(19) United States
(12) Patent Application Publication
(10) Pub. No.: US 2022/0185644 A1
(43) Pub. Date: Jun. 16, 2022

(54) Ergonomic Flexible Grip Container Opener

(71) Applicant: Rebecca Stevenson, Kyle, TX (US)

(72) Inventor: Rebecca Stevenson, Kyle, TX (US)

(21) Appl. No.: 17/121,498

(22) Filed: Dec. 14, 2020

(51) Int. Cl. B67B 7/14; B67B 7/18

(52) U.S. Cl. CPC B67B 7/14; B67B 7/18

(57) ABSTRACT

Disclosed herein is an apparatus for opening and closing containers with lids by hand, which comprises a large flexible padded body suitable for being comfortably gripped, squeezed, and twisted by weak hands, and a region for receiving and gripping a hard material, such as a lid of a container. The more preferred embodiments of the invention comprise one or more types of silicone, and an inner layer of a harder silicone may be used to improve the grip on a lid. The flexibility and stretchability of the apparatus allows it to stretch and adapt to different sizes and shapes of lids. Various embodiments also utilize different ergonomic shapes to accommodate different hand sizes and comfortably fit finger placement, including shapes that are squarish, cuboid, spheroid, star-shaped, cross-shaped, handle-shaped, resemble nuts, or have grooves or scallops for fingers to improve gripping.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

### 1. Field of the Invention

The present invention is in the technical field of container opening devices. More particularly, the preferred embodiments of the present invention relate generally to container opening devices for containers with lids. More particularly, the preferred embodiments of the present invention relate generally to container opening devices for different sized containers and lids. More particularly, the preferred embodiments of the present invention relate generally to container opening devices that assist persons with weak hands to open containers with lids. More particularly, the preferred embodiments of the present invention relate generally to ergonomic container opening devices that assist persons with weak hands to open containers with lids.

### 2. Description of the Related Art

The broad concept of container openers is known. However, most of these devices are not well suited to allow weak hands to open a container.

Handheld container openers are also known. However, these inventions are not usually tailored for weak hands that have difficulty in closing or closing tightly and can cause pain to weak hands.

It is also known to use container openers that grip. However, these devices are usually focused on gripping a lid and not the comfort of a gripping hand and can cause pain in weak hands during use.

Container openers that ergonomically fit fingers are also known. However, these inventions are usually designed to fit the fingers of strong hands and allow a tight grip, which can be painful to weak hands.

It is also known to use container openers that fit different lid sizes. However, these inventions are usually focused on fitting various lid sizes and not the comfort afforded a weak hand or ease of use on a hand and different sized lids may require different use of force, which can be difficult or painful to a weak hand.

Container openers made of silicone are also known. However, these inventions are usually intended to use the silicone as a gripping surface to help remove a lid tightly affixed to a container and the silicone is not used in a soft or volumetric manner in order to provide a large, soft gripping surface for weak hands.

Container openers for weak hands are known as well. However, these inventions usually rely on a leverage arm to aid in opening a lid and do not provide a large, soft gripping surface well suited for being gripped by weak hands that have difficulty in closing or tightly closing or experience pain from the same.

### SUMMARY OF THE INVENTION

Opening containers is rather commonplace in modern times. Liquids, powders, medicines, juices, grocery products, refreshments, and even drinking water, are kept in containers with tight lids that require a firm, strong grip to open. Problems may arise with persons afflicted with weak hands, such as from arthritis, nerve damage, carpal tunnel, tendinitis, hand/wrist/arm injuries, weak muscles, inflexibility, old age, or the like, or with people with small hands that are unable to properly grip some lid sizes, such as children, who are unable to grip and turn lids due to their affliction. Additional problems arise if persons with weak hands must push in and turn a lid to open it, as with most medications. Thus, there is a need to provide an apparatus to assist persons with weak hands to grip and open or close lids on containers.

The Ergonomic Flexible Grip Container Opener invention was developed in part to provide an apparatus for opening and closing containers with lids, which can easily be ergonomically gripped and turned by weak hands in a highly useful manner. In broad embodiment, the Ergonomic Flexible Grip Container Opener invention relates to an apparatus for opening and closing containers with lids by hand, which comprises a large flexible padded body made of a soft material, which is suitable for being comfortably gripped by weak hands, and a region for receiving and gripping a hard material, such as a lid of a container. The more preferred embodiments of the invention comprise one or more types of silicone that are strong, flexible, stretchable, and grip soft or hard surfaces well. Additionally, an inner layer of a harder silicone may be used to improve the grip on a lid. The flexibility and stretchability of the materials used for the Ergonomic Flexible Grip Container Opener is well suited for adapting to different sizes and shapes of lids by simply stretching the material over the lid for a tight fit. Various embodiments also utilize different ergonomic shapes to accommodate different hand sizes and comfortably fit finger placement, including shapes that are squarish, cuboid, spheroid, star-shaped, cross-shaped, handle-shaped, resemble nuts, or have grooves or scallops for fingers to improve gripping.

In the more preferred embodiments, the present invention relates to an apparatus for opening and closing containers with lids by hand, said apparatus comprising: a padded body, said padded body comprising: a size suitable to substantially fit in said hand, a strong, soft, flexible, and stretchable material suitable for being gripped in said hand, an outer shape that ergonomically fits said hand, an indentation in said large padded body, said indentation capable of receiving said lid of said container and comprising: an opening, a cavity, and one or more gripping surfaces, said one or more gripping surfaces lining said cavity; and wherein said lid of said container is inserted through said opening into said cavity of said indentation, said padded body is gripped by said hand thereby gripping said lid with said gripping surfaces in said indentation, said hand turns said padded body, thereby turning said gripping surfaces in said indentation and said lid of said container until said lid is opened or closed. Some versions further comprise an inner layer of a harder material that the softer padded body. Other versions further comprise a drawstring for a better grip or to assist weak hands in removing a lid. Still other versions further comprise various gripping notches in the exterior surface of the padded body to provide an improved gripping surface. Additional versions may include a lip surrounding the opening of the indentation and extending into the indentation slightly to allow the apparatus to better grip a lid of a container. Other versions have gripping surfaces with multiple faces that may be set at an offset angle to each other. Various ergonomic shapes may be used to assist weak hands in opening or closing containers, with some versions appearing as a rounded cuboid or spheroid and other versions shapes as a handle, cross, or star. These versions are exemplary and not intended to limit the scope of the present invention.

In the most preferred embodiments, the present invention relates to an apparatus for opening and closing containers with lids by hand, said apparatus comprising: a padded body, said padded body comprising: a size suitable to substantially fit in said hand, a strong, soft, flexible, and stretchable material suitable for being gripped in said hand, an outer shape that ergonomically fits said hand, an indentation in said large padded body, said indentation capable of receiving said lid of said container and comprising: an opening, a cavity, an inner layer disposed within said indentation, lining said cavity, and bonded to said padded body, said inner layer comprising: a thin, hard, flexible, and stretchable material suitable for gripping said lid of said container, and one or more gripping surfaces; and wherein said lid of said container is inserted into said indentation, said padded body is gripped by said hand thereby gripping said lid with said one or more gripping surfaces of said inner layer, and said hand turns said padded body, thereby turning said one or more gripping surfaces of said inner layer and said lid of said container until said lid is opened or closed. In sum, the Ergonomic Flexible Grip Container Opener invention provides a relatively inexpensive solution for assisting weak hands to grip lids and open or close containers in a convenient and useful fashion.

### BRIEF DESCRIPTION OF THE DRAWING

Illustrative and preferred embodiments of the present invention are shown in the accompanying drawings in which:

FIG. 1 is a perspective view of a broad embodiment of an apparatus of the present invention;

FIG. 2 is a front view of an apparatus of FIG. 1;

FIG. 3 is a rear view of an apparatus of FIG. 1;

FIG. 4 is a corner view of an apparatus of FIG. 1;

FIG. 5 is a right-side view of an apparatus of FIG. 1;

FIG. 6 is a left-side view of an apparatus of FIG. 1;

FIG. 7 is a top view of an apparatus of FIG. 1;

FIG. 8 is a bottom view of an apparatus of FIG. 1;

FIG. 9 is a cutaway side view of an apparatus of FIG. 1;

FIG. 10 is a perspective view of another embodiment of an apparatus of the present invention;

FIG. 11 is a front view of an apparatus of FIG. 10;

FIG. 12 is a rear view of an apparatus of FIG. 10;

FIG. 13 is a corner view of an apparatus of FIG. 10;

FIG. 14 is a right-side view of an apparatus of FIG. 10;

FIG. 15 is a left-side view of an apparatus of FIG. 10;

FIG. 16 is a top view of an apparatus of FIG. 10;

FIG. 17 is a bottom view of an apparatus of FIG. 10;

FIG. 18 is a cutaway view of an apparatus of FIG. 10;

FIG. 19 is a front view of an apparatus of FIG. 10 above a container;

FIG. 20 is a front view of an apparatus of FIG. 10 mounted onto the lid of a container of FIG. 19;

FIG. 21 is a front view of an apparatus of FIG. 10 mounted onto the lid of a container of FIG. 19 and twisting the lid;

FIG. 22 is a front view of an apparatus of FIG. 10 mounted onto the lid of a container of FIG. 19 with the lid removed from the container;

FIG. 23 is a cutaway view of an apparatus of FIG. 10 above a container of FIG. 19;

FIG. 24 is a cutaway view of an apparatus of FIG. 10 mounted onto the lid of a container of FIG. 19;

FIG. 25 is a cutaway view of an apparatus of FIG. 10 mounted onto the lid of a container of FIG. 19 and twisting the lid;

FIG. 26 is a cutaway view of an apparatus of FIG. 10 mounted onto the lid of a container of FIG. 19 with the lid removed from the container;

FIG. 27 is a front view of an apparatus of FIG. 10 above another type of container;

FIG. 28 is a front view of an apparatus of FIG. 10 mounted onto the lid of a container of FIG. 27;

FIG. 29 is a front view of an apparatus of FIG. 10 mounted onto the lid of a container of FIG. 27 and twisting the lid;

FIG. 30 is a front view of an apparatus of FIG. 10 mounted onto the lid of a container of FIG. 27 with the lid removed from the container;

FIG. 31 is a cutaway view of an apparatus of FIG. 10 above a container of FIG. 27;

FIG. 32 is a cutaway view of an apparatus of FIG. 10 mounted onto the lid of a container of FIG. 27;

FIG. 33 is a cutaway view of an apparatus of FIG. 10 mounted onto the lid of a container of FIG. 27 and twisting the lid;

FIG. 34 is a cutaway view of an apparatus of FIG. 10 mounted onto the lid of a container of FIG. 27 with the lid removed from the container;

FIG. 35 is a front view of an apparatus of FIG. 10 above another type of container;

FIG. 36 is a front view of an apparatus of FIG. 10 mounted onto the lid of a container of FIG. 35;

FIG. 37 is a front view of an apparatus of FIG. 10 mounted onto the lid of a container of FIG. 35;

FIG. 38 is a front view of an apparatus of FIG. 10 mounted onto the lid of a container of FIG. 35 with the lid removed from the container;

FIG. 39 is a cutaway view of an apparatus of FIG. 10 above a container of FIG. 35;

FIG. 40 is a cutaway view of an apparatus of FIG. 10 mounted onto the lid of a container of FIG. 35;

FIG. 41 is a cutaway view of an apparatus of FIG. 10 mounted onto the lid of a container of FIG. 35 and twisting the lid;

FIG. 42 is a cutaway view of an apparatus of FIG. 10 mounted onto the lid of a container of FIG. 35 with the lid removed from the container;

FIG. 43 is a perspective view of the most preferred embodiment of an apparatus of the present invention;

FIG. 44 is a front view of an apparatus of FIG. 43;

FIG. 45 is a rear view of an apparatus of FIG. 43;

FIG. 46 is a corner view of an apparatus of FIG. 43;

FIG. 47 is a right-side view of an apparatus of FIG. 43;

FIG. 48 is a left-side view of an apparatus of FIG. 43;

FIG. 49 is a top view of an apparatus of FIG. 43;

FIG. 50 is a bottom view of an apparatus of FIG. 43;

FIG. 51 is a cutaway view of an apparatus of FIG. 43;

FIG. 52 is a front view of an apparatus of FIG. 43 above a container;

FIG. 53 is a front view of an apparatus of FIG. 43 mounted onto the lid of a container of FIG. 52;

FIG. 54 is a front view of an apparatus of FIG. 43 mounted onto the lid of a container of FIG. 52 and twisting the lid;

FIG. 55 is a front view of an apparatus of FIG. 43 mounted onto the lid of a container of FIG. 52 with the lid removed from the container;

FIG. 56 is a cutaway view of an apparatus of FIG. 43 above a container of FIG. 52;

FIG. 57 is a cutaway view of an apparatus of FIG. 43 mounted onto the lid of a container of FIG. 52;

FIG. 58 is a cutaway view of an apparatus of FIG. 43 mounted onto the lid of a container of FIG. 52 and twisting the lid;

FIG. 59 is a cutaway view of an apparatus of FIG. 43 mounted onto the lid of a container of FIG. 52 with the lid removed from the container;

FIG. 60 is a front view of an apparatus of FIG. 43 above another type of container;

FIG. 61 is a front view of an apparatus of FIG. 43 mounted onto the lid of a container of FIG. 60;

FIG. 62 is a front view of an apparatus of FIG. 43 mounted onto the lid of a container of FIG. 60 and twisting the lid;

FIG. 63 is a front view of an apparatus of FIG. 43 mounted onto the lid of a container of FIG. 60 with the lid removed from the container;

FIG. 64 is a cutaway view of an apparatus of FIG. 43 above a container of FIG. 60;

FIG. 65 is a cutaway view of an apparatus of FIG. 43 mounted onto the lid of a container of FIG. 60;

FIG. 66 is a cutaway view of an apparatus of FIG. 43 mounted onto the lid of a container of FIG. 60 and twisting the lid;

FIG. 67 is a cutaway view of an apparatus of FIG. 43 mounted onto the lid of a container of FIG. 60 with the lid removed from the container;

FIG. 68 is a front view of an apparatus of FIG. 43 above another type of container;

FIG. 69 is a front view of an apparatus of FIG. 43 mounted onto the lid of a container of FIG. 68;

FIG. 70 is a front view of an apparatus of FIG. 43 mounted onto the lid of a container of FIG. 68;

FIG. 71 is a front view of an apparatus of FIG. 43 mounted onto the lid of a container of FIG. 68 with the lid removed from the container;

FIG. 72 is a cutaway view of an apparatus of FIG. 43 above a container of FIG. 68;

FIG. 73 is a cutaway view of an apparatus of FIG. 43 mounted onto the lid of a container of FIG. 68;

FIG. 74 is a cutaway view of an apparatus of FIG. 43 mounted onto the lid of a container of FIG. 68 and twisting the lid;

FIG. 75 is a cutaway view of an apparatus of FIG. 43 mounted onto the lid of a container of FIG. 68 with the lid removed from the container;

FIG. 76 is a perspective view of another embodiment of an apparatus of the present invention;

FIG. 77 is a front view of an apparatus of FIG. 76;

FIG. 78 is a rear view of an apparatus of FIG. 76;

FIG. 79 is a right-side view of an apparatus of FIG. 76;

FIG. 80 is a left-side view of an apparatus of FIG. 76;

FIG. 81 is a top view of an apparatus of FIG. 76;

FIG. 82 is a bottom view of an apparatus of FIG. 76;

FIG. 83 is a cutaway view of an apparatus of FIG. 76;

FIG. 84 is a perspective view of another embodiment of an apparatus of the present invention;

FIG. 85 is a perspective view of another embodiment of an apparatus of the present invention;

FIG. 86 is a front view of an apparatus of FIG. 81;

FIG. 87 is a right-side view of an apparatus of FIG. 81;

FIG. 88 a left-side view of an apparatus of FIG. 81;

FIG. 89 is a top view of an apparatus of FIG. 81;

FIG. 90 is a bottom view of an apparatus of FIG. 81;

FIG. 91 is a front cutaway view of an apparatus of FIG. 81;

FIG. 92 is a left-side cutaway view of an apparatus of FIG. 81;

FIG. 93 is a perspective view of another embodiment of an apparatus of the present invention;

FIG. 94 is a front view of an apparatus of FIG. 93;

FIG. 95 is a rear view of an apparatus of FIG. 93;

FIG. 96 is a right-side view of an apparatus of FIG. 93;

FIG. 97 a left-side view of an apparatus of FIG. 93;

FIG. 98 is a top view of an apparatus of FIG. 93;

FIG. 99 is a bottom view of an apparatus of FIG. 93; and

FIG. 100 is a front cutaway view of an apparatus of FIG. 93.

### DETAILED DESCRIPTION OF THE PREFERRED EMBODIMENTS

For the purpose of illustration, the present invention is shown in the most preferred embodiments of an ergonomic flexible-grip container-opening apparatus with various inner structures, optionally including an inner layer or drawstring in some embodiments, which flex and stretch to fit over the lids of a variety of containers and allow a person to comfortably grip the apparatus while opening a container. Exemplary embodiments include versions with ergonomic shapes, including rounded cuboid-shapes with finger grips and drawstrings, spheroid-shapes with various finger grips, rounded handle shapes, and rounded star shapes. These embodiments are not intended to limit the scope of the present invention.

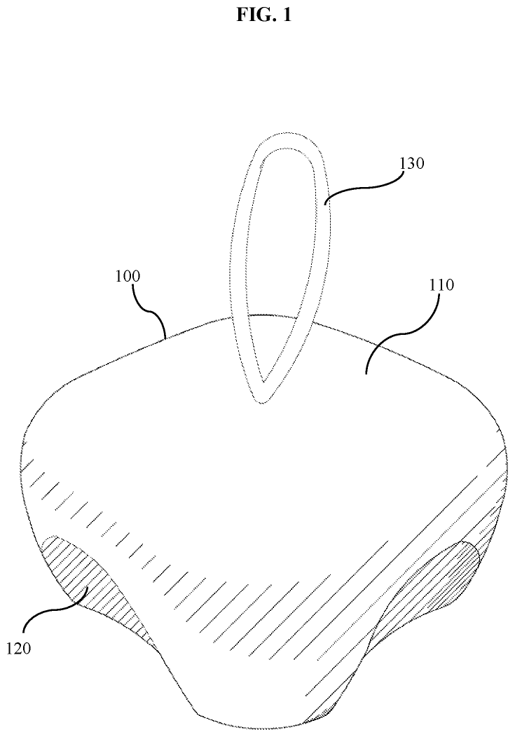

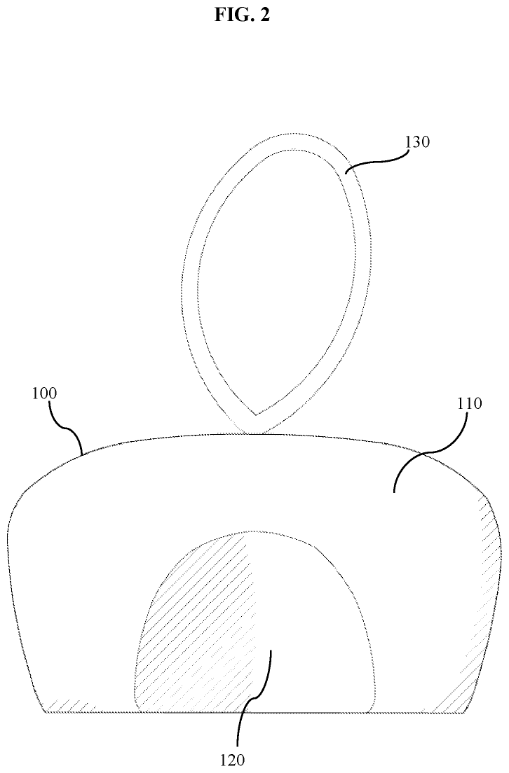

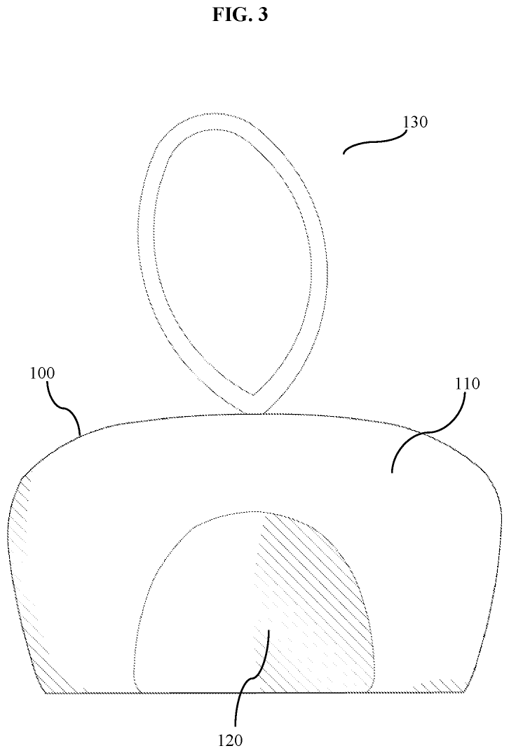

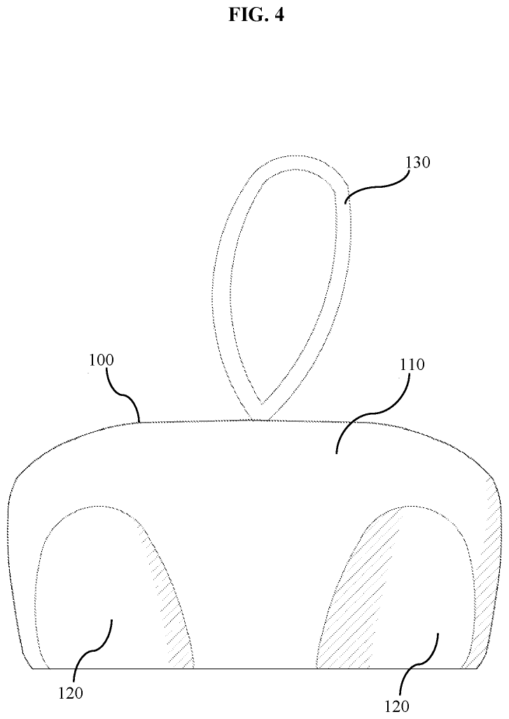

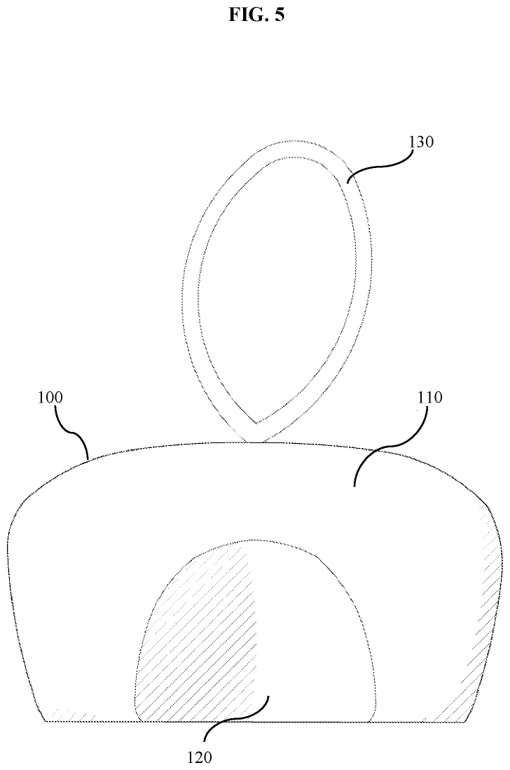

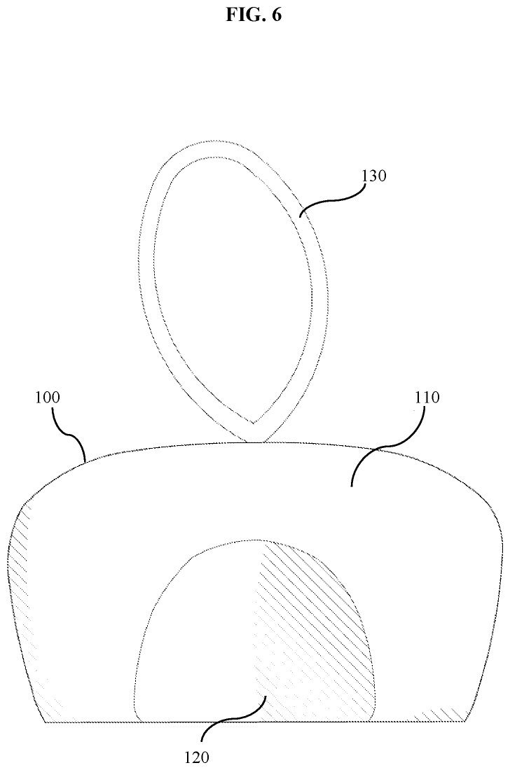

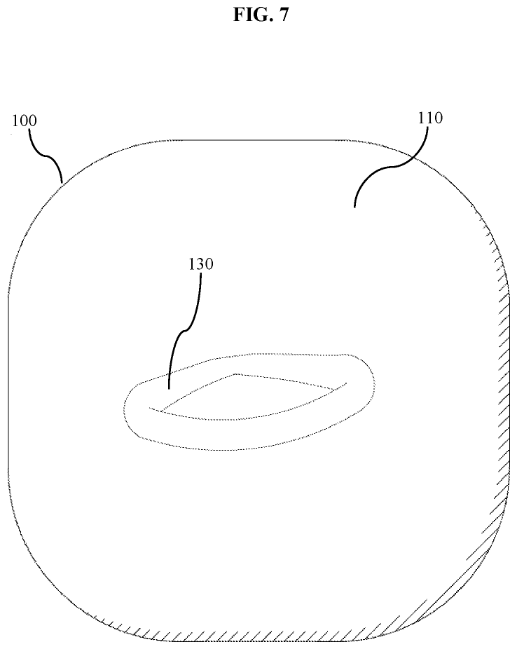

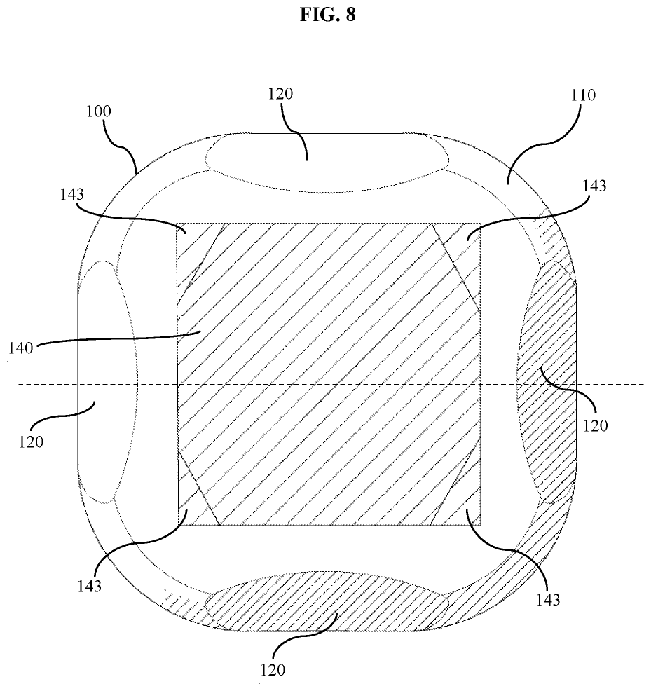

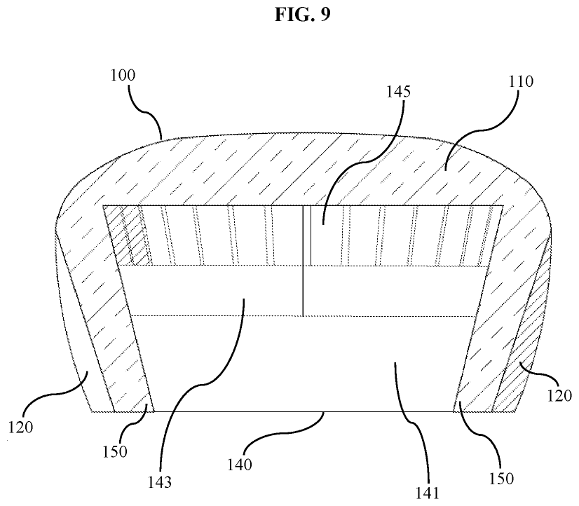

The Ergonomic Flexible Grip Container Opener invention was developed in part to provide an apparatus for opening and closing containers with lids comprising a resilient, flexible, pliable, and/or stretchable material, which can easily be ergonomically gripped and turned by weak hands in a highly useful manner. Referring now to a broad preferred embodiment of the invention, in FIG. 1, FIG. 2, FIG. 3, FIG. 4, FIG. 5, FIG. 6, FIG. 7, FIG. 8, and FIG. 9, a Broad Ergonomic Flexible Grip Container Opener 100 is shown. FIG. 1 illustrates a perspective view of a Broad Ergonomic Flexible Grip Container Opener 100. FIG. 2 depicts a front view a Broad Ergonomic Flexible Grip Container Opener 100. FIG. 3 illustrates a rear view of a Broad Ergonomic Flexible Grip Container Opener 100. FIG. 4 shows a corner view of a Broad Ergonomic Flexible Grip Container Opener 100. FIG. 5 displays a right-side view of a Broad Ergonomic Flexible Grip Container Opener 100. FIG. 6 shows a left-side view of a Broad Ergonomic Flexible Grip Container Opener 100. FIG. 7 depicts a top view of a Broad Ergonomic Flexible Grip Container Opener 100. FIG. 8 illustrates a bottom view of a Broad Ergonomic Flexible Grip Container Opener 100. FIG. 9 demonstrates a cutaway view of a Broad Ergonomic Flexible Grip Container Opener 100 with the cutaway slice indicated by a dotted line in FIG. 8. Because of the symmetry of the Broad Ergonomic Flexible Grip Container Opener 100, the front view in FIG. 2, the rear view in FIG. 3, the right-side view in FIG. 5, and the left-side view in FIG. 6, appear substantially identical.

Referring still to the broad preferred embodiment of the invention in FIG. 1, FIG. 2, FIG. 3, FIG. 4, FIG. 5, FIG. 6, FIG. 7, FIG. 8, and FIG. 9, the Broad Ergonomic Flexible Grip Container Opener 100 comprises a broad padded body 110; a broad drawstring 130 depending from the top of the broad padded body 110; and a broad indentation 140, which is recessing into the bottom of the broad padded body 110 and capable of receiving a lid of a container. The broad padded body 110 comprises a size suitable to substantially fit in a hand comfortably without the hand needing to be substantially closed or tightly gripped; a soft, strong, flexible, pliable, resilient, and stretchable material, which is suitable for being comfortably gripped in a hand; and an outer shape with ergonomically fitting broad finger notches 120 set into each side (front, rear, right, and left sides) of the broad padded body 110. The broad padded body 110 also comprises a broad lip 150, which surrounds the opening of the broad indentation 140 and extends into it slightly. The broad indentation 140 comprises a square-shaped opening and three gripping surfaces within the recessed cavity: a broad lower gripping surface 141, a broad middle gripping surface 143, and a broad upper gripping surface 145. The broad lower gripping surface 141 conforms to the square shape of the broad indentation 140 but becomes wider as it extends into the interior of the broad indentation 140. The broad middle gripping surface 143 is similarly square-shaped; however, its shape is set at an offset angle to the broad lower gripping surface 141 in order to engage a lid of a container at a different angle than the broad lower gripping surface 141. The broad upper gripping surface 145 comprises a plurality of surfaces, preferably a large number of surfaces, to engage a lid of a container at a large volume of multiple contact sites. The broad drawstring 130 depends from the top of the broad padded body 110 and provides additional leverage when removing a lid from a container.

In further detail, referring still to the broad preferred embodiment of the invention in FIG. 1, FIG. 2, FIG. 3, FIG. 4, FIG. 5, FIG. 6, FIG. 7, FIG. 8, and FIG. 9; during use, the a soft, strong, flexible, pliable, resilient, and stretchable material, of the broad padded body 110 of a Broad Ergonomic Flexible Grip Container Opener 100 allows the apparatus to fit upon a wide variety sizes and shapes of container lids and is well-suited for being comfortably gripped by weak hands. To use a Broad Ergonomic Flexible Grip Container Opener 100, first a lid fastened onto a container is inserted into the broad indentation 140. Because of the flexibility and stretchiness of the broad padded body 110 of a Broad Ergonomic Flexible Grip Container Opener 100, the broad padded body 110 and the broad lip 150 may be stretched over a lid, which does not necessarily match the size of the broad indentation 140. Once the Broad Ergonomic Flexible Grip Container Opener 100 is set onto the lid, the broad padded body 110 may be comfortably gripped, even by weak hands that have difficulty with tightly closing, and gently squeezed, and twisted. The soft, strong, flexible, pliable, resilient, and stretchable material, of the broad padded body 110 of a Broad Ergonomic Flexible Grip Container Opener 100 allows force from a gentle grip to be applied to the lid while limiting this force from causing discomfort in a user's hands. The gentle squeezing of the Broad Ergonomic Flexible Grip Container Opener 100 allows the broad lower gripping surface 141, the broad middle gripping surface 143, and/or the broad upper gripping surface 145 to come into contact with the lid of the container within the broad indentation 140. If the lid is a pop-off lid, a user may use the broad drawstring 130 to assist in pulling the lid off the container without stressing weak hands. If the lid is a screw-on lid, then, while continuing to squeeze the broad padded body 110 of a Broad Ergonomic Flexible Grip Container Opener 100, a user may twist the apparatus to cause the lid to twist off of the container. Once the lid is removed from the container it may either be removed from the broad indentation 140 or remain in the broad indentation 140 so that the Broad Ergonomic Flexible Grip Container Opener 100 may be used to attach the lid to the container again. The Broad Ergonomic Flexible Grip Container Opener 100 offers a comfortable solution, which allows a person with weak hands to open and close containers with lids.

The construction details of the invention as shown in FIG. 1, FIG. 2, FIG. 3, FIG. 4, FIG. 5, FIG. 6, FIG. 7, FIG. 8, and FIG. 9, are as follows. The broad padded body 110 comprises a soft, strong, flexible, pliable, resilient, and stretchable material, or the like, which is suitable for being comfortably gripped in a hand, such as silicone, plastic, rubber, foam, composite material, soft wood, colloids, polymers, gels, emulsions, tissues, felt, cloth, or the like. The broad drawstring 130 comprises plastic, silicone, rope, twine, cloth, composite material, metal, chain, wire, string, fiber, or the like. The broad indentation 140 comprises a shaped cavity or space within the broad padded body 110. The broad finger notches 120 comprise indentions in the exterior of the broad padded body 110, which ergonomically conform to the shape of fingers, or the like. The broad lip 150 is a part of the broad padded body 110 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The broad lower gripping surface 141 is a part of the broad padded body 110 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The broad middle gripping surface 143 is a part of the broad padded body 110 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The broad upper gripping surface 145 is a part of the broad padded body 110 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. This version could also be used with an inner lining, as shown below with the most preferred embodiment of the invention. The materials listed herein are examples only and not intended to limit the scope of the present invention.

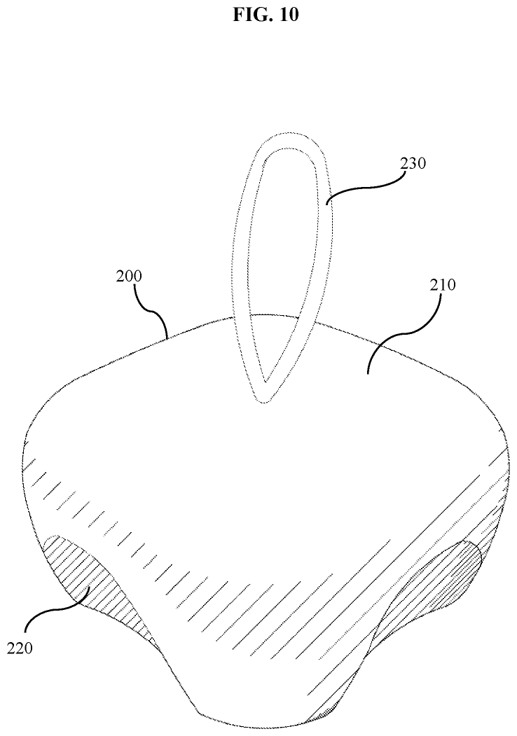

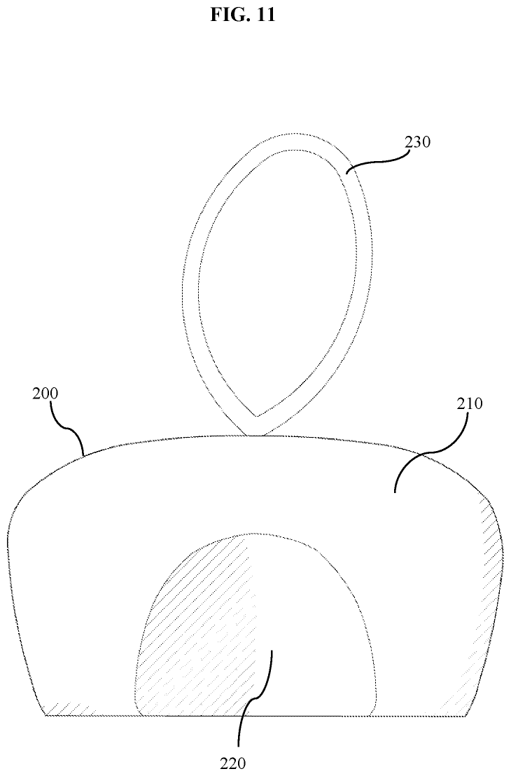

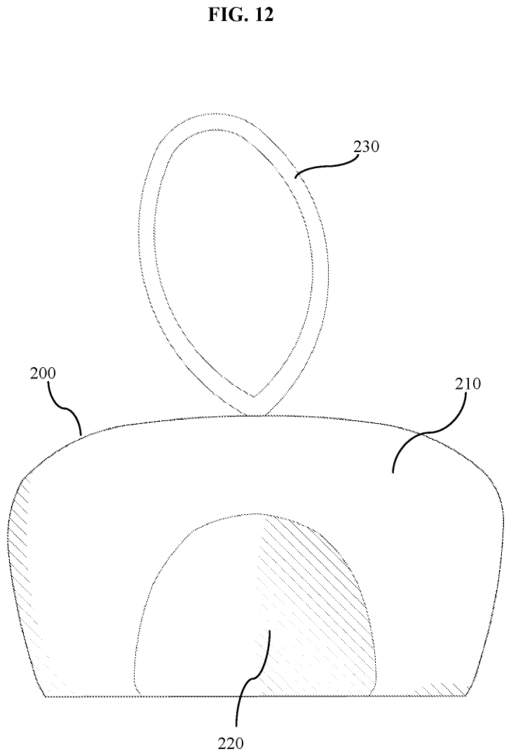

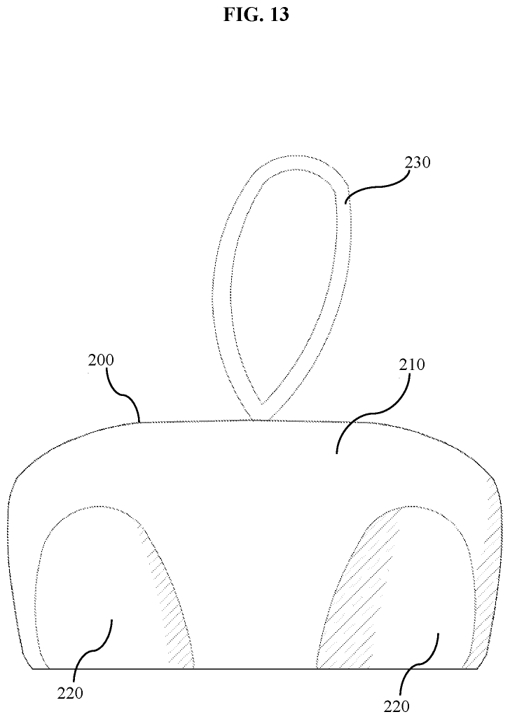

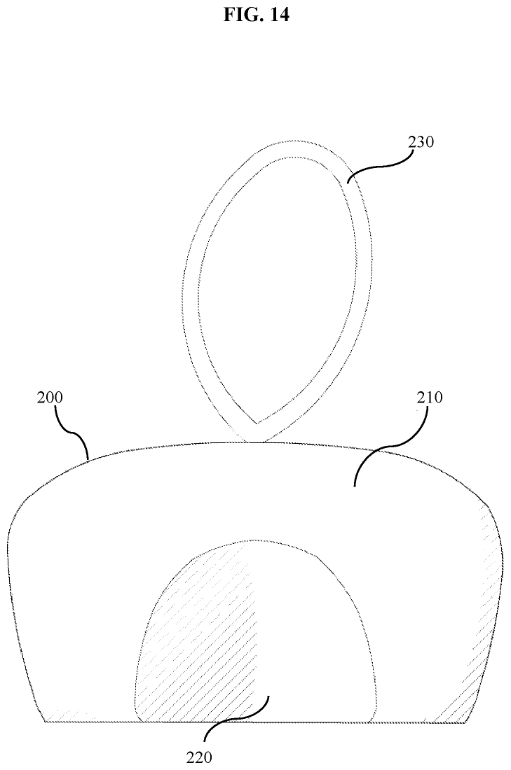

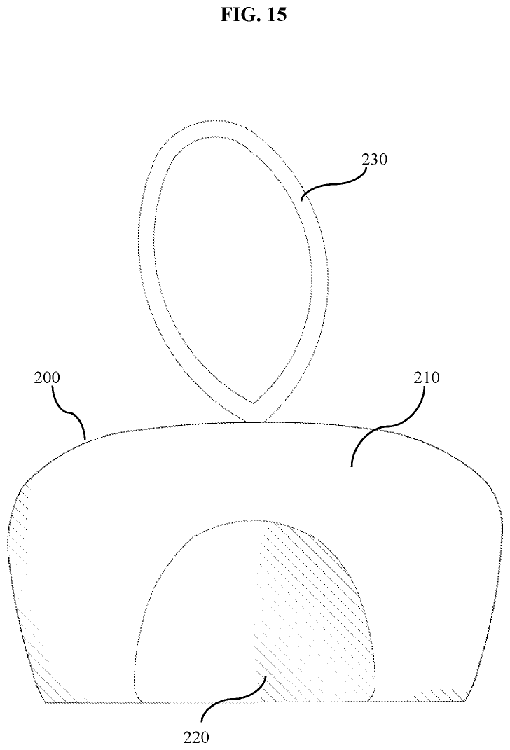

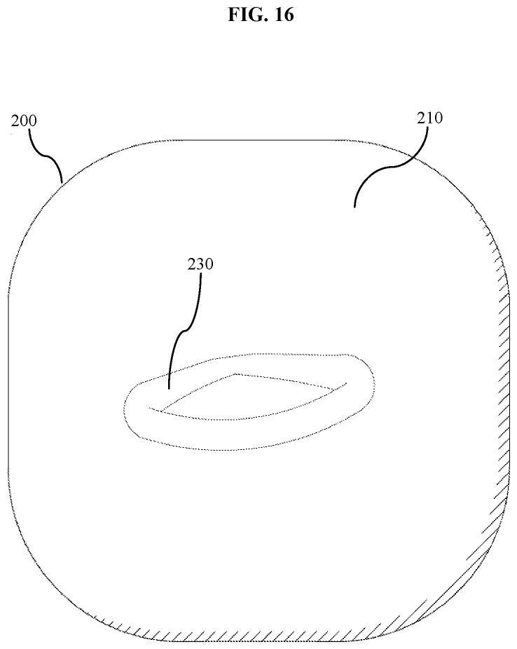

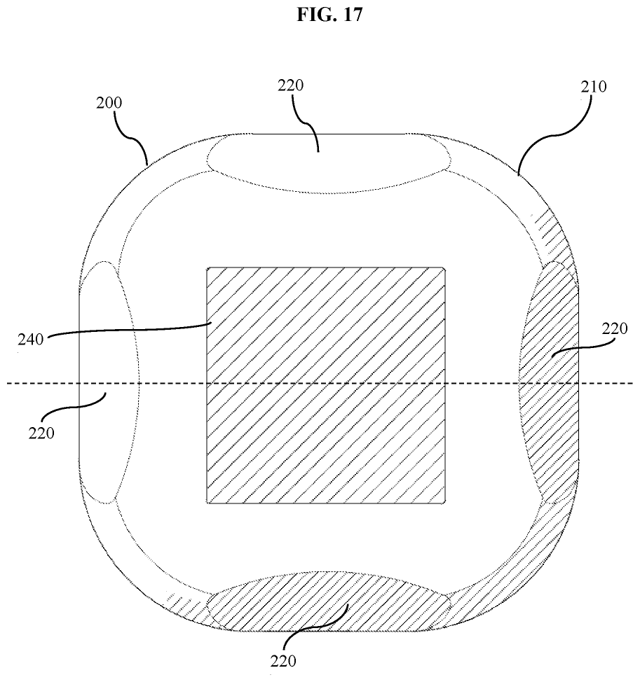

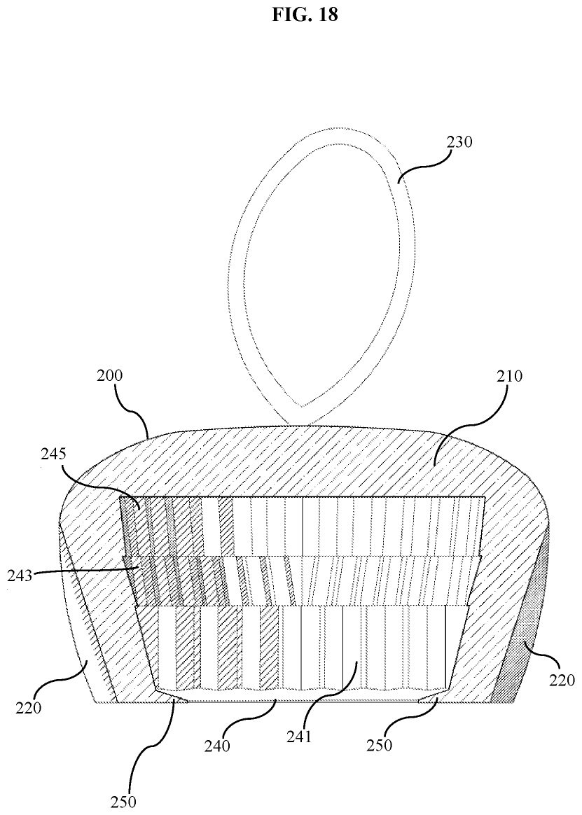

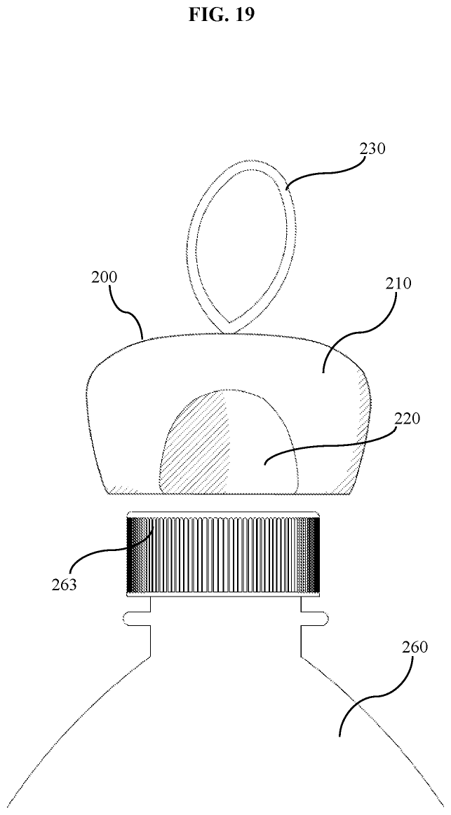

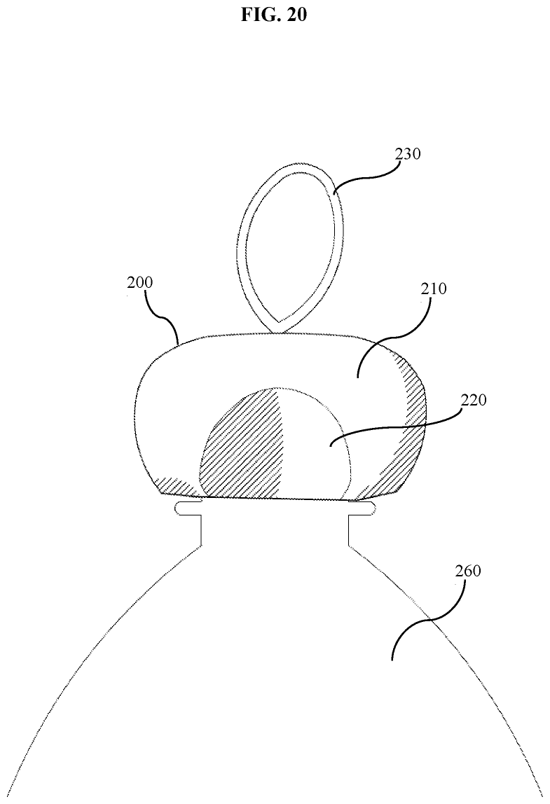

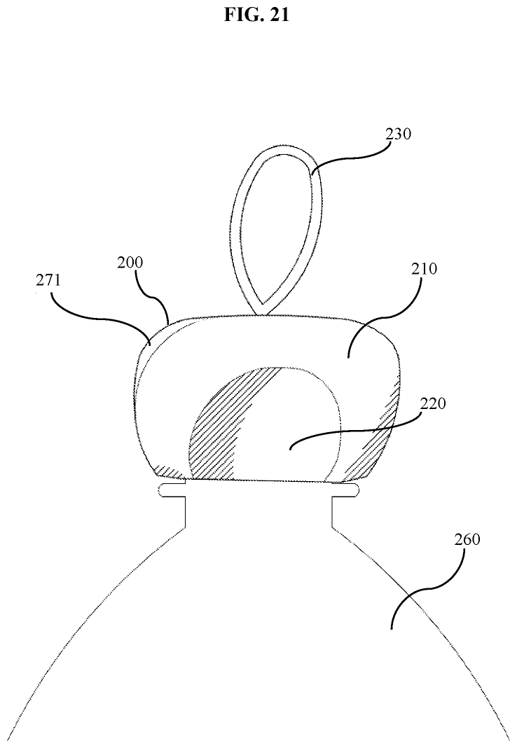

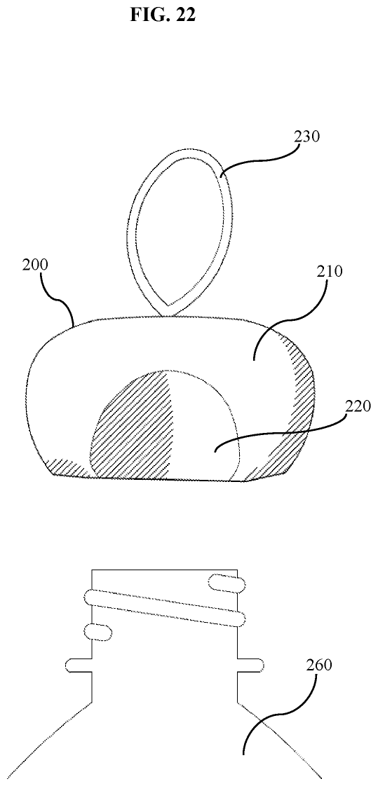

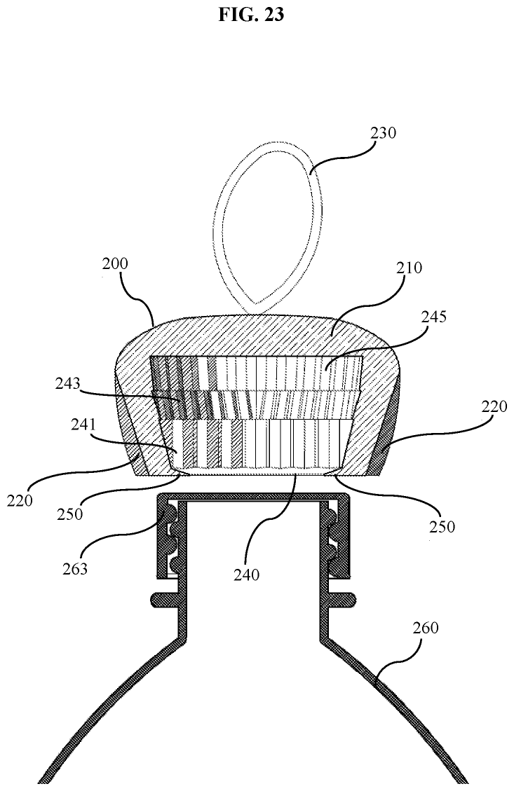

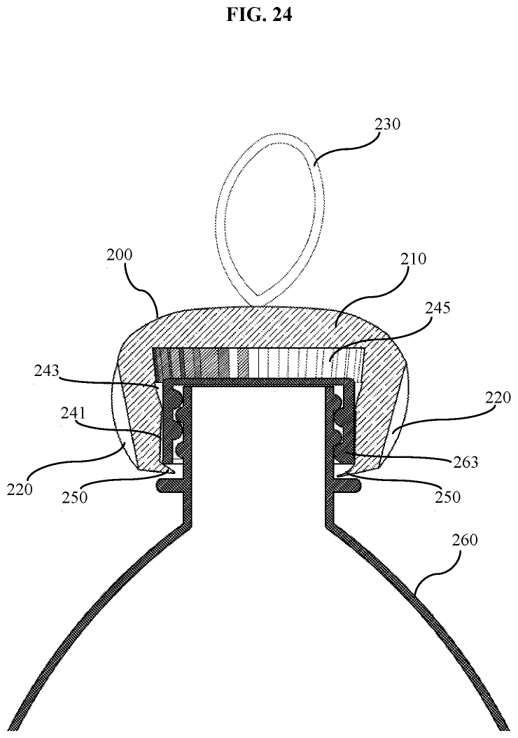

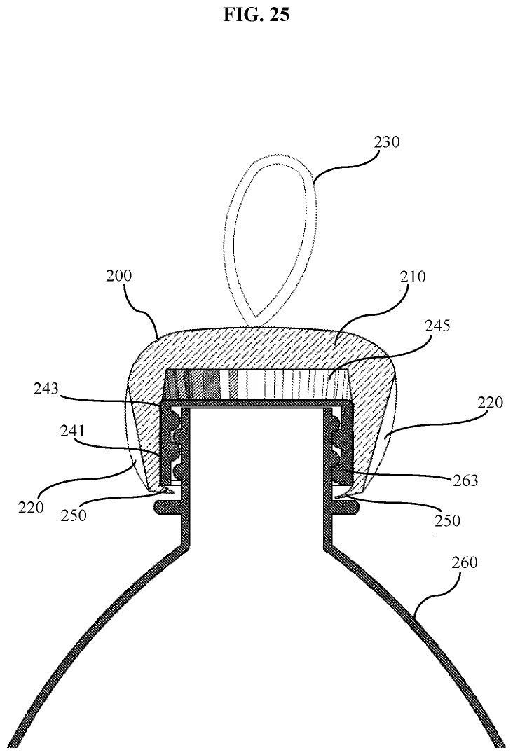

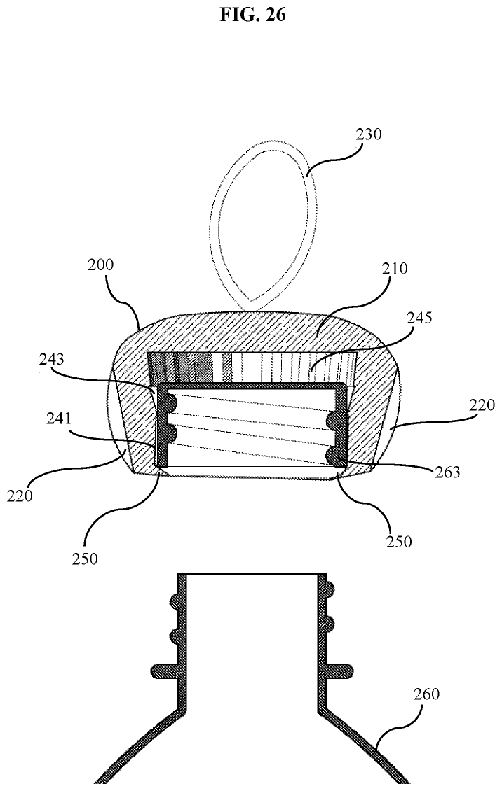

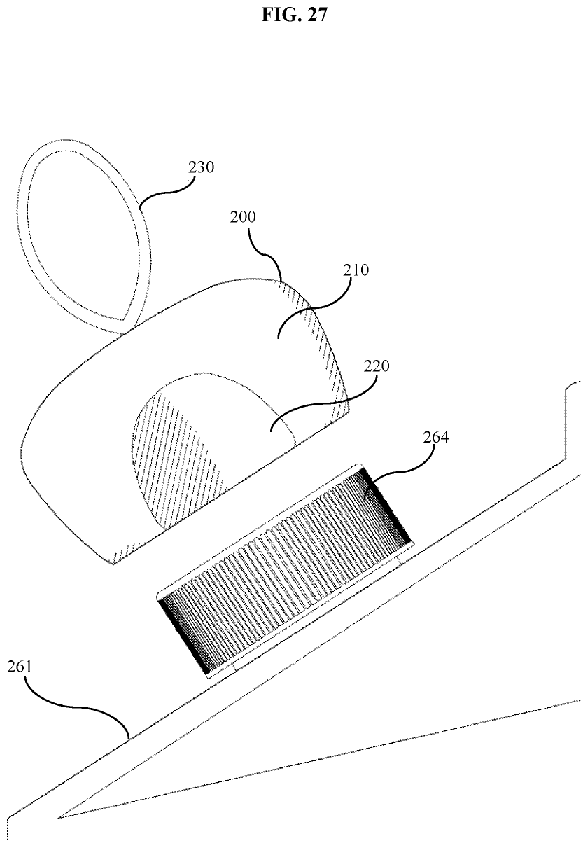

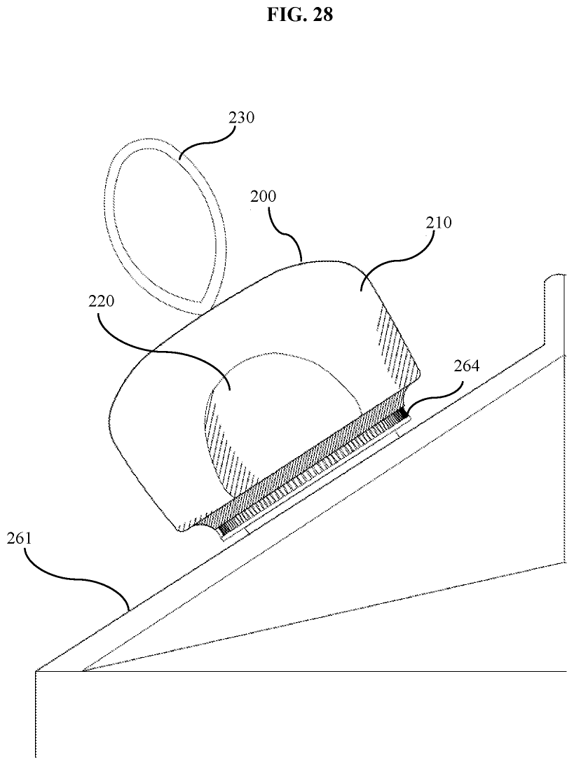

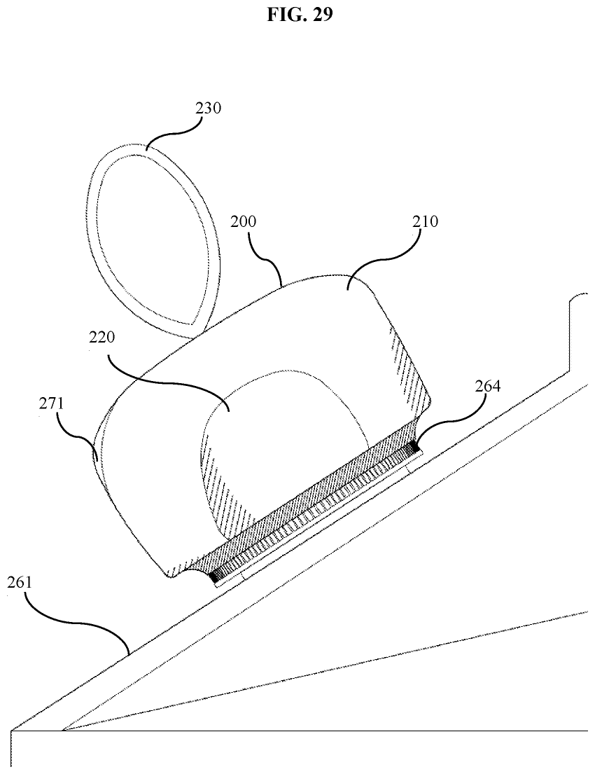

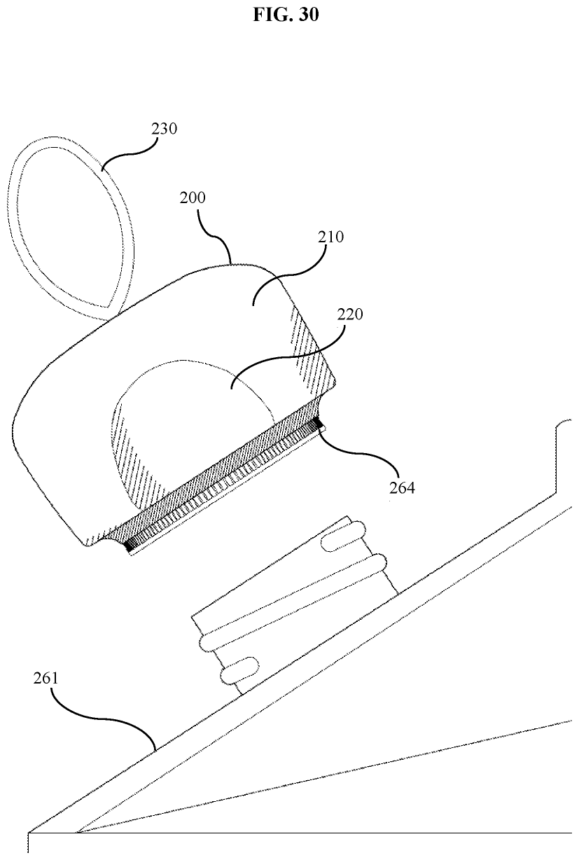

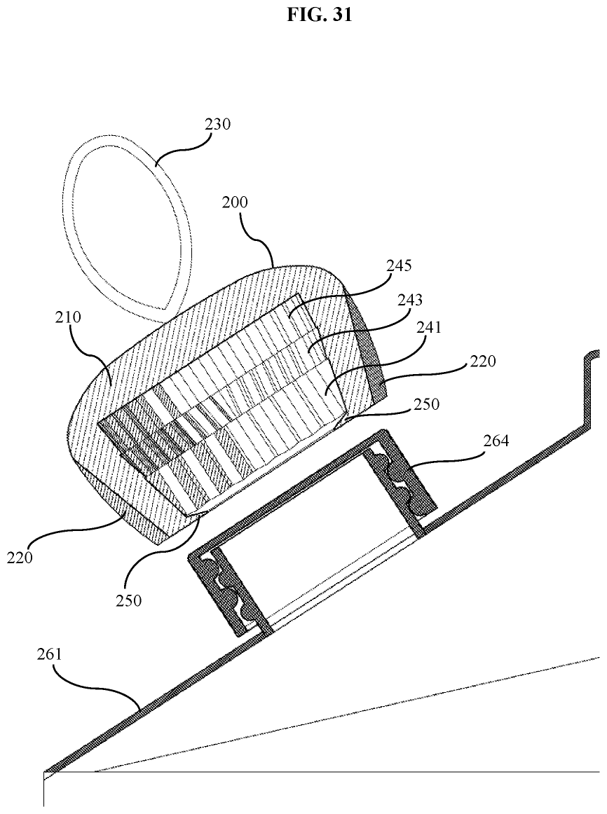

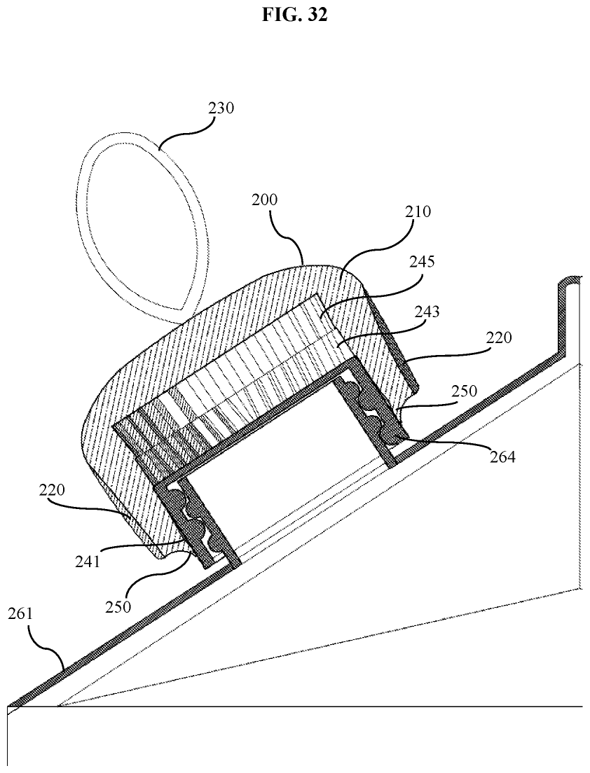

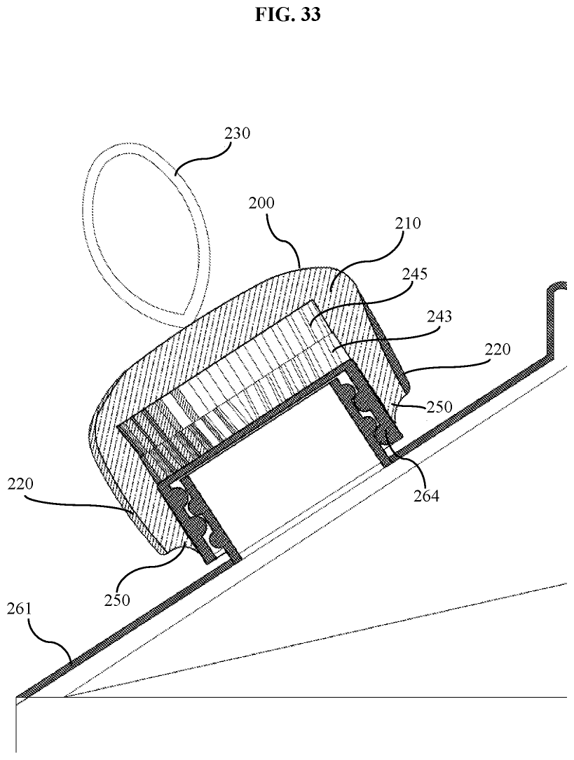

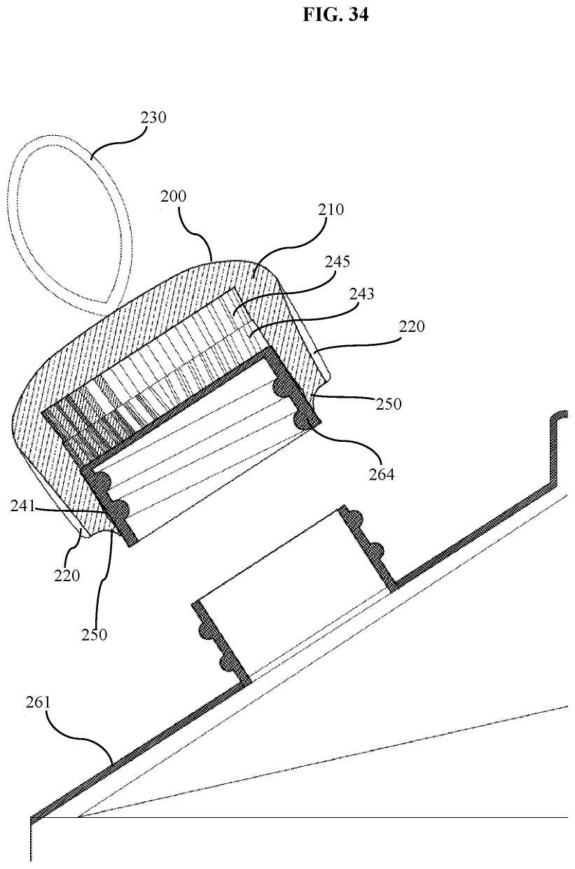

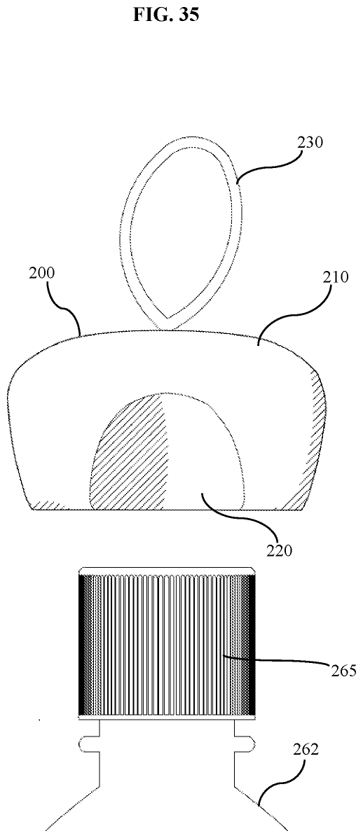

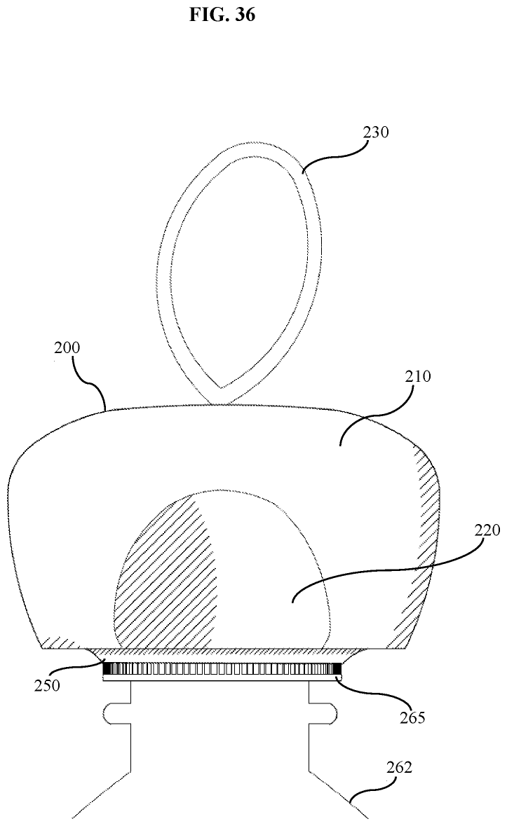

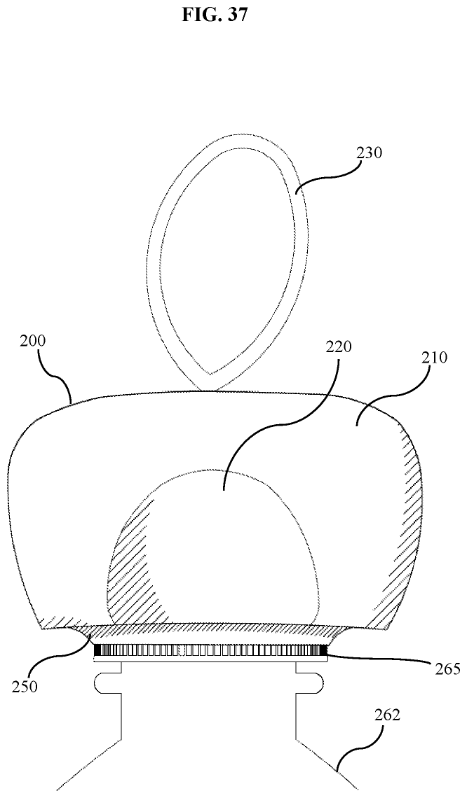

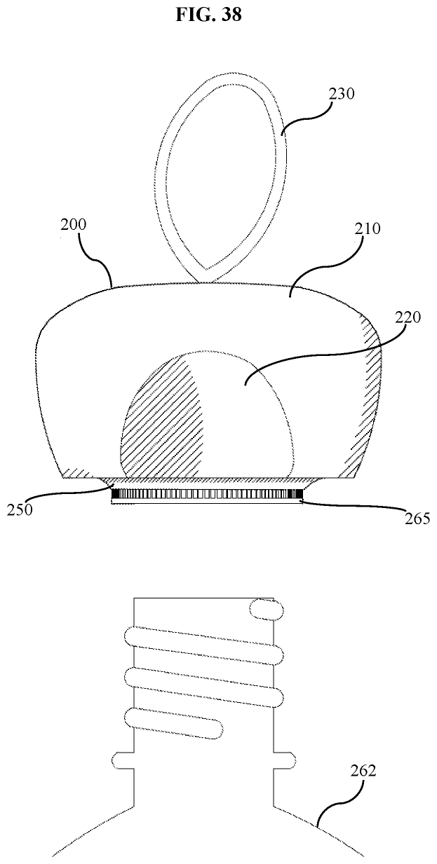

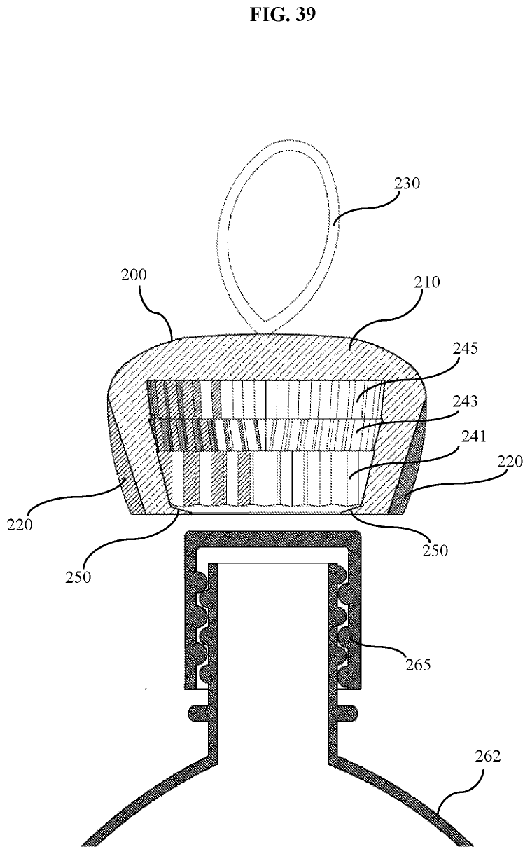

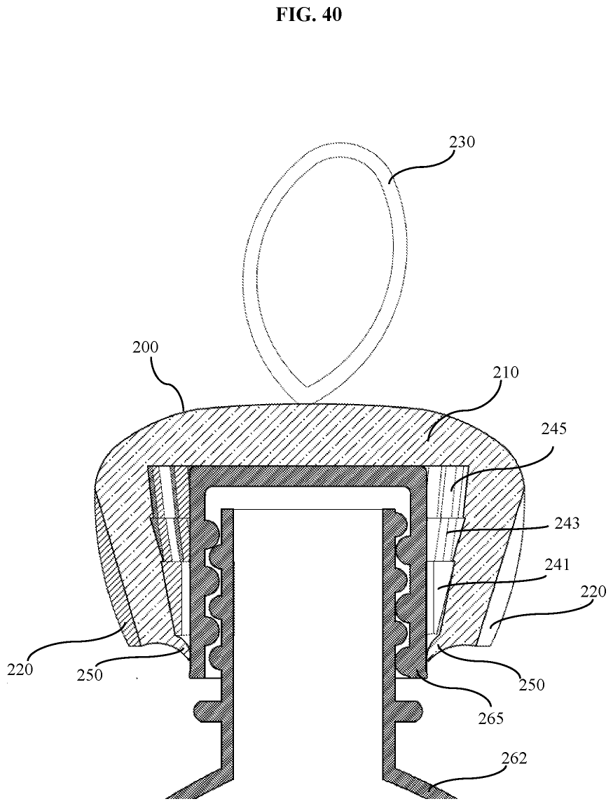

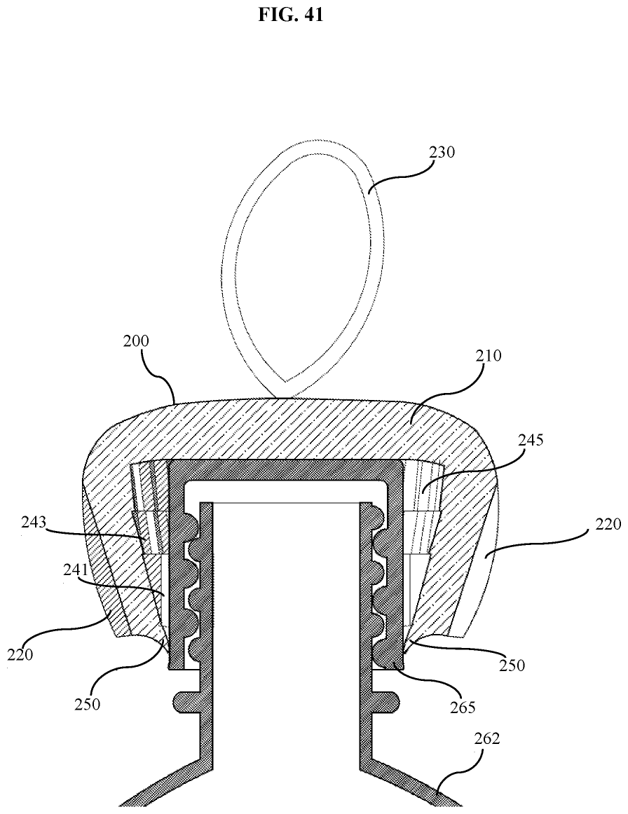

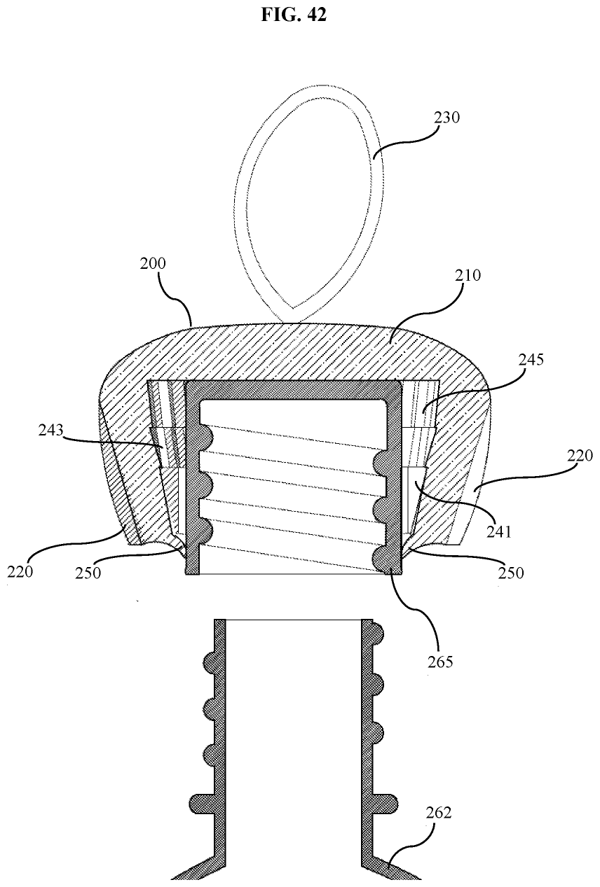

Referring now to another preferred embodiment of the present invention, in FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, and FIG. 42, a Cuboid Ergonomic Flexible Grip Container Opener 200 is shown. FIG. 10 illustrates a perspective view of a Cuboid Ergonomic Flexible Grip Container Opener 200. FIG. 11 depicts a front view a Cuboid Ergonomic Flexible Grip Container Opener 200. FIG. 12 illustrates a rear view of a Cuboid Ergonomic Flexible Grip Container Opener 200. FIG. 13 shows a corner view of a Cuboid Ergonomic Flexible Grip Container Opener 200. FIG. 14 displays a right-side view of a Cuboid Ergonomic Flexible Grip Container Opener 200. FIG. 15 shows a left-side view of a Cuboid Ergonomic Flexible Grip Container Opener 200. Because of the symmetry of the Cuboid Ergonomic Flexible Grip Container Opener 200, the front view in FIG. 11, the rear view in FIG. 12, the right-side view in FIG. 14, and the left-side view in FIG. 15, appear substantially identical. FIG. 16 depicts a top view of a Cuboid Ergonomic Flexible Grip Container Opener 200. FIG. 17 illustrates a bottom view of a Cuboid Ergonomic Flexible Grip Container Opener 200. FIG. 18 demonstrates a cutaway view of a Cuboid Ergonomic Flexible Grip Container Opener 200 with the cutaway slice indicated by a dotted line in FIG. 17. FIG. 19 shows a front view of a Cuboid Ergonomic Flexible Grip Container Opener 200 above a standard container 260. FIG. 20 depicts a front view of a Cuboid Ergonomic Flexible Grip Container Opener 200 mounted onto a standard lid 263 of a standard container 260. FIG. 21 illustrates a front view of a Cuboid Ergonomic Flexible Grip Container Opener 200 mounted onto a standard lid 263 of a standard container 260 and twisting the standard lid 263. FIG. 22 displays a front view of a Cuboid Ergonomic Flexible Grip Container Opener 200 mounted onto a standard lid 263 of a standard container 260 with the standard lid 263 removed from the standard container 260. FIG. 23 shows a cutaway view of a Cuboid Ergonomic Flexible Grip Container Opener 200 above a standard container 260. FIG. 24 depicts a cutaway view of a Cuboid Ergonomic Flexible Grip Container Opener 200 mounted onto a standard lid 263 of a standard container 260. FIG. 25 illustrates a cutaway view of a Cuboid Ergonomic Flexible Grip Container Opener 200 mounted onto a standard lid 263 of a standard container 260 and twisting the standard lid 263. FIG. 26 displays a cutaway view of a Cuboid Ergonomic Flexible Grip Container Opener 200 mounted onto a standard lid 263 of a standard container 260 with a standard lid 263 removed from a standard container 260. FIG. 27 shows a front view of a Cuboid Ergonomic Flexible Grip Container Opener 200 above a wide container 261. FIG. 28 depicts a front view of a Cuboid Ergonomic Flexible Grip Container Opener 200 mounted onto a wide lid 264 of a wide container 261. FIG. 29 illustrates a front view of a Cuboid Ergonomic Flexible Grip Container Opener 200 mounted onto a wide lid 264 of a wide container 261 and twisting the wide lid 264. FIG. 30 displays a front view of a Cuboid Ergonomic Flexible Grip Container Opener 200 mounted onto a wide lid 264 of a wide container 261 with the wide lid 264 removed from the wide container 261. FIG. 31 shows a cutaway view of a Cuboid Ergonomic Flexible Grip Container Opener 200 above a wide lid 264 of a wide container 261. FIG. 32 depicts a cutaway view of a Cuboid Ergonomic Flexible Grip Container Opener 200 mounted onto a wide lid 264 of a wide container 261. FIG. 33 illustrates a cutaway view of a Cuboid Ergonomic Flexible Grip Container Opener 200 mounted onto a wide lid 264 of a wide container 261 and twisting the wide lid 264. FIG. 34 displays a cutaway view of a Cuboid Ergonomic Flexible Grip Container Opener 200 mounted onto a wide lid 264 of a wide container 261 with the wide lid 264 removed from the wide container 261. FIG. 35 shows a front view of a Cuboid Ergonomic Flexible Grip Container Opener 200 above a tall container 262. FIG. 36 depicts a front view of a Cuboid Ergonomic Flexible Grip Container Opener 200 mounted onto a tall lid 265 of a tall container 262. FIG. 37 illustrates a front view of a Cuboid Ergonomic Flexible Grip Container Opener 200 mounted onto a tall lid 265 of a tall container 262 and twisting. FIG. 38 displays a front view of a Cuboid Ergonomic Flexible Grip Container Opener 200 mounted onto a tall lid 265 of a tall container 262 with the tall lid 265 removed from the tall container 262. FIG. 39 shows a cutaway view of a Cuboid Ergonomic Flexible Grip Container Opener 200 above a tall container 262. FIG. 40 depicts a cutaway view of a Cuboid Ergonomic Flexible Grip Container Opener 200 mounted onto a tall lid 265 of a tall container 262. FIG. 41 illustrates a cutaway view of a Cuboid Ergonomic Flexible Grip Container Opener 200 mounted onto a tall lid 265 of a tall container 262 and twisting the tall lid 265. FIG. 42 displays a cutaway view of a Cuboid Ergonomic Flexible Grip Container Opener 200 mounted onto a tall lid 265 of a tall container 262 with the tall lid 265 removed from the tall container 262.

Referring still to the preferred embodiment of the invention in FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, and FIG. 42, the Cuboid Ergonomic Flexible Grip Container Opener 200 comprises a cuboid padded body 210; a cuboid drawstring 230 depending from the top of the cuboid padded body 210; and a cuboid indentation 240, which is recessing into the bottom of the cuboid padded body 210 and capable of receiving a lid of a container. The cuboid padded body 210 comprises a size suitable to substantially fit in a hand comfortably without the hand needing to be substantially closed or tightly gripped; a soft, strong, flexible, pliable, resilient, and stretchable material, which is suitable for being comfortably gripped in a hand; and an outer shape with ergonomically fitting cuboid finger notches 220 set into each side (front, rear, right, and left sides) of the cuboid padded body 210. The cuboid padded body 210 also comprises a cuboid lip 250, which surrounds the opening of the cuboid indentation 240 and extends into it slightly. The cuboid indentation 240 comprises a square-shaped opening and three gripping surfaces within a recessed cavity: a cuboid lower gripping surface 241, a cuboid middle gripping surface 243, and a cuboid upper gripping surface 245. The cuboid lower gripping surface 241 is nearest the opening of the cuboid indentation 240 and comprises a plurality of surfaces, preferably a large number of surfaces, to engage a lid of a container at a large volume of multiple contact sites. The cuboid middle gripping surface 243 is similarly shaped and comprises a plurality of surfaces, preferably a large number of surfaces, to engage a lid of a container at a large volume of multiple contact sites; however, it has more surfaces than the cuboid lower gripping surface 241, and its surfaces are set at an offset angle to the cuboid lower gripping surface 241 in order to engage a lid of a container at a different angle than the cuboid lower gripping surface 241. The cuboid upper gripping surface 245 is also similarly shaped and comprises a plurality of surfaces, preferably a large number of surfaces, to engage a lid of a container at a large volume of multiple contact sites, and it also has more surfaces than the cuboid lower gripping surface 241; however, its surfaces are set at an offset angle to both the cuboid lower gripping surface 241 and the cuboid middle gripping surface 243 in order to engage a lid of a container at a different angle than both the cuboid lower gripping surface 241 and the cuboid middle gripping surface 243. The cuboid drawstring 230 depends from the top of the cuboid padded body 210 and provides additional leverage when removing a lid from a container.

In further detail, referring still to the preferred embodiment of the invention in FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, and FIG. 42; in FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, and FIG. 42, several sequence of events are depicted, which describe the process of using a Cuboid Ergonomic Flexible Grip Container Opener 200 to remove different types of lids from different types of containers. During use, the a soft, strong, flexible, pliable, resilient, and stretchable material, of the cuboid padded body 210 of a Cuboid Ergonomic Flexible Grip Container Opener 200 allows the apparatus to fit upon a wide variety sizes and shapes of container lids and is well-suited for being comfortably gripped by weak hands. FIG. 19, FIG. 20, FIG. 21, FIG. 22, FIG. 23, FIG. 24, FIG. 25, and FIG. 26, show a sequence of events for removing a standard lid 263 from a standard container 260 using a Cuboid Ergonomic Flexible Grip Container Opener 200. To use a Cuboid Ergonomic Flexible Grip Container Opener 200 to remove a standard lid 263 from a standard container 260, first a standard lid 263 fastened onto a standard container 260 is inserted into the cuboid indentation 240, as shown in FIG. 20 and FIG. 24. Because of the flexibility and stretchiness of the cuboid padded body 210 of a Cuboid Ergonomic Flexible Grip Container Opener 200, the cuboid padded body 210 and the cuboid lip 250 may be stretched or compressed over a lid, which does not necessarily match the size of the cuboid indentation 240. For lids that are smaller than the cuboid indentation 240, the soft, strong, flexible, pliable, resilient, and stretchable material, of the cuboid padded body 210 has the ability to compress and squeeze the cuboid indentation 240 around the lid. Next, once the Cuboid Ergonomic Flexible Grip Container Opener 200 is set onto the standard lid 263, the cuboid padded body 210 may be comfortably gripped, even by weak hands that have difficulty with tightly closing, and gently squeezed, and twisted, as shown in FIGS. 21 and 25. Although the hand that grips and turns the apparatus is not depicted, the cuboid distortion 271 is shown in FIG. 21 to illustrate the twisting of the apparatus while removing a standard lid 263. The soft, strong, flexible, pliable, resilient, and stretchable material, of the cuboid padded body 210 of a Cuboid Ergonomic Flexible Grip Container Opener 200 allows force from a gentle grip to be applied to the standard lid 263 while limiting this force from causing discomfort in a user's hands. The gentle squeezing of the Cuboid Ergonomic Flexible Grip Container Opener 200 allows the cuboid lower gripping surface 241, the cuboid middle gripping surface 243, and/or the cuboid upper gripping surface 245 to come into contact with the standard lid 263 of the standard container 260 within the cuboid indentation 240, as shown in FIG. 24 and FIG. 25. If the standard lid 263 is a pop-off lid, a user may use the cuboid drawstring 230 to assist in pulling the standard lid 263 off the standard container 260 without stressing weak hands. If the standard lid 263 is a screw-on lid, then, while continuing to squeeze the cuboid padded body 210 of a Cuboid Ergonomic Flexible Grip Container Opener 200, a user may twist the apparatus to cause the standard lid 263 to twist off of the standard container 260, as shown in FIGS. 21 and 25. Once the lid is removed from the container it may either be removed from the cuboid indentation 240 or remain in the cuboid indentation 240, as shown in FIG. 22 and FIG. 26, so that the Cuboid Ergonomic Flexible Grip Container Opener 200 may be used to attach the standard lid 263 to the standard container 260 again. FIG. 27, FIG. 28, FIG. 29, FIG. 30, FIG. 31, FIG. 32, FIG. 33, and FIG. 34, illustrate a sequence of events for removing a wide lid 264 from a wide container 261 using a Cuboid Ergonomic Flexible Grip Container Opener 200. To use a Cuboid Ergonomic Flexible Grip Container Opener 200 to remove a wide lid 264 from a wide container 261, first a wide lid 264 fastened onto a wide container 261 is inserted into the cuboid indentation 240, as shown in FIG. 28 and FIG. 32. Because of the flexibility and stretchiness of the cuboid padded body 210 of a Cuboid Ergonomic Flexible Grip Container Opener 200, the cuboid padded body 210 and the cuboid lip 250 may be stretched or compressed over a lid, which does not necessarily match the size of the cuboid indentation 240. For lids that are wider than the cuboid indentation 240, the soft, strong, flexible, pliable, resilient, and stretchable material, of the cuboid padded body 210 has the ability to be stretched so that the cuboid indentation 240 fits around the wider lid. Next, once the Cuboid Ergonomic Flexible Grip Container Opener 200 is set onto the wide lid 264, the cuboid padded body 210 may be comfortably gripped, even by weak hands that have difficulty with tightly closing, and gently squeezed, and twisted, as shown in FIGS. 29 and 33. Although the hand that grips and turns the apparatus is not depicted, the cuboid distortion 271 is shown in FIG. 29 to illustrate the twisting of the apparatus while removing a wide lid 264. The soft, strong, flexible, pliable, resilient, and stretchable material, of the cuboid padded body 210 of a Cuboid Ergonomic Flexible Grip Container Opener 200 allows force from a gentle grip to be applied to the wide lid 264 while limiting this force from causing discomfort in a user's hands. The gentle squeezing of the Cuboid Ergonomic Flexible Grip Container Opener 200 allows the cuboid lower gripping surface 241, the cuboid middle gripping surface 243, and/or the cuboid upper gripping surface 245 to come into contact with the wide lid 264 of the wide container 261 within the cuboid indentation 240, as shown in FIG. 32 and FIG. 33. If the wide lid 264 is a pop-off lid, a user may use the cuboid drawstring 230 to assist in pulling the wide lid 264 off the wide container 261 without stressing weak hands. If the wide lid 264 is a screw-on lid, then, while continuing to squeeze the cuboid padded body 210 of a Cuboid Ergonomic Flexible Grip Container Opener 200, a user may twist the apparatus to cause the wide lid 264 to twist off of the wide container 261, as shown in FIGS. 30 and 34. Once the wide lid 264 is removed from the wide container 261 it may either be removed from the cuboid indentation 240 or remain in the cuboid indentation 240, as shown in FIG. 30 and FIG. 34, so that the Cuboid Ergonomic Flexible Grip Container Opener 200 may be used to attach the wide lid 264 to the wide container 261 again. FIG. 35, FIG. 36, FIG. 37, FIG. 38, FIG. 39, FIG. 40, FIG. 41, and FIG. 42, depict a sequence of events for removing a tall lid 265 from a tall container 262 using a Cuboid Ergonomic Flexible Grip Container Opener 200. To use a Cuboid Ergonomic Flexible Grip Container Opener 200 to remove a tall lid 265 from a tall container 262, first a tall lid 265 fastened onto a tall container 262 is inserted into the cuboid indentation 240, as shown in FIG. 36 and FIG. 40. Because of the flexibility and stretchiness of the cuboid padded body 210 of a Cuboid Ergonomic Flexible Grip Container Opener 200, the cuboid padded body 210 and the cuboid lip 250 may be stretched or compressed over a lid, which does not necessarily match the size of the cuboid indentation 240. For lids that are taller than the cuboid indentation 240, the soft, strong, flexible, pliable, resilient, and stretchable material, of the cuboid padded body 210 has the ability to be stretched so that the cuboid indentation 240 fits around the tall lid 265. Next, once the Cuboid Ergonomic Flexible Grip Container Opener 200 is set onto the tall lid 265, the cuboid padded body 210 may be comfortably gripped, even by weak hands that have difficulty with tightly closing, and gently squeezed, and twisted, as shown in FIGS. 37 and 41. The soft, strong, flexible, pliable, resilient, and stretchable material, of the cuboid padded body 210 of a Cuboid Ergonomic Flexible Grip Container Opener 200 allows force from a gentle grip to be applied to the tall lid 265 while limiting this force from causing discomfort in a user's hands. The gentle squeezing of the Cuboid Ergonomic Flexible Grip Container Opener 200 allows the cuboid lower gripping surface 241, the cuboid middle gripping surface 243, and/or the cuboid upper gripping surface 245 to come into contact with the tall lid 265 of the tall container 262 within the cuboid indentation 240, as shown in FIG. 40 and FIG. 41. If the tall lid 265 is a pop-off lid, a user may use the cuboid drawstring 230 to assist in pulling the tall lid 265 off the tall container 262 without stressing weak hands. If the tall lid 265 is a screw-on lid, then, while continuing to squeeze the cuboid padded body 210 of a Cuboid Ergonomic Flexible Grip Container Opener 200, a user may twist the apparatus to cause the tall lid 265 to twist off of the tall container 262, as shown in FIGS. 38 and 42. Once the tall lid 265 is removed from the tall container 262 it may either be removed from the cuboid indentation 240 or remain in the cuboid indentation 240, as shown in FIG. 38 and FIG. 42, so that the Cuboid Ergonomic Flexible Grip Container Opener 200 may be used to attach the tall lid 265 to the tall container 262 again. The Cuboid Ergonomic Flexible Grip Container Opener 200 offers a comfortable solution, which allows a person with weak hands to open and close containers with lids.

The construction details of the invention as shown in FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, and FIG. 42, are as follows. The cuboid padded body 210 comprises a soft, strong, flexible, pliable, resilient, and stretchable material, or the like, which is suitable for being comfortably gripped in a hand, such as silicone, plastic, rubber, foam, composite material, soft wood, colloids, polymers, gels, emulsions, tissues, felt, cloth, or the like. The cuboid drawstring 230 comprises plastic, silicone, rope, twine, cloth, composite material, metal, chain, wire, string, fiber, or the like. The cuboid indentation 240 comprises a shaped cavity or space within the cuboid padded body 210. The cuboid finger notches 220 comprise indentions in the exterior of the cuboid padded body 210, which ergonomically conform to the shape of fingers, or the like. The cuboid lip 250 is a part of the cuboid padded body 210 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The cuboid lower gripping surface 241 is a part of the cuboid padded body 210 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The cuboid middle gripping surface 243 is a part of the cuboid padded body 210 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The cuboid upper gripping surface 245 is a part of the cuboid padded body 210 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. This version could also be used with an inner lining, as shown below with the most preferred embodiment of the invention. The materials listed herein are examples only and not intended to limit the scope of the present invention.

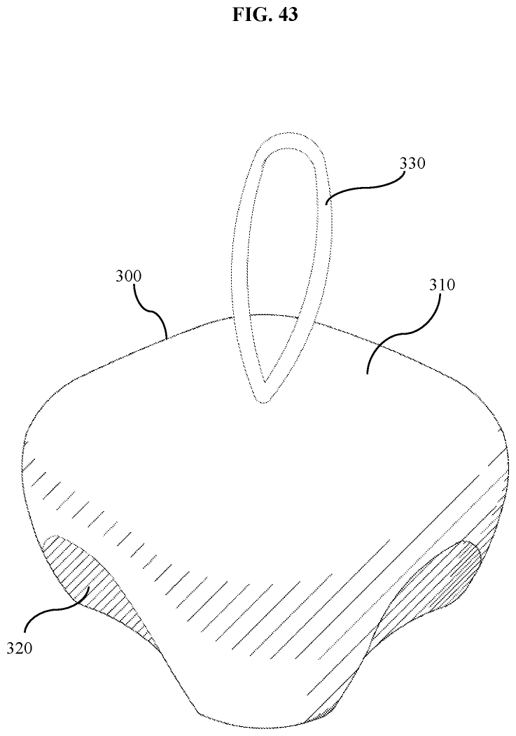

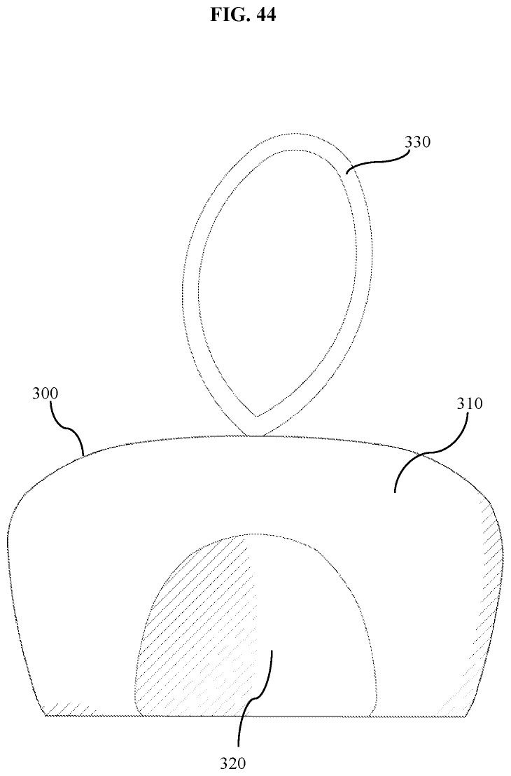

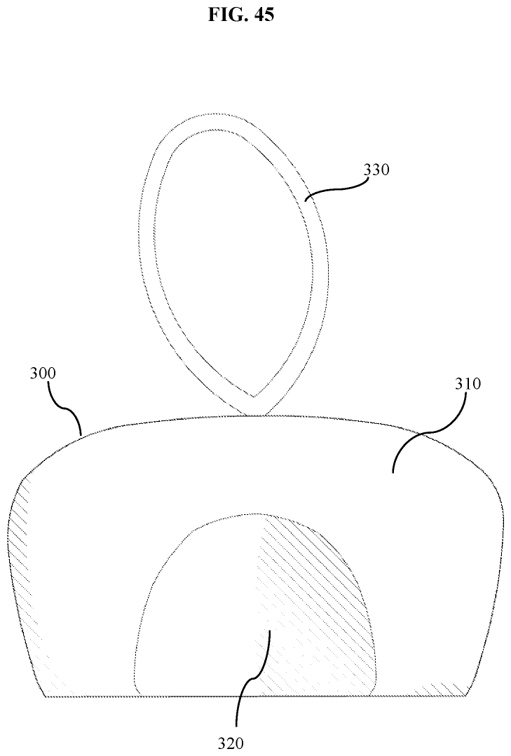

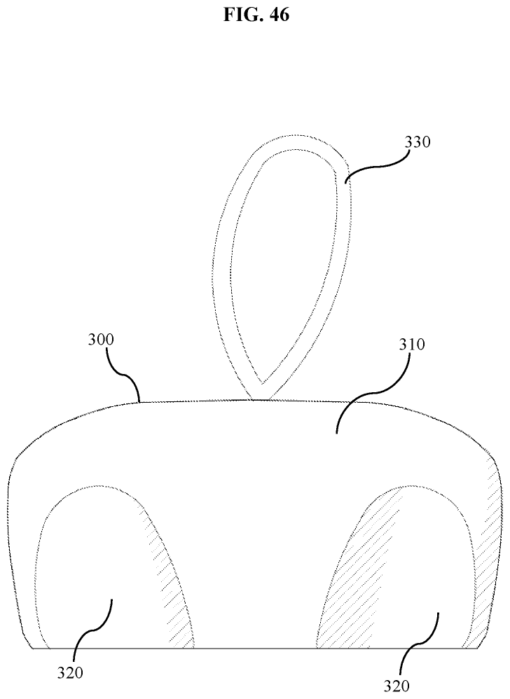

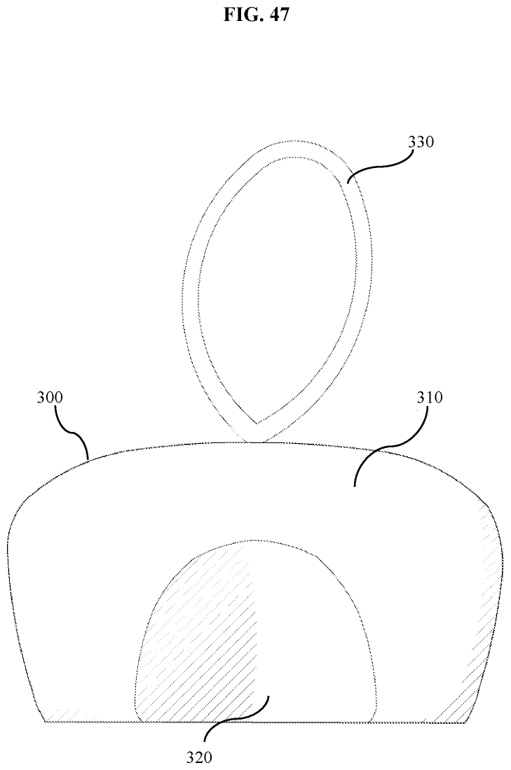

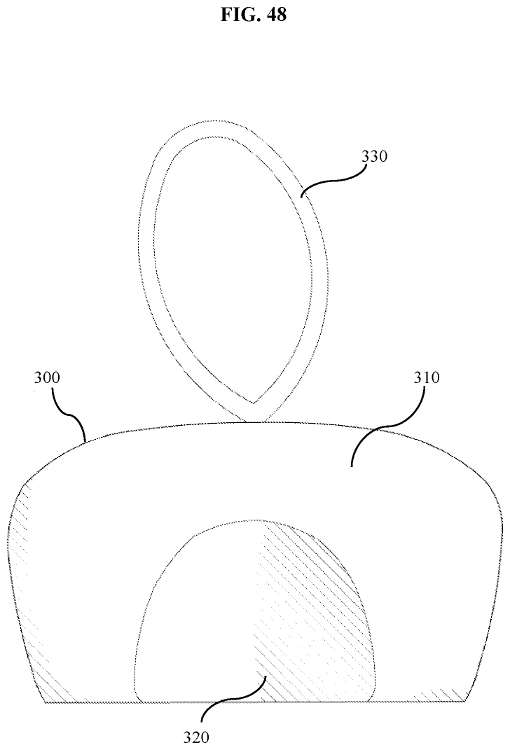

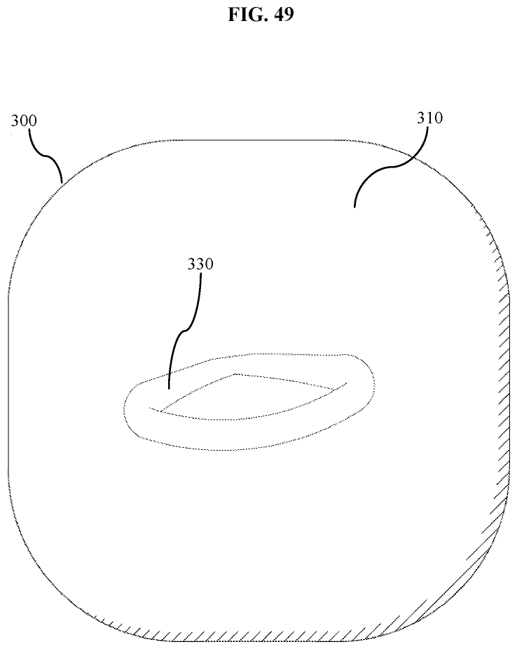

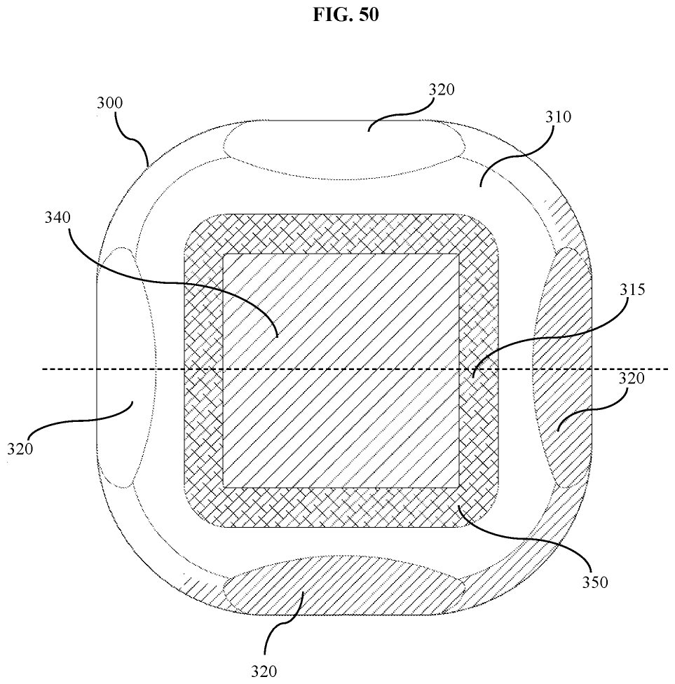

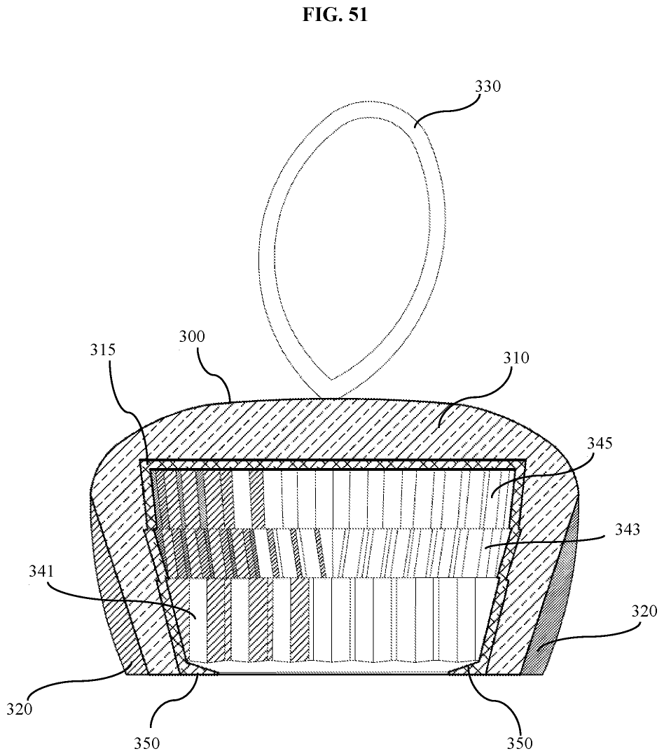

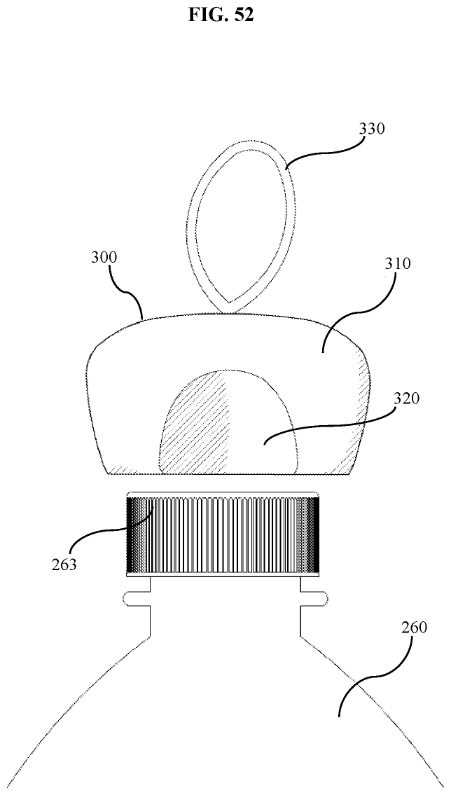

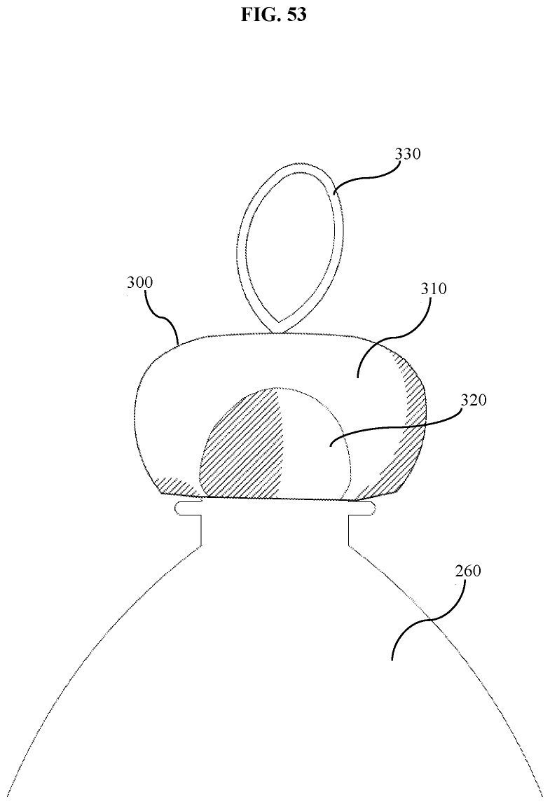

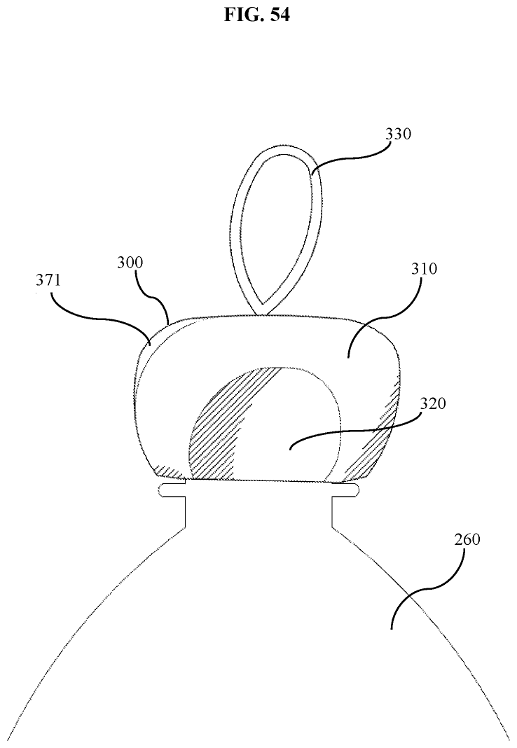

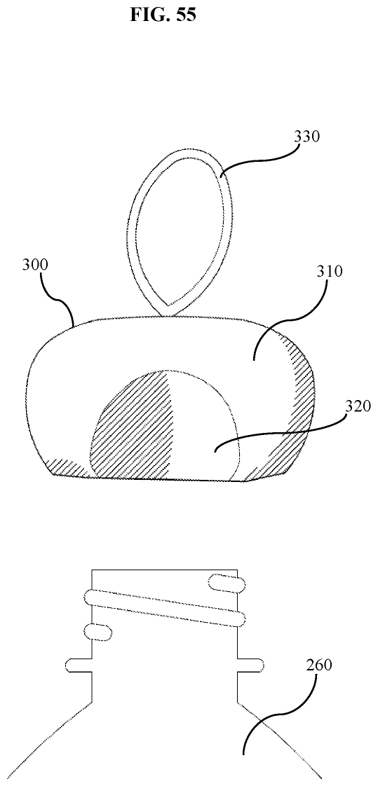

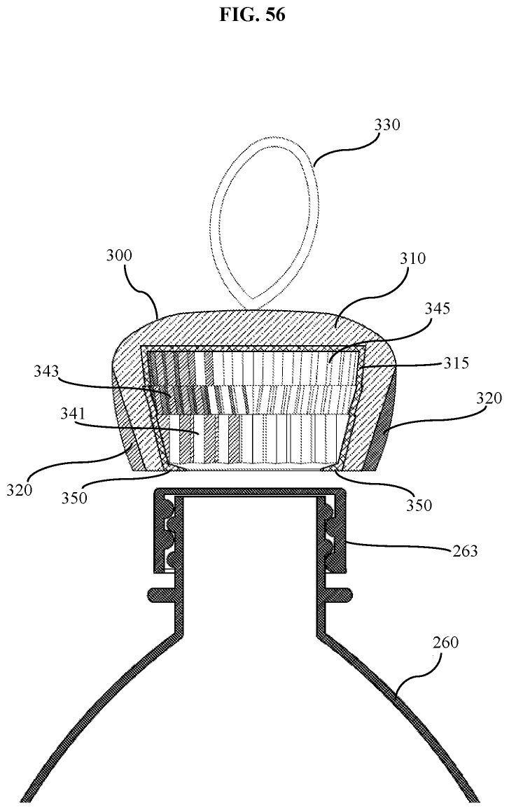

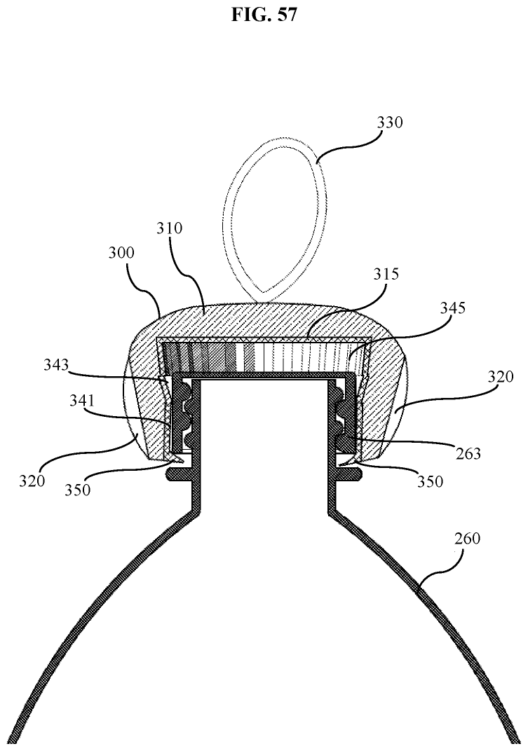

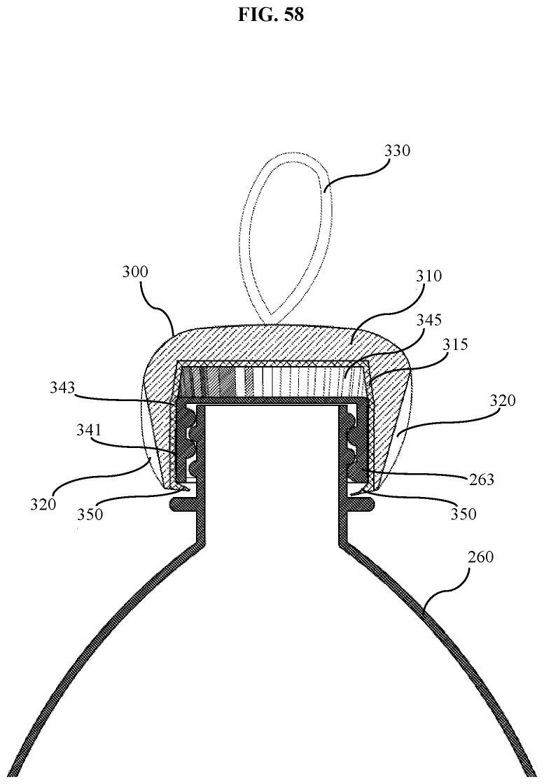

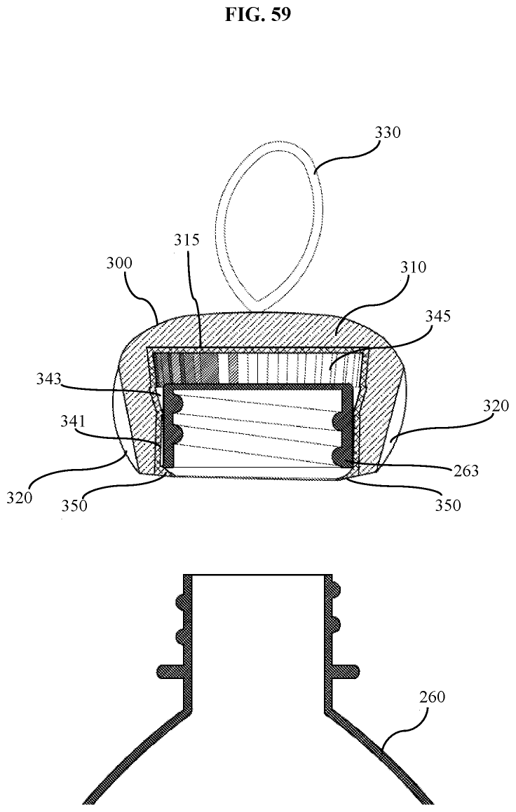

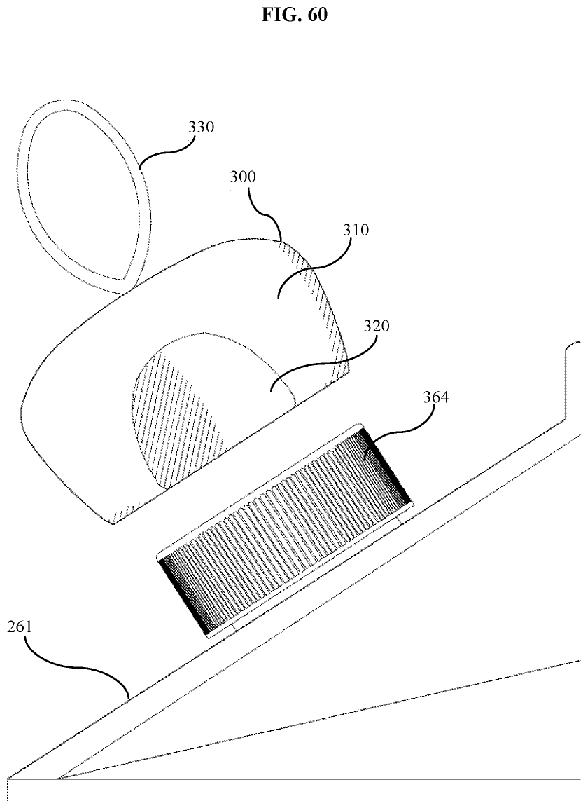

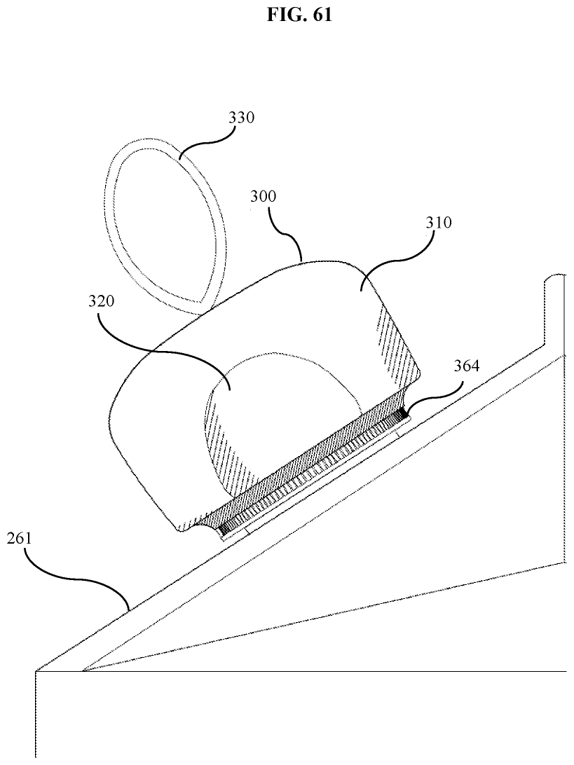

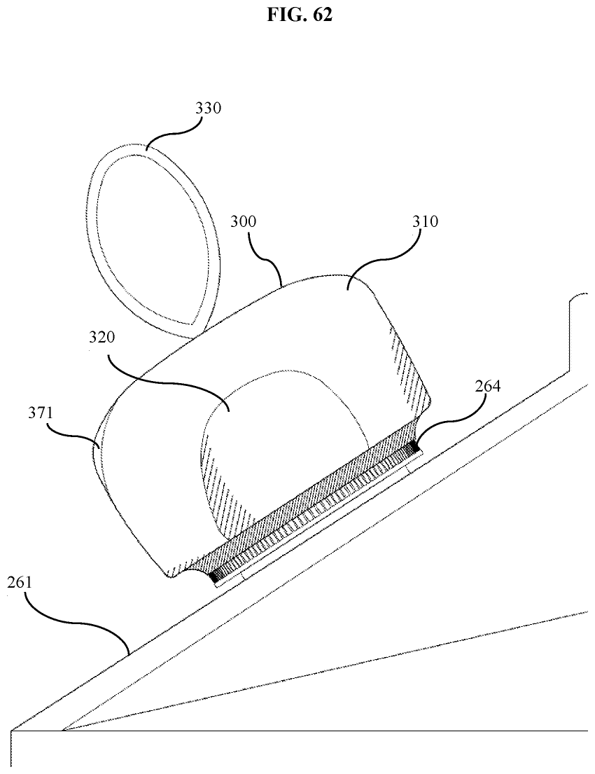

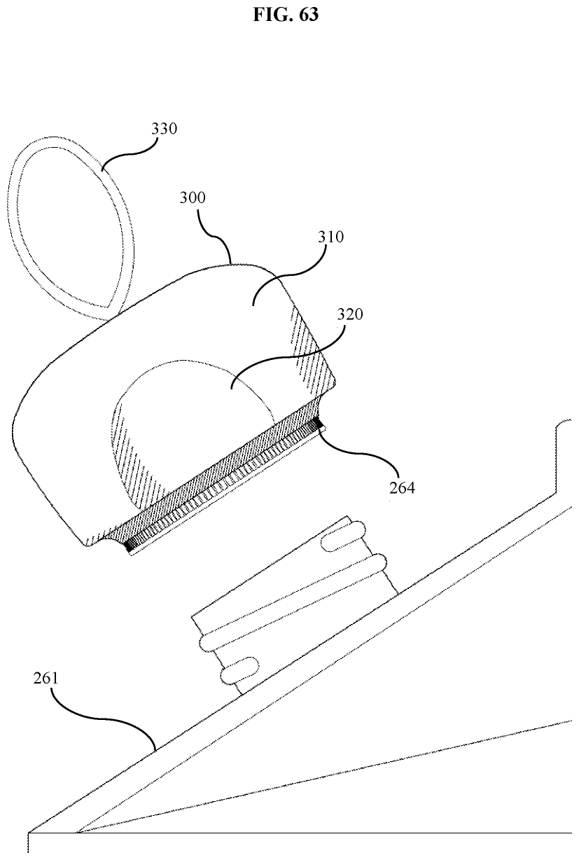

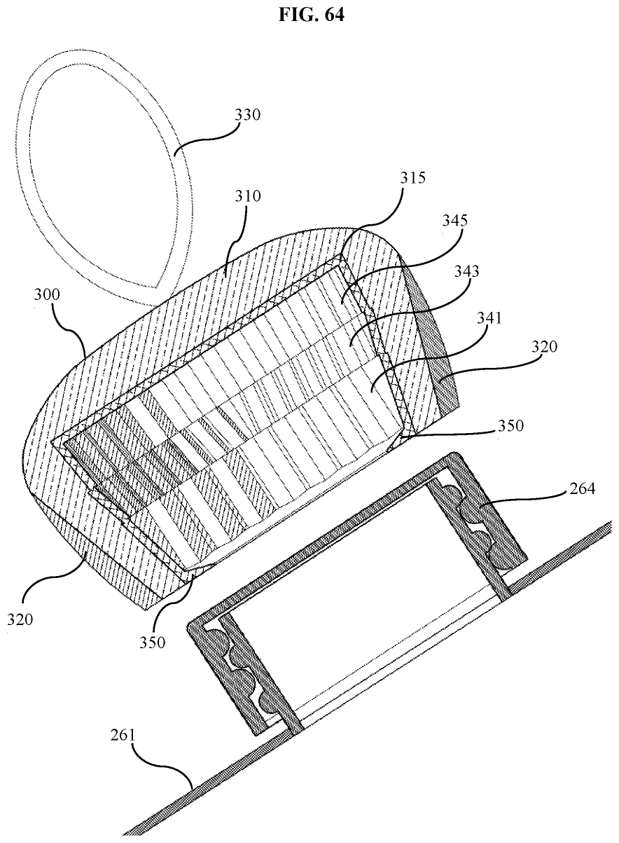

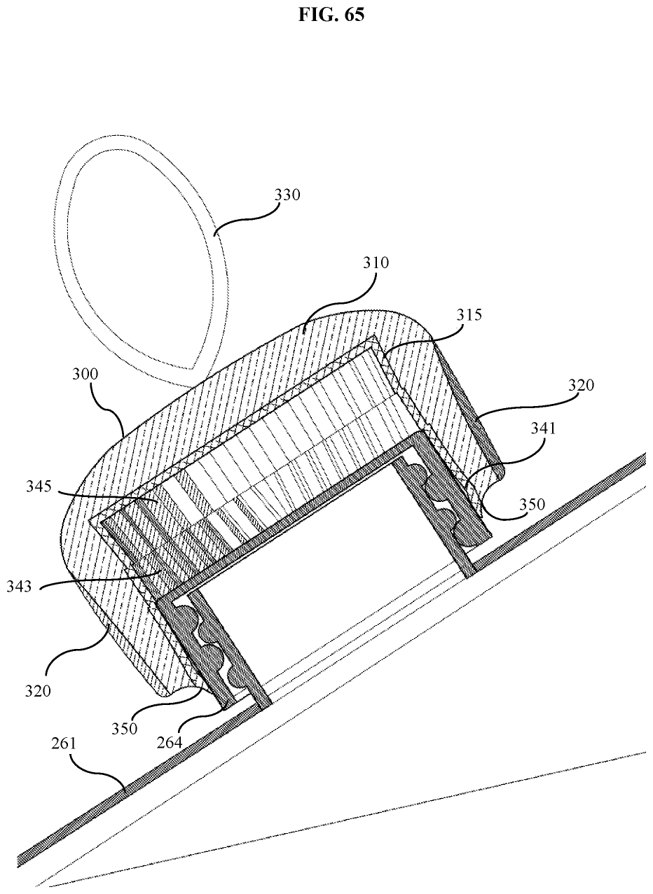

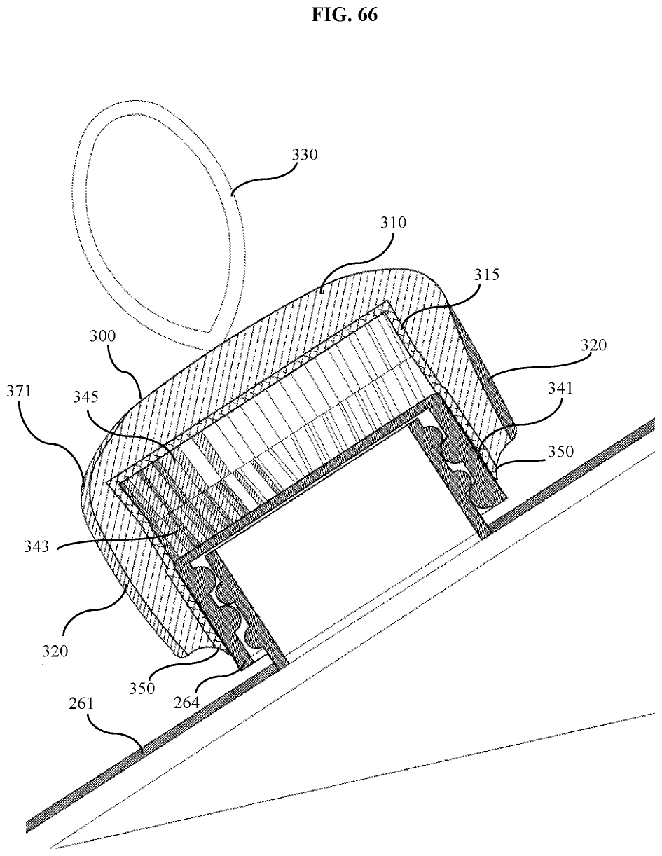

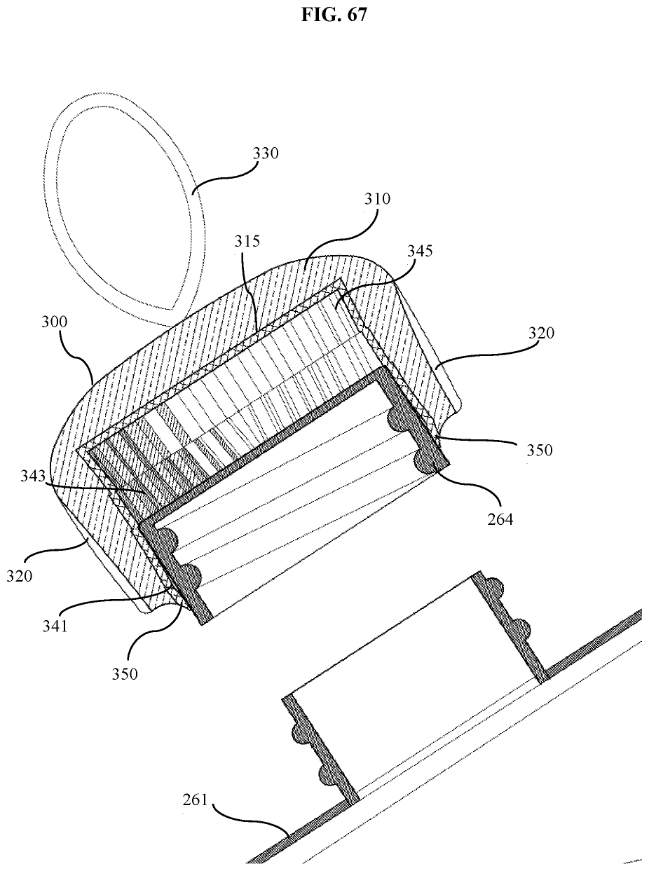

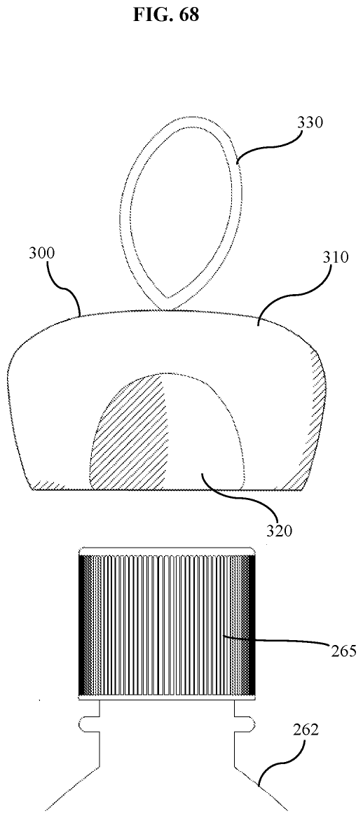

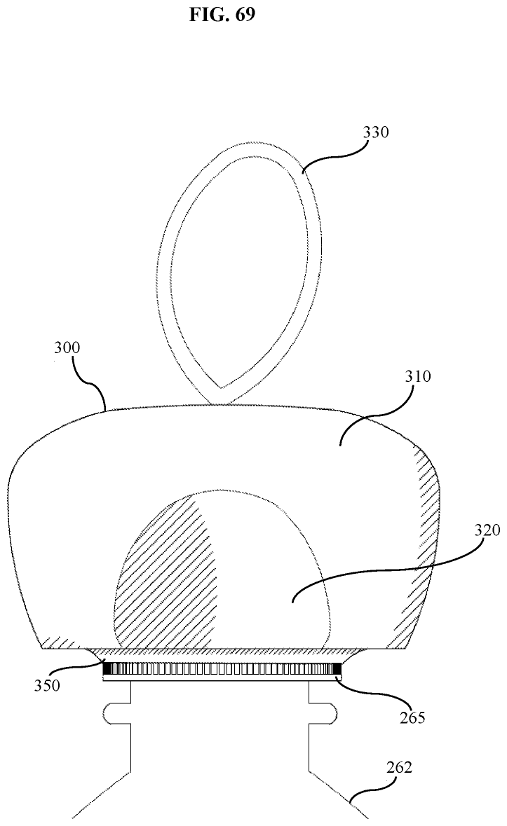

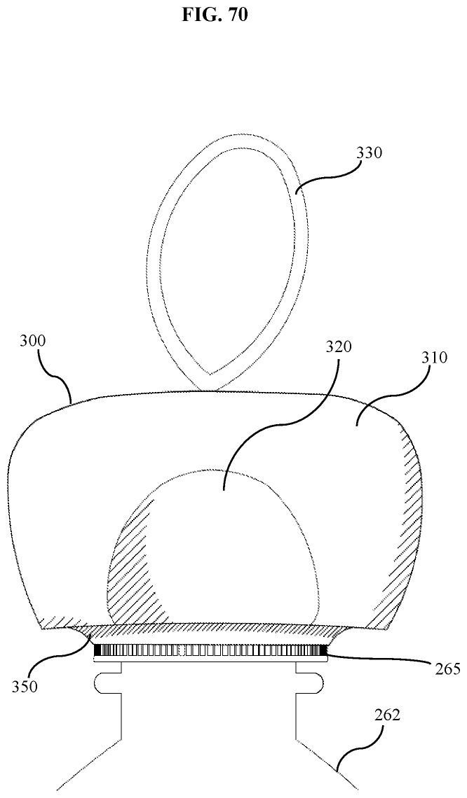

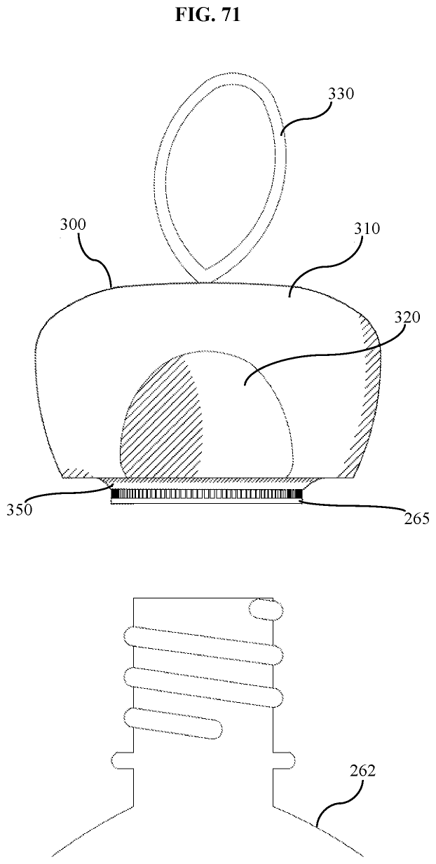

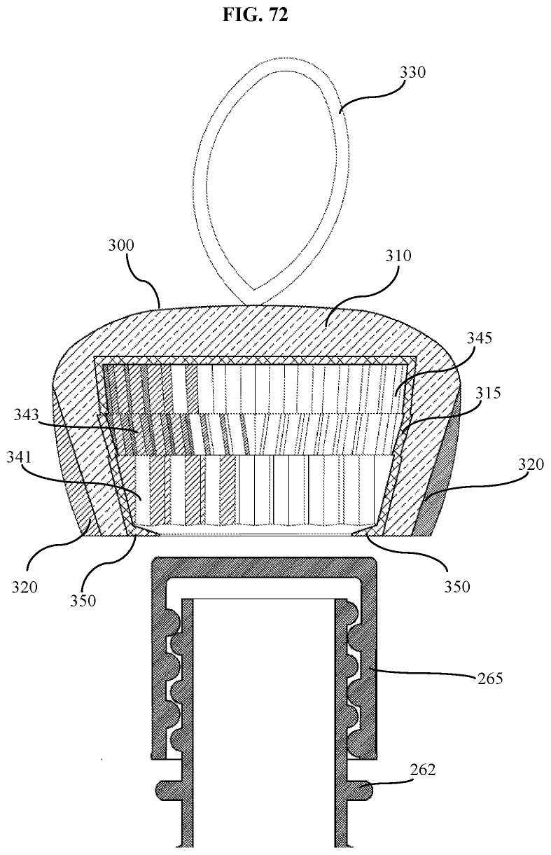

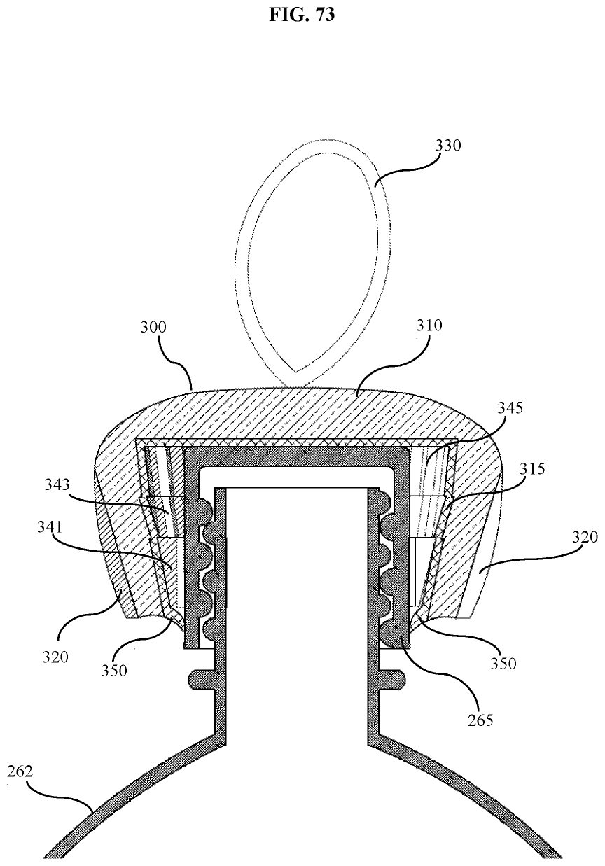

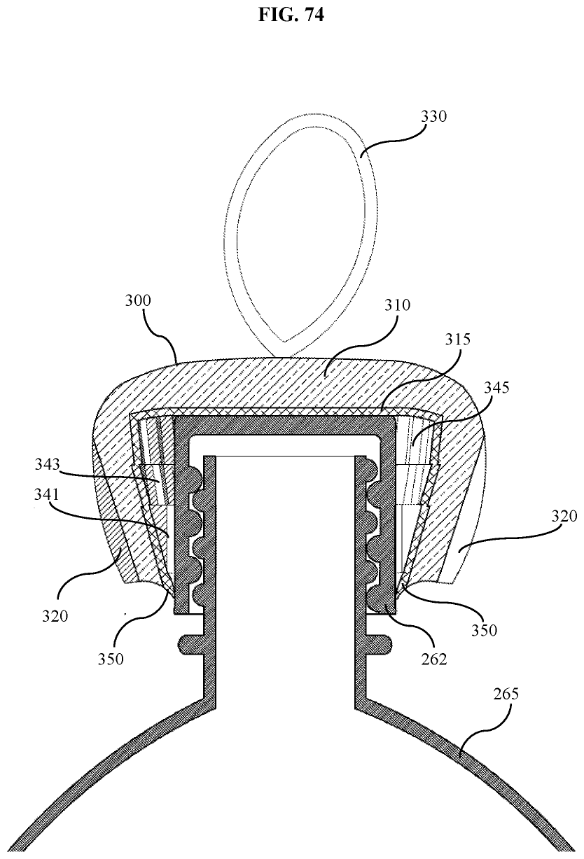

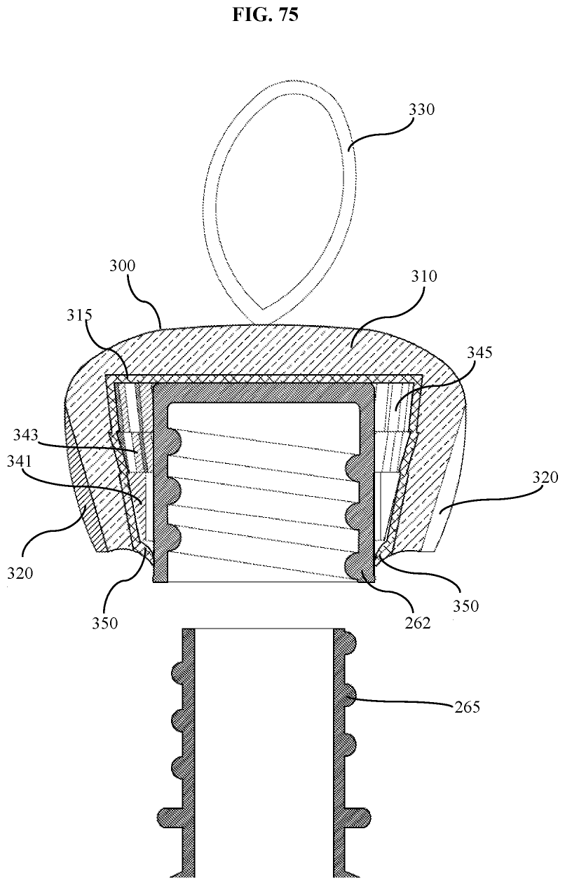

Referring now to the most preferred embodiment of the invention, in FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, and FIG. 75, a Lined Ergonomic Flexible Grip Container Opener 300 is shown. FIG. 43 depicts a perspective view of a Lined Ergonomic Flexible Grip Container Opener 300. FIG. 44 illustrates a front view of a Lined Ergonomic Flexible Grip Container Opener 300. FIG. 45 displays a rear view of a Lined Ergonomic Flexible Grip Container Opener 300. FIG. 46 shows a corner view of a Lined Ergonomic Flexible Grip Container Opener 300. FIG. 47 depicts a right-side view of a Lined Ergonomic Flexible Grip Container Opener 300. FIG. 48 illustrates a left-side view of a Lined Ergonomic Flexible Grip Container Opener 300. Because of the symmetry of the Lined Ergonomic Flexible Grip Container Opener 300, the front view in FIG. 44, the rear view in FIG. 45, the right-side view in FIG. 47, and the left-side view in FIG. 48, appear substantially identical. FIG. 49 displays a top view of a Lined Ergonomic Flexible Grip Container Opener 300. FIG. 50 shows a bottom view of a Lined Ergonomic Flexible Grip Container Opener 300. FIG. 51 depicts a cutaway view of a Lined Ergonomic Flexible Grip Container Opener 300 with the cutaway slice indicated by a dotted line in FIG. 50. FIG. 52 demonstrates a front view of a Lined Ergonomic Flexible Grip Container Opener 300 above a standard container 260. FIG. 53 displays a front view of a Lined Ergonomic Flexible Grip Container Opener 300 mounted onto a standard lid 263 of a standard container 260. FIG. 54 shows a front view of a Lined Ergonomic Flexible Grip Container Opener 300 mounted onto a standard lid 263 of a standard container 260 and twisting the lid. FIG. 55 depicts a front view of a Lined Ergonomic Flexible Grip Container Opener 300 mounted onto a standard lid 263 of a standard container 260 with the standard lid 263 removed from the standard container 260. FIG. 56 illustrates a cutaway view of a Lined Ergonomic Flexible Grip Container Opener 300 above a standard container 260. FIG. 57 displays a cutaway view of a Lined Ergonomic Flexible Grip Container Opener 300 mounted onto a standard lid 263 of a standard container 260. FIG. 58 shows a cutaway view of a Lined Ergonomic Flexible Grip Container Opener 300 mounted onto a standard lid 263 of a standard container 260 and twisting the standard lid 263. FIG. 59 depicts a cutaway view of a Lined Ergonomic Flexible Grip Container Opener 300 mounted onto a standard lid 263 of a standard container 260 with the standard lid 263 removed from the standard container 260. FIG. 60 illustrates a front view of a Lined Ergonomic Flexible Grip Container Opener 300 above a wide container 261. FIG. 61 displays a front view of a Lined Ergonomic Flexible Grip Container Opener 300 mounted onto a wide lid 264 of a wide container 261. FIG. 62 shows a front view of a Lined Ergonomic Flexible Grip Container Opener 300 mounted onto a wide lid 264 of a wide container 261 and twisting the wide lid 264. FIG. 63 depicts a front view of a Lined Ergonomic Flexible Grip Container Opener 300 mounted onto a wide lid 264 of a wide container 261 with the wide lid 264 removed from the wide container 261. FIG. 64 illustrates a cutaway view of a Lined Ergonomic Flexible Grip Container Opener 300 above a wide container 261. FIG. 65 displays a cutaway view of a Lined Ergonomic Flexible Grip Container Opener 300 mounted onto a wide lid 264 of a wide container 261. FIG. 66 shows a cutaway view of a Lined Ergonomic Flexible Grip Container Opener 300 mounted onto a wide lid 264 of a wide container 261 and twisting the wide lid 264. FIG. 67 depicts a cutaway view of a Lined Ergonomic Flexible Grip Container Opener 300 mounted onto a wide lid 264 of a wide container 261 with the wide lid 264 removed from the wide container 261. FIG. 68 illustrates a front view of a Lined Ergonomic Flexible Grip Container Opener 300 above a tall container 262. FIG. 69 demonstrates a front view of a Lined Ergonomic Flexible Grip Container Opener 300 mounted onto a tall lid 265 of a tall container 262. FIG. 70 shows a front view of a Lined Ergonomic Flexible Grip Container Opener 300 mounted onto a tall lid 265 of a tall container 262 and twisting. FIG. 71 depicts a front view of a Lined Ergonomic Flexible Grip Container Opener 300 mounted onto a tall lid 265 of a tall container 262 with the tall lid 265 removed from the tall container 262. FIG. 72 illustrates a cutaway view of a Lined Ergonomic Flexible Grip Container Opener 300 above a tall container 262. FIG. 73 displays a cutaway view of a Lined Ergonomic Flexible Grip Container Opener 300 mounted onto a tall lid 265 of a tall container 262. FIG. 74 shows a cutaway view of a Lined Ergonomic Flexible Grip Container Opener 300 mounted onto a tall lid 265 of a tall container 262 and twisting the lid. FIG. 75 depicts a cutaway view of a Lined Ergonomic Flexible Grip Container Opener 300 mounted onto a tall lid 265 of a tall container 262 with the tall lid 265 removed from the tall container 262.

Referring still to the most preferred embodiment of the invention in FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, and FIG. 75, the Lined Ergonomic Flexible Grip Container Opener 300 comprises a lined padded body 310; a lined drawstring 330 depending from the top of the lined padded body 310; a lined indentation 340, which is recessing into the bottom of the lined padded body 310 and capable of receiving a lid of a container; and an inner lining 315, which is bonded to the lined padded body 310 and lines the interior of the lined indentation 340. The lined padded body 310 comprises a size suitable to substantially fit in a hand comfortably without the hand needing to be substantially closed or tightly gripped; a soft, strong, flexible, pliable, resilient, and stretchable material, which is suitable for being comfortably gripped in a hand; and an outer shape with ergonomically fitting lined finger notches 320 set into each side (front, rear, right, and left sides) of the lined padded body 310. The inner lining 315, which is bonded to the lined padded body 310 and lines the interior of the lined indentation 340, comprises a thin, flexible, strong, resilient, stretchable, and hard material that is well-suiting for gripping the lids of containers while preventing slipping. The inner lining 315 also comprises a lined lip 350, which surrounds the opening of the lined indentation 340 and extends into it slightly. The lined indentation 340 comprises a square-shaped opening and three gripping surfaces within the recessed cavity: a lined lower gripping surface 341, a lined middle gripping surface 343, and a lined upper gripping surface 345. The lined lower gripping surface 341 is nearest the opening of the lined indentation 340 and comprises a plurality of surfaces, preferably a large number of surfaces, to engage a lid of a container at a large volume of multiple contact sites. The lined middle gripping surface 343 is similarly shaped and comprises a plurality of surfaces, preferably a large number of surfaces, to engage a lid of a container at a large volume of multiple contact sites; however, it has more surfaces than the lined lower gripping surface 341, and its surfaces are set at an offset angle to the lined lower gripping surface 341 in order to engage a lid of a container at a different angle than the lined lower gripping surface 341. The lined upper gripping surface 345 is also similarly shaped and comprises a plurality of surfaces, preferably a large number of surfaces, to engage a lid of a container at a large volume of multiple contact sites, and it also has more surfaces than the lined lower gripping surface 341; however, its surfaces are set at an offset angle to both the lined lower gripping surface 341 and the lined middle gripping surface 343 in order to engage a lid of a container at a different angle than both the lined lower gripping surface 341 and the lined middle gripping surface 343. The lined drawstring 330 depends from the top of the lined padded body 310 and provides additional leverage when removing a lid from a container. An inner lining may be used with any of the other versions, embodiments, or designs of the invention.

In further detail, referring still to the most preferred embodiment of the invention, in FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, and FIG. 75; in FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, and FIG. 75, several sequence of events are depicted, which describe the process of using a Lined Ergonomic Flexible Grip Container Opener 300 to remove different types of lids from different types of containers. During use, the a soft, strong, flexible, pliable, resilient, and stretchable material, of the lined padded body 310 of a Lined Ergonomic Flexible Grip Container Opener 300 allows the apparatus to fit upon a wide variety sizes and shapes of container lids and is well-suited for being comfortably gripped by weak hands. FIG. 52, FIG. 53, FIG. 54, FIG. 55, FIG. 56, FIG. 57, FIG. 58, and FIG. 59, show a sequence of events for removing a standard lid 263 from a standard container 260 using a Lined Ergonomic Flexible Grip Container Opener 300. To use a Lined Ergonomic Flexible Grip Container Opener 300 to remove a standard lid 263 from a standard container 260, first a standard lid 263 fastened onto a standard container 260 is inserted into the lined indentation 340, as shown in FIG. 53 and FIG. 57. Because of the flexibility and stretchiness of the lined padded body 310 and the inner lining 315 of a Lined Ergonomic Flexible Grip Container Opener 300, the lined padded body 310 and the lined lip 350 may be stretched or compressed over a lid, which does not necessarily match the size of the lined indentation 340. For lids that are smaller than the lined indentation 340, the soft, strong, flexible, pliable, resilient, and stretchable material, of the lined padded body 310 has the ability to compress and squeeze the lined indentation 340 around the lid. Next, once the Lined Ergonomic Flexible Grip Container Opener 300 is set onto the standard lid 263, the lined padded body 310 may be comfortably gripped, even by weak hands that have difficulty with tightly closing, and gently squeezed, and twisted, as shown in FIGS. 54 and 58. Although the hand that grips and turns the apparatus is not depicted, the lined distortion 371 is shown in FIG. 54 to illustrate the twisting of the apparatus while removing a standard lid 263. The soft, strong, flexible, pliable, resilient, and stretchable material, of the lined padded body 310 of a Lined Ergonomic Flexible Grip Container Opener 300 allows force from a gentle grip to be applied through the inner lining 315 and to the standard lid 263 while limiting this force from causing discomfort in a user's hands. The gentle squeezing of the Lined Ergonomic Flexible Grip Container Opener 300 allows the lined lower gripping surface 341, the lined middle gripping surface 343, and/or the lined upper gripping surface 345 of the inner lining 315 to come into contact with the standard lid 263 of the standard container 260 within the lined indentation 340, as shown in FIG. 57 and FIG. 58. If the standard lid 263 is a pop-off lid, a user may use the lined drawstring 330 to assist in pulling the standard lid 263 off the standard container 260 without stressing weak hands. If the standard lid 263 is a screw-on lid, then, while continuing to squeeze the lined padded body 310 of a Lined Ergonomic Flexible Grip Container Opener 300, a user may twist the apparatus to cause the standard lid 263 to twist off of the standard container 260, as shown in FIGS. 54 and 58. Once the standard lid 263 is removed from the standard container 260 it may either be removed from the lined indentation 340 or remain in the lined indentation 340, as shown in FIG. 55 and FIG. 59, so that the Lined Ergonomic Flexible Grip Container Opener 300 may be used to attach the standard lid 263 to the standard container 260 again. FIG. 60, FIG. 61, FIG. 62, FIG. 63, FIG. 64, FIG. 65, FIG. 66, and FIG. 67, illustrate a sequence of events for removing a wide lid 264 from a wide container 261 using a Lined Ergonomic Flexible Grip Container Opener 300. To use a Lined Ergonomic Flexible Grip Container Opener 300 to remove a wide lid 264 from a wide container 261, first a wide lid 264 fastened onto a wide container 261 is inserted into the lined indentation 340, as shown in FIG. 61 and FIG. 65. Because of the flexibility and stretchiness of the lined padded body 310 and the inner lining 315 of a Lined Ergonomic Flexible Grip Container Opener 300, the lined padded body 310 and the lined lip 350 may be stretched or compressed over a lid, which does not necessarily match the size of the lined indentation 340. For lids that are wider than the lined indentation 340, the soft, strong, flexible, pliable, resilient, and stretchable material of the lined padded body 310 and the stretchable material of the inner lining 315, have the ability to be stretched so that the lined indentation 340 fits around the wider lid. Next, once the Lined Ergonomic Flexible Grip Container Opener 300 is set onto the wide lid 264, the lined padded body 310 may be comfortably gripped, even by weak hands that have difficulty with tightly closing, and gently squeezed, and twisted, as shown in FIGS. 62 and 66, allowing the inner lining 315 to come into firm contact with the wide lid 264. Although the hand that grips and turns the apparatus is not depicted, the lined distortion 371 is shown in FIG. 62 to illustrate the twisting of the apparatus while removing a wide lid 264. The soft, strong, flexible, pliable, resilient, and stretchable material, of the lined padded body 310 of a Lined Ergonomic Flexible Grip Container Opener 300 allows force from a gentle grip to be applied through the inner lining 315 to the wide lid 264 while limiting this force from causing discomfort in a user's hands. The gentle squeezing of the Lined Ergonomic Flexible Grip Container Opener 300 allows the lined lower gripping surface 341, the lined middle gripping surface 343, and/or the lined upper gripping surface 345 of the inner lining 315 to come into contact with the wide lid 264 of the wide container 261 within the lined indentation 340, as shown in FIG. 65 and FIG. 66. If the wide lid 264 is a pop-off lid, a user may use the lined drawstring 330 to assist in pulling the wide lid 264 off the wide container 261 without stressing weak hands. If the wide lid 264 is a screw-on lid, then, while continuing to squeeze the lined padded body 310 of a Lined Ergonomic Flexible Grip Container Opener 300, a user may twist the apparatus to cause the wide lid 264 to twist off of the wide container 261, as shown in FIGS. 63 and 67. Once the wide lid 264 is removed from the wide container 261 it may either be removed from the lined indentation 340 or remain in the lined indentation 340, as shown in FIG. 63 and FIG. 67, so that the Lined Ergonomic Flexible Grip Container Opener 300 may be used to attach the wide lid 264 to the wide container 261 again. FIG. 68, FIG. 69, FIG. 70, FIG. 71, FIG. 72, FIG. 73, FIG. 74, and FIG. 75, depict a sequence of events for removing a tall lid 265 from a tall container 262 using a Lined Ergonomic Flexible Grip Container Opener 300. To use a Lined Ergonomic Flexible Grip Container Opener 300 to remove a tall lid 265 from a tall container 262, first a tall lid 265 fastened onto a tall container 262 is inserted into the lined indentation 340, as shown in FIG. 69 and FIG. 73. Because of the flexibility and stretchiness of the lined padded body 310 and the inner lining 315 of a Lined Ergonomic Flexible Grip Container Opener 300, the lined padded body 310 and the lined lip 350 may be stretched or compressed over a lid, which does not necessarily match the size of the lined indentation 340. For lids that are taller than the lined indentation 340, the soft, strong, flexible, pliable, resilient, and stretchable material, of the lined padded body 310 and the stretchable material of the inner lining 315 have the ability to be stretched so that the lined indentation 340 fits around the tall lid 265. Next, once the Lined Ergonomic Flexible Grip Container Opener 300 is set onto the tall lid 265, the lined padded body 310 may be comfortably gripped, even by weak hands that have difficulty with tightly closing, and gently squeezed, and twisted, as shown in FIGS. 70 and 74. The soft, strong, flexible, pliable, resilient, and stretchable material, of the lined padded body 310 of a Lined Ergonomic Flexible Grip Container Opener 300 allows force from a gentle grip to be applied through the inner lining 315 to the tall lid 265 while limiting this force from causing discomfort in a user's hands. The gentle squeezing of the Lined Ergonomic Flexible Grip Container Opener 300 allows the lined lower gripping surface 341, the lined middle gripping surface 343, and/or the lined upper gripping surface 345 of the inner lining 315 to come into firm contact with the tall lid 265 of the tall container 262 within the lined indentation 340, as shown in FIG. 73 and FIG. 74. If the tall lid 265 is a pop-off lid, a user may use the lined drawstring 330 to assist in pulling the tall lid 265 off the tall container 262 without stressing weak hands. If the tall lid 265 is a screw-on lid, then, while continuing to squeeze the lined padded body 310 of a Lined Ergonomic Flexible Grip Container Opener 300, a user may twist the apparatus to cause the tall lid 265 to twist off of the tall container 262, as shown in FIGS. 70 and 74. Once the tall lid 265 is removed from the tall container 262 it may either be removed from the lined indentation 340 or remain in the lined indentation 340, as shown in FIG. 71 and FIG. 75, so that the Lined Ergonomic Flexible Grip Container Opener 300 may be used to attach the tall lid 265 to the tall container 262 again. The Lined Ergonomic Flexible Grip Container Opener 300 offers a comfortable solution, which allows a person with weak hands to open and close containers with lids.

The construction details of the invention as shown in in FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, and FIG. 75, are as follows. The lined padded body 310 comprises a soft, strong, flexible, pliable, resilient, and stretchable material, or the like, which is suitable for being comfortably gripped in a hand, such as silicone, plastic, rubber, foam, composite material, soft wood, colloids, polymers, gels, emulsions, tissues, felt, cloth, or the like. The lined drawstring 330 comprises plastic, silicone, rope, twine, cloth, composite material, metal, chain, wire, string, fiber, or the like. The lined indentation 340 comprises a shaped cavity or space within the lined padded body 310. The inner lining 315, which is bonded to the lined padded body 310 and lines the interior of the lined indentation 340, comprises a thin, flexible, strong, resilient, stretchable, and hard material, or the like, that is well-suiting for gripping the lids of containers while preventing slipping, such as silicone, plastic, rubber, foam, composite material, colloids, polymers, gels, emulsions, tissues, felt, cloth, or the like. The lined finger notches 320 comprise indentions in the exterior of the lined padded body 310, which ergonomically conform to the shape of fingers, or the like. The lined lip 350 is a part of the inner lining 315 and comprises a thin, flexible, strong, resilient, stretchable, and hard material, or the like, such as silicone, plastic, rubber, foam, composite material, colloids, polymers, gels, emulsions, tissues, felt, cloth, or the like. The lined lower gripping surface 341 is a part of the inner lining 315 and comprises a thin, flexible, strong, resilient, stretchable, and hard material, or the like, such as silicone, plastic, rubber, foam, composite material, colloids, polymers, gels, emulsions, tissues, felt, cloth, or the like. The lined middle gripping surface 343 is a part of the inner lining 315 and comprises a thin, flexible, strong, resilient, stretchable, and hard material, or the like, such as silicone, plastic, rubber, foam, composite material, colloids, polymers, gels, emulsions, tissues, felt, cloth, or the like. The lined upper gripping surface 345 is a part of the inner lining 315 and comprises a thin, flexible, strong, resilient, stretchable, and hard material, or the like, such as silicone, plastic, rubber, foam, composite material, colloids, polymers, gels, emulsions, tissues, felt, cloth, or the like. The materials listed herein are examples only and not intended to limit the scope of the present invention.

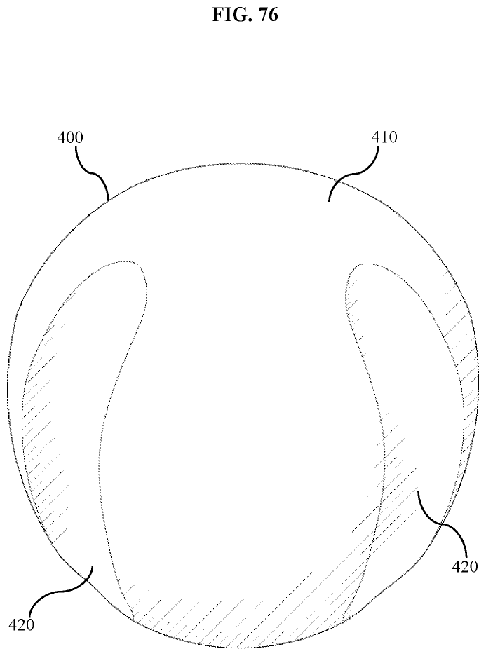

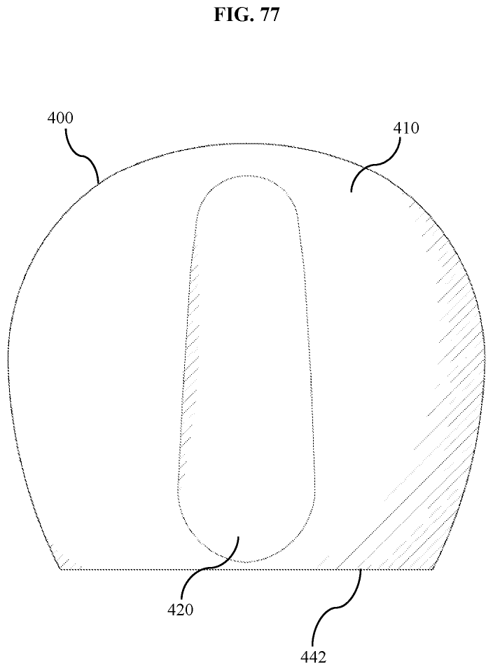

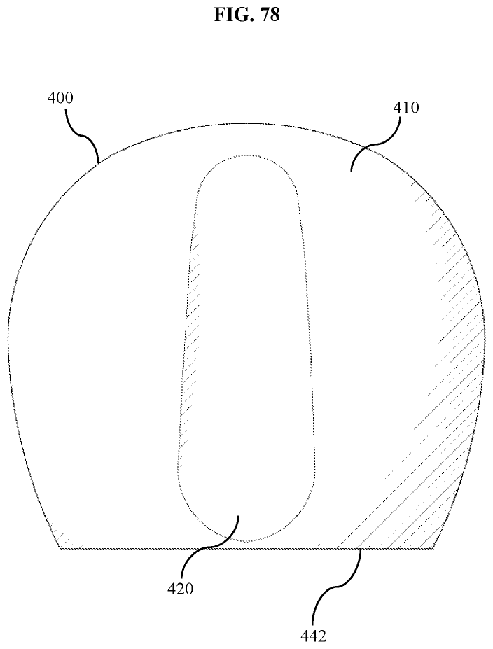

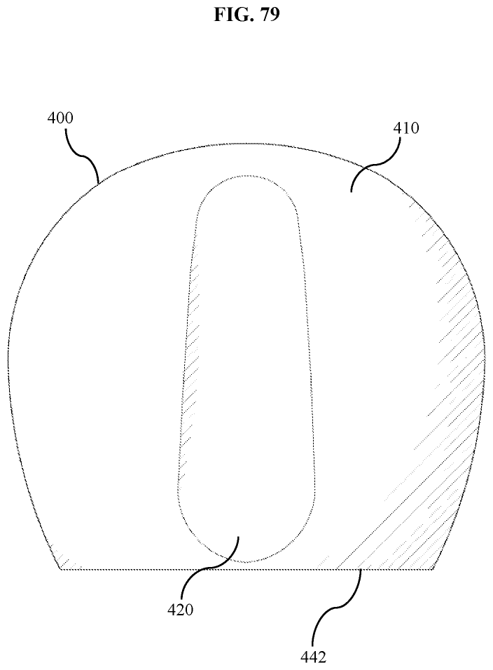

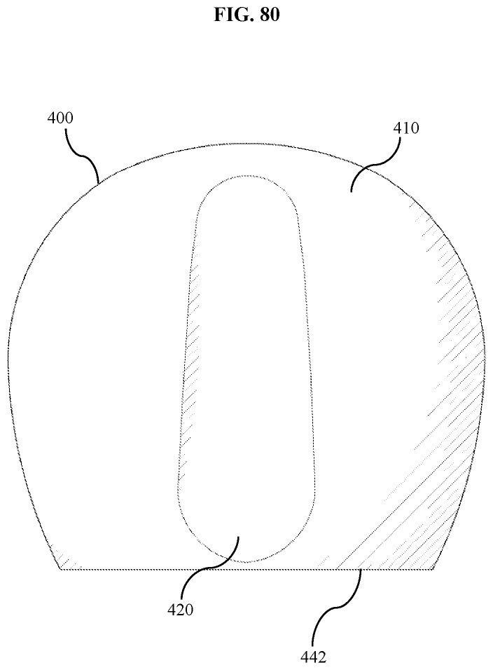

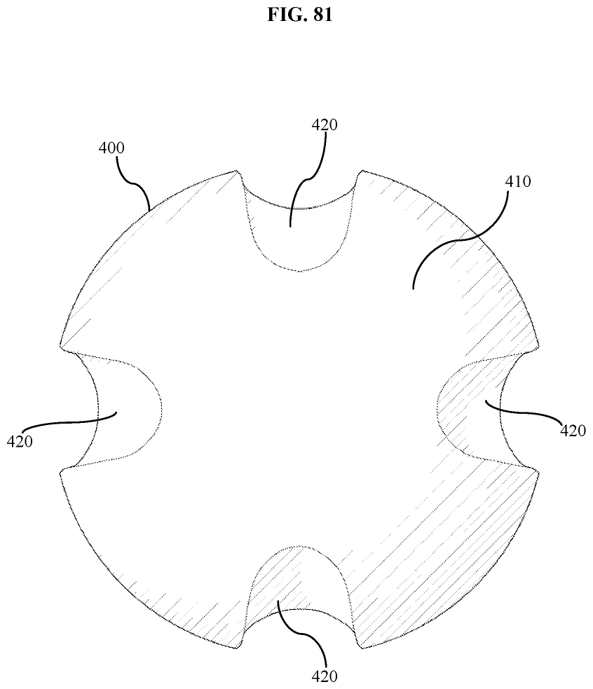

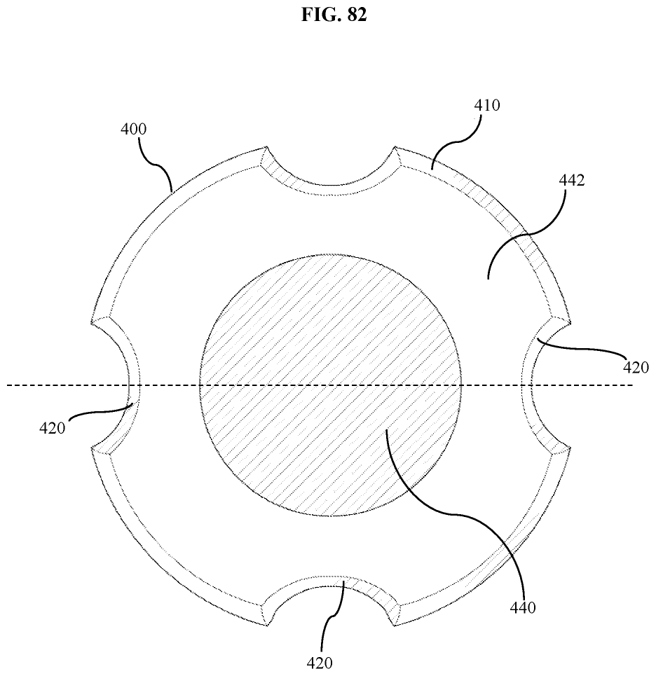

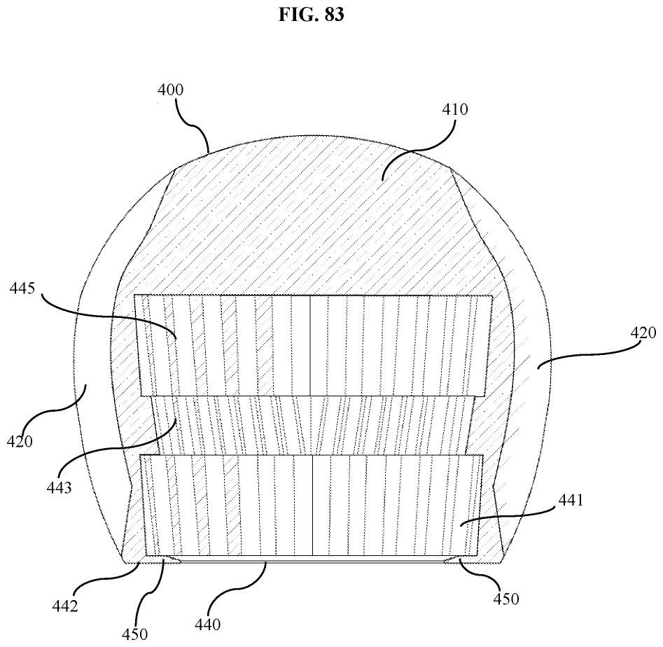

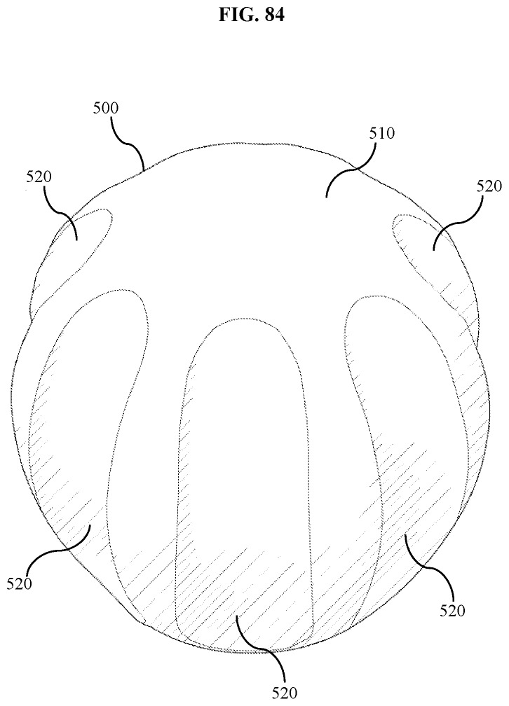

Referring now to another preferred embodiment of the invention, in FIG. 76, FIG. 77, FIG. 78, FIG. 79, FIG. 80, FIG. 81, FIG. 82, and FIG. 83, a Spheroid Ergonomic Flexible Grip Container Opener 400 is shown. FIG. 76 illustrates a perspective view of a Spheroid Ergonomic Flexible Grip Container Opener 400. FIG. 77 displays a front view of a Spheroid Ergonomic Flexible Grip Container Opener 400. FIG. 78 shows a rear view of a Spheroid Ergonomic Flexible Grip Container Opener 400. FIG. 79 depicts a right-side view of a Spheroid Ergonomic Flexible Grip Container Opener 400. FIG. 80 illustrates a left-side view of a Spheroid Ergonomic Flexible Grip Container Opener 400. Because of the symmetry of the Spheroid Ergonomic Flexible Grip Container Opener 400, the front view in FIG. 77, the rear view in FIG. 78, the right-side view in FIG. 79, and the left-side view in FIG. 80, appear substantially identical. FIG. 81 demonstrates a top view of a Spheroid Ergonomic Flexible Grip Container Opener 400. FIG. 82 shows a bottom view of a Spheroid Ergonomic Flexible Grip Container Opener 400. FIG. 83 depicts a cutaway view of a Spheroid Ergonomic Flexible Grip Container Opener 400 with the cutaway slice indicated by a dotted line in FIG. 82. FIG. 84 illustrates a perspective view of an Octo Spheroid Ergonomic Flexible Grip Container Opener 500, which is a slightly different version of a Spheroid Ergonomic Flexible Grip Container Opener 400 with twice as many ergonomic finger notches but with the remainder of the version being substantially identical, including the interior structure.

Referring still to the preferred embodiment of the invention in FIG. 76, FIG. 77, FIG. 78, FIG. 79, FIG. 80, FIG. 81, FIG. 82, FIG. 83, and FIG. 84, the Spheroid Ergonomic Flexible Grip Container Opener 400 comprises a spheroid padded body 410; and a spheroid indentation 440, which is recessing into the bottom of the spheroid padded body 410 and capable of receiving a lid of a container. The spheroid padded body 410 comprises a size suitable to substantially fit in a hand comfortably without the hand needing to be substantially closed or tightly gripped; a soft, strong, flexible, pliable, resilient, and stretchable material, which is suitable for being comfortably gripped in a hand; and an outer shape with ergonomically fitting spheroid finger notches 420 set into each side (front, rear, right, and left sides) of the spheroid padded body 410. The spheroid padded body 410 also comprises a spheroid lip 450, which surrounds the opening of the spheroid indentation 440 and extends into it slightly. The spheroid indentation 440 comprises a round opening and three gripping surfaces within the recessed cavity: a spheroid lower gripping surface 441, a spheroid middle gripping surface 443, and a spheroid upper gripping surface 445. The spheroid lower gripping surface 441 is nearest the opening of the spheroid indentation 440 and comprises a plurality of surfaces, preferably a large number of surfaces, to engage a lid of a container at a large volume of multiple contact sites. The spheroid middle gripping surface 443 is similarly shaped but with a more narrow diameter than the spheroid lower gripping surface 441 and comprises a plurality of surfaces, preferably a large number of surfaces, to engage a lid of a container at a large volume of multiple contact sites; however, it has more surfaces than the spheroid lower gripping surface 441, and its surfaces are set at an offset angle to the spheroid lower gripping surface 441 in order to engage a lid of a container at a different angle than the spheroid lower gripping surface 441. The spheroid upper gripping surface 445 is also similarly shaped with a similar diameter to the spheroid lower gripping surface 441 and comprises a plurality of surfaces, preferably a large number of surfaces, to engage a lid of a container at a large volume of multiple contact sites; however, its surfaces are set at an offset angle to both the spheroid lower gripping surface 441 and the spheroid middle gripping surface 443 in order to engage a lid of a container at a different angle than both the spheroid lower gripping surface 441 and the spheroid middle gripping surface 443. The Octo Spheroid Ergonomic Flexible Grip Container Opener 500 of FIG. 84 comprises an octo spheroid padded body 510; and an indentation substantially identical to the spheroid indentation 440, etc., which is recessing into the bottom of the octo spheroid padded body 510 and capable of receiving a lid of a container. The octo spheroid padded body 510 comprises a size suitable to substantially fit in a hand comfortably without the hand needing to be substantially closed or tightly gripped; a soft, strong, flexible, pliable, resilient, and stretchable material, which is suitable for being comfortably gripped in a hand; and further comprises an outer shape with eight ergonomically-fitting octo spheroid finger notches 520 set into the octo spheroid padded body 510.

In further detail, referring still to the preferred embodiment of the invention in FIG. 76, FIG. 77, FIG. 78, FIG. 79, FIG. 80, FIG. 81, FIG. 82, FIG. 83, and FIG. 84; during use, the a soft, strong, flexible, pliable, resilient, and stretchable material, of the spheroid padded body 410 of a Spheroid Ergonomic Flexible Grip Container Opener 400 or allows the apparatus to fit upon a wide variety sizes and shapes of container lids and is well-suited for being comfortably gripped by weak hands. To use a Spheroid Ergonomic Flexible Grip Container Opener 400, first a lid fastened onto a container is inserted into the spheroid indentation 440. Because of the flexibility and stretchiness of the spheroid padded body 410 of a Spheroid Ergonomic Flexible Grip Container Opener 400, the spheroid padded body 410 and the spheroid lip 450 may be stretched over a lid, which does not necessarily match the size of the spheroid indentation 440. Once the Spheroid Ergonomic Flexible Grip Container Opener 400 is set onto the lid, the spheroid padded body 410 may be comfortably gripped, even by weak hands that have difficulty with tightly closing, and gently squeezed, and twisted. The soft, strong, flexible, pliable, resilient, and stretchable material, of the spheroid padded body 410 of a Spheroid Ergonomic Flexible Grip Container Opener 400 allows force from a gentle grip to be applied to the lid while limiting this force from causing discomfort in a user's hands. The gentle squeezing of the Spheroid Ergonomic Flexible Grip Container Opener 400 allows the spheroid lower gripping surface 441, the spheroid middle gripping surface 443, and/or the spheroid upper gripping surface 445 to come into contact with the lid of the container within the spheroid indentation 440. To remove the lid, while continuing to squeeze the spheroid padded body 410 of a Spheroid Ergonomic Flexible Grip Container Opener 400, a user may twist the apparatus to cause the lid to twist off of the container. Once the lid is removed from the container it may either be removed from the spheroid indentation 440 or remain in the spheroid indentation 440 so that the Spheroid Ergonomic Flexible Grip Container Opener 400 may be used to attach the lid to the container again. The Octo Spheroid Ergonomic Flexible Grip Container Opener 500 functions in a substantially identical manner to the Spheroid Ergonomic Flexible Grip Container Opener 400 except that it further comprises additional ergonomically-fitting octo spheroid finger notches 520. The Spheroid Ergonomic Flexible Grip Container Opener 400 and the Octo Spheroid Ergonomic Flexible Grip Container Opener 500 offer comfortable solutions, which allows a person with weak hands to open and close containers with lids.

The construction details of the invention as shown in FIG. 76, FIG. 77, FIG. 78, FIG. 79, FIG. 80, FIG. 81, FIG. 82, FIG. 83, and FIG. 84, are as follows. The spheroid padded body 410 and the octo spheroid padded body 510 comprise a soft, strong, flexible, pliable, resilient, and stretchable material, or the like, which is suitable for being comfortably gripped in a hand, such as silicone, plastic, rubber, foam, composite material, soft wood, colloids, polymers, gels, emulsions, tissues, felt, cloth, or the like. The spheroid indentation 440 comprises a shaped cavity or space within the spheroid padded body 410. The spheroid finger notches 420 comprise indentions in the exterior of the spheroid padded body 410, which ergonomically conform to the shape of fingers, or the like. The octo spheroid finger notches 520 comprise indentions in the exterior of the octo spheroid padded body 510, which ergonomically conform to the shape of fingers, or the like. The spheroid lip 450 is a part of the spheroid padded body 410 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The spheroid lower gripping surface 441 is a part of the spheroid padded body 410 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The spheroid middle gripping surface 443 is a part of the spheroid padded body 410 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The spheroid upper gripping surface 445 is a part of the spheroid padded body 410 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. These versions could also be used with an inner lining and/or drawstring, as shown above with the most preferred embodiment of the invention. The materials listed herein are examples only and not intended to limit the scope of the present invention.

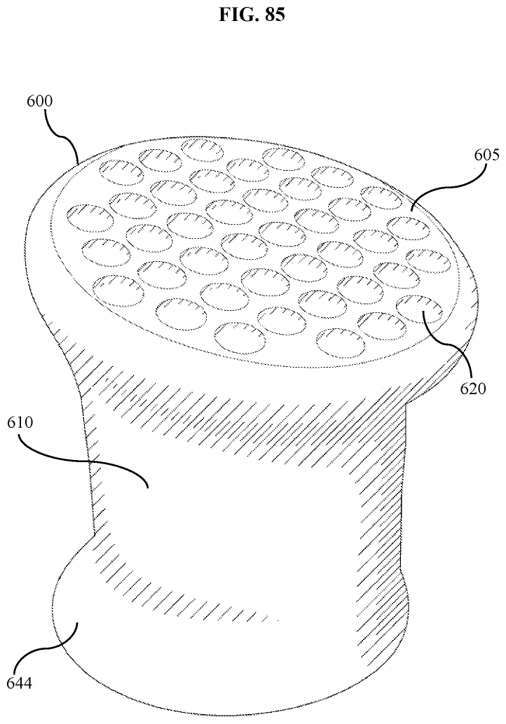

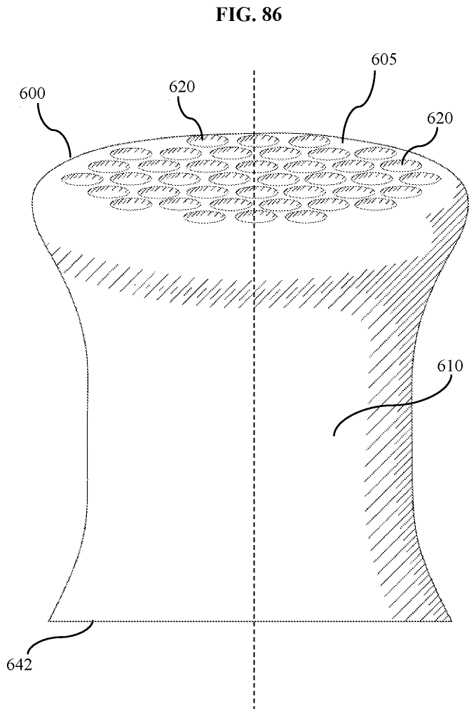

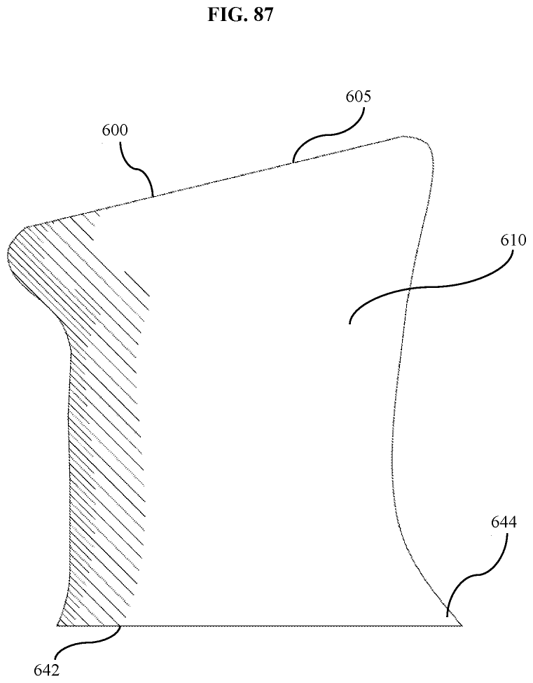

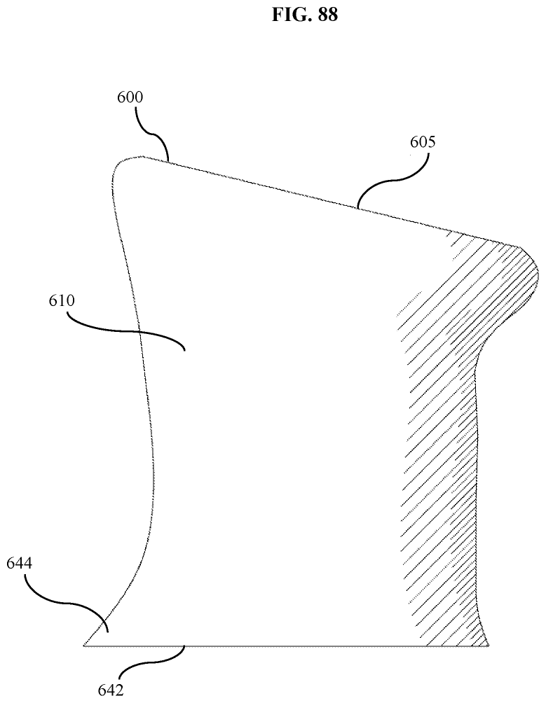

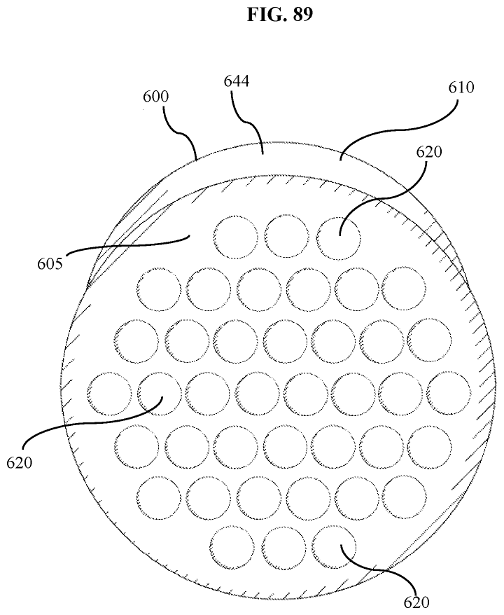

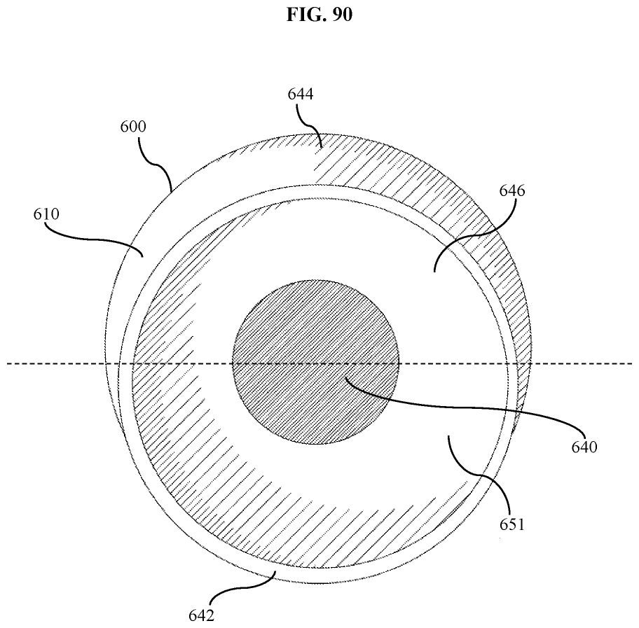

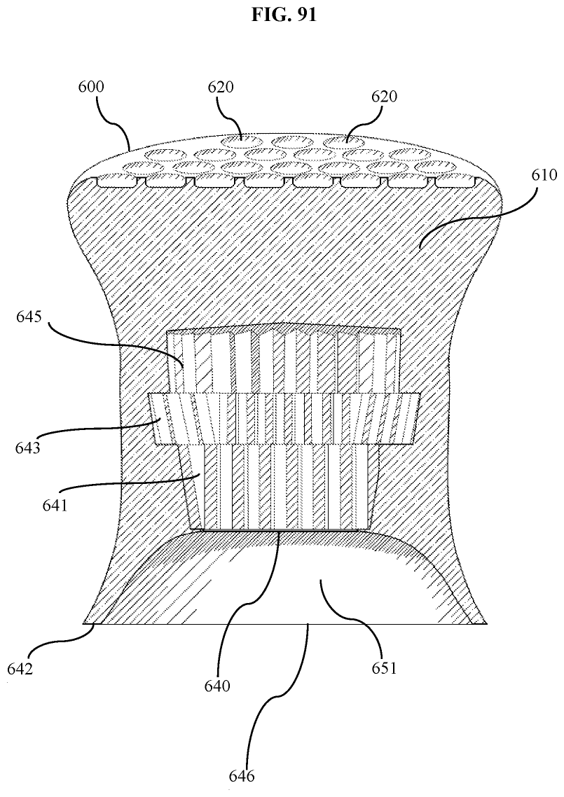

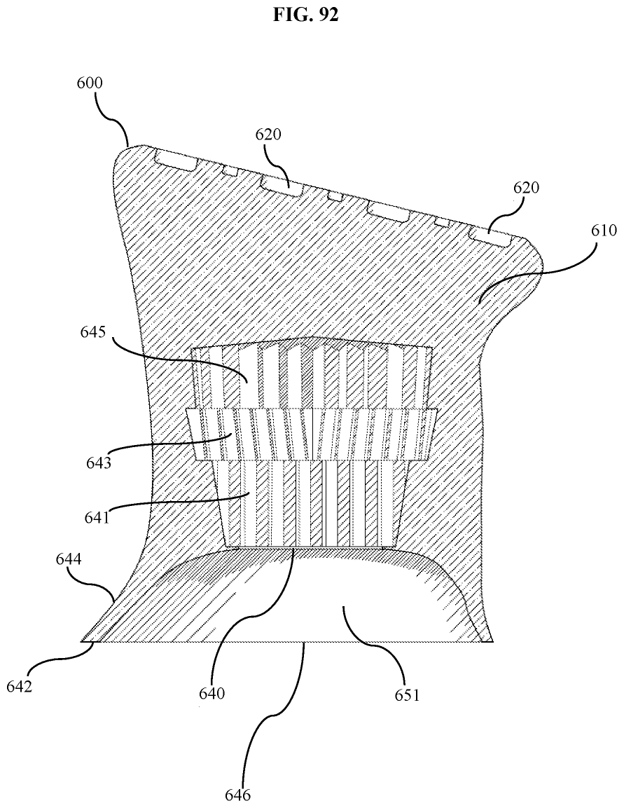

Referring now to another preferred embodiment of the invention, in FIG. 85, FIG. 86, FIG. 87, FIG. 88, FIG. 89, FIG. 90, FIG. 91, and FIG. 92, a Handled Ergonomic Flexible Grip Container Opener 600 is shown. FIG. 85 displays a perspective view of a Handled Ergonomic Flexible Grip Container Opener 600. FIG. 86 shows a front view of a Handled Ergonomic Flexible Grip Container Opener 600. FIG. 87 depicts a right-side view of a Handled Ergonomic Flexible Grip Container Opener 600. FIG. 88 illustrates a left-side view of a Handled Ergonomic Flexible Grip Container Opener 600. FIG. 89 displays a top view of a Handled Ergonomic Flexible Grip Container Opener 600. FIG. 90 demonstrates a bottom view of a Handled Ergonomic Flexible Grip Container Opener 600. FIG. 91 depicts a front cutaway view of a Handled Ergonomic Flexible Grip Container Opener 600 with the cutaway slice indicated by a dotted line in FIG. 90. FIG. 92 illustrates a left-side cutaway view of a Handled Ergonomic Flexible Grip Container Opener 600 with the cutaway slice indicated by a dotted line in FIG. 86.

Referring still to the preferred embodiment of the invention in FIG. 85, FIG. 86, FIG. 87, FIG. 88, FIG. 89, FIG. 90, FIG. 91, and FIG. 92, the Handled Ergonomic Flexible Grip Container Opener 600 comprises a handled padded body 610; and a handled indentation 640, which is recessing into the handled bottom 642 of the handled padded body 610 and capable of receiving a lid of a container. The handled padded body 610 comprises a size suitable to substantially fit in a hand comfortably without the hand needing to be substantially closed or tightly gripped; a soft, strong, flexible, pliable, resilient, and stretchable material, which is suitable for being comfortably gripped in a hand; and a handle shape with a handled top 605 and a handled bottom 642. The handled top 605 comprises a plurality of handled notches 620, which help a weak hand to grip the apparatus. The handled bottom 642 comprises a handled lip 650, which surrounds the opening of the handled indentation 640 and extends into it slightly. The handled bottom 642 also comprises a handled indentation 640, which comprises a round opening and three gripping surfaces within the recessed cavity: a handled lower gripping surface 641, a handled middle gripping surface 643, and a handled upper gripping surface 645. The handled lower gripping surface 641 is nearest the opening of the handled indentation 640 and comprises a plurality of surfaces, preferably a large number of surfaces, to engage a lid of a container at a large volume of multiple contact sites. The handled middle gripping surface 643 is similarly shaped but with a wider diameter than the handled lower gripping surface 641 and comprises a plurality of surfaces, preferably a large number of surfaces, to engage a lid of a container at a large volume of multiple contact sites; however, it has more surfaces than the handled lower gripping surface 641, and its surfaces are set at an offset angle to the handled lower gripping surface 641 in order to engage a lid of a container at a different angle than the handled lower gripping surface 641. The handled upper gripping surface 645 is also similarly shaped with a similar diameter to the handled lower gripping surface 641 and comprises a plurality of surfaces, preferably a large number of surfaces, to engage a lid of a container at a large volume of multiple contact sites; however, its surfaces are set at an offset angle to both the handled lower gripping surface 641 and the handled middle gripping surface 643 in order to engage a lid of a container at a different angle than both the handled lower gripping surface 641 and the handled middle gripping surface 643.

In further detail, referring still to the preferred invention in FIG. 85, FIG. 86, FIG. 87, FIG. 88, FIG. 89, FIG. 90, FIG. 91, and FIG. 92; during use, the a soft, strong, flexible, pliable, resilient, and stretchable material, of the handled padded body 610 of a Handled Ergonomic Flexible Grip Container Opener 600 or allows the apparatus to fit upon a wide variety sizes and shapes of container lids and is well-suited for being comfortably gripped by weak hands. To use a Handled Ergonomic Flexible Grip Container Opener 600, first a lid fastened onto a container is inserted into the handled indentation 640. Because of the flexibility and stretchiness of the handled padded body 610 of a Handled Ergonomic Flexible Grip Container Opener 600, the handled padded body 610 and the handled lip 650 may be stretched over a lid, which does not necessarily match the size of the handled indentation 640. Once the Handled Ergonomic Flexible Grip Container Opener 600 is set onto the lid, the handled padded body 610 may be comfortably gripped, even by weak hands that have difficulty with tightly closing, and gently squeezed, and twisted. The soft, strong, flexible, pliable, resilient, and stretchable material, of the handled padded body 610 of a Handled Ergonomic Flexible Grip Container Opener 600 allows force from a gentle grip to be applied to the lid while limiting this force from causing discomfort in a user's hands. The gentle squeezing of the Handled Ergonomic Flexible Grip Container Opener 600 allows the handled lower gripping surface 641, the handled middle gripping surface 643, and/or the handled upper gripping surface 645 to come into contact with the lid of the container within the handled indentation 640. To remove the lid, while continuing to squeeze the handled padded body 610 of a Handled Ergonomic Flexible Grip Container Opener 600, a user may twist the apparatus to cause the lid to twist off of the container. Once the lid is removed from the container it may either be removed from the handled indentation 640 or remain in the handled indentation 640 so that the Handled Ergonomic Flexible Grip Container Opener 600 may be used to attach the lid to the container again. The Handled Ergonomic Flexible Grip Container Opener 600 offers a comfortable solution, which allows a person with weak hands to open and close containers with lids.

The construction details of the invention as shown in 85, FIG. 86, FIG. 87, FIG. 88, FIG. 89, FIG. 90, FIG. 91, and FIG. 92, are as follows. The handled padded body 610 comprises a soft, strong, flexible, pliable, resilient, and stretchable material, or the like, which is suitable for being comfortably gripped in a hand, such as silicone, plastic, rubber, foam, composite material, soft wood, colloids, polymers, gels, emulsions, tissues, felt, cloth, or the like. The handled indentation 640 comprises a shaped cavity or space within the handled padded body 610. The handled notches 620 comprise indentions in the exterior of the handled padded body 610, or the like. The handled lip 650 is a part of the handled padded body 610 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The handled lower gripping surface 641 is a part of the handled padded body 610 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The handled middle gripping surface 643 is a part of the handled padded body 610 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The handled upper gripping surface 645 is a part of the handled padded body 610 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. This version could also be used with an inner lining and/or drawstring, as shown above with the most preferred embodiment of the invention. The materials listed herein are examples only and not intended to limit the scope of the present invention.

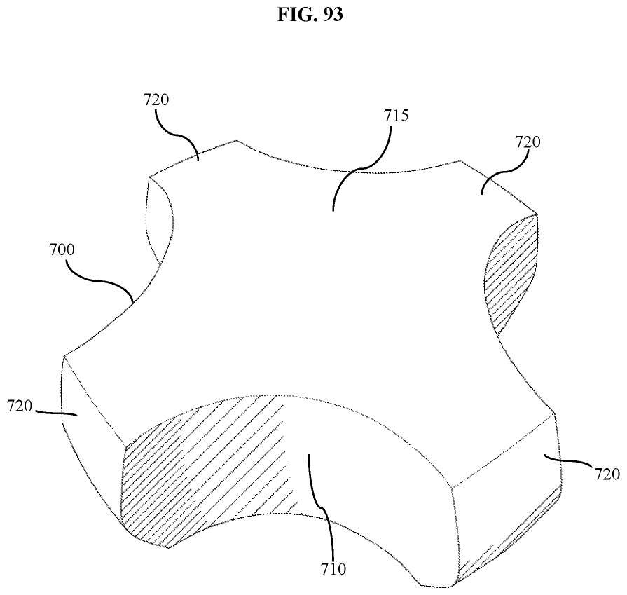

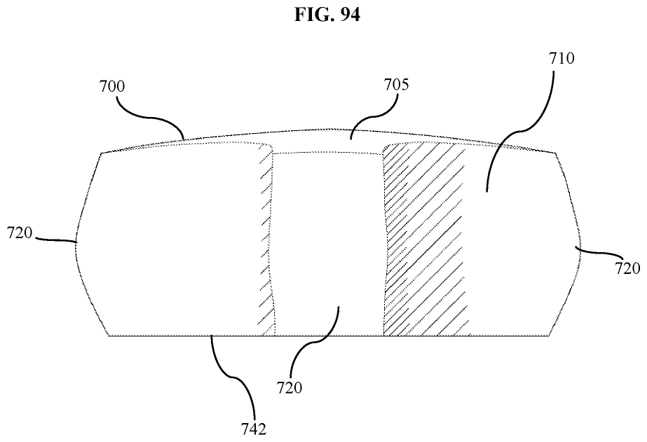

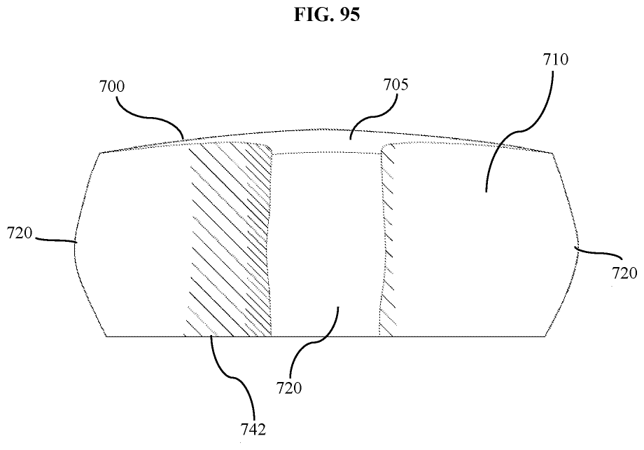

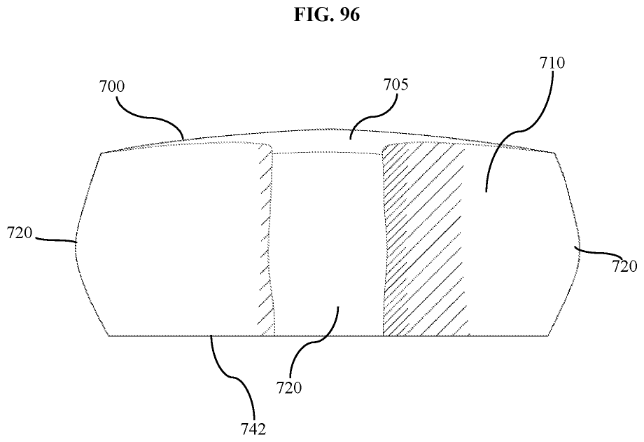

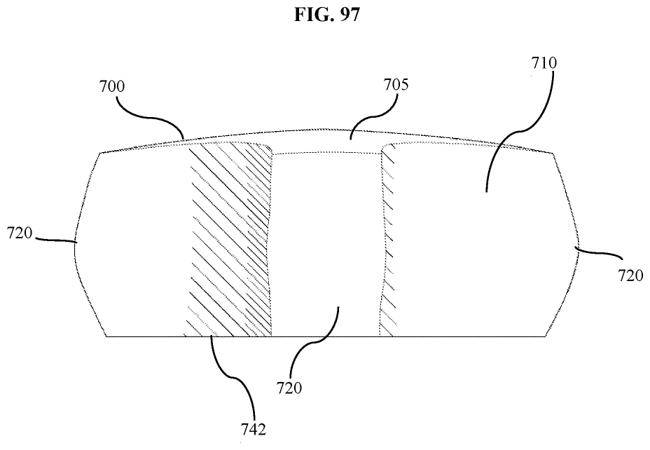

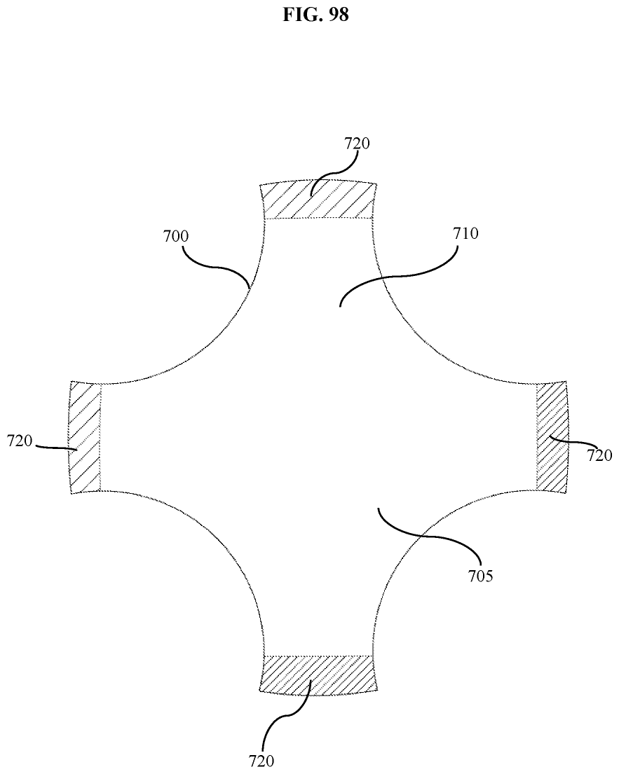

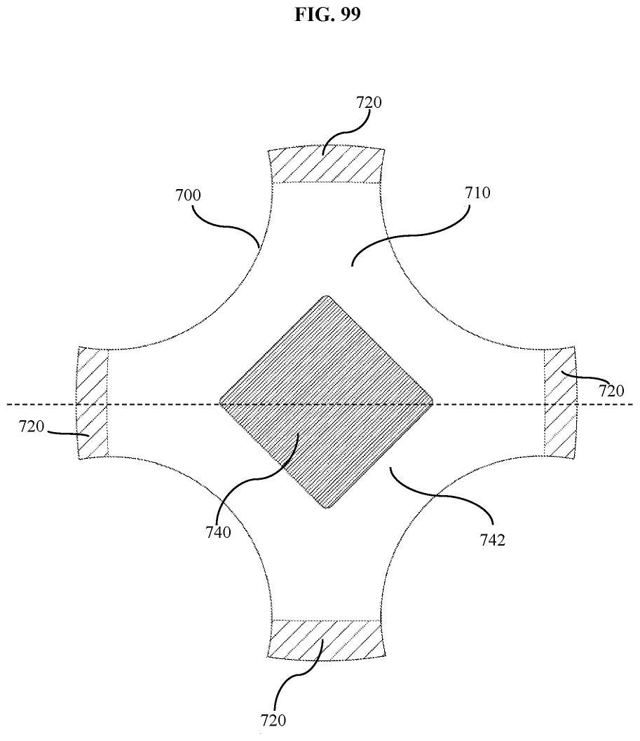

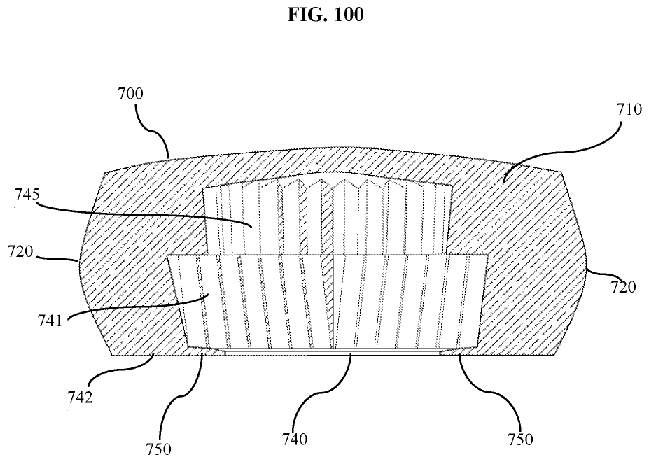

Referring now to another preferred embodiment of the invention, in FIG. 93, FIG. 94, FIG. 95, FIG. 96, FIG. 97, FIG. 98, FIG. 99, and FIG. 100, a Star Ergonomic Flexible Grip Container Opener 700 is shown. FIG. 93 displays a perspective view of a Star Ergonomic Flexible Grip Container Opener 700. FIG. 94 shows a front view of a Star Ergonomic Flexible Grip Container Opener 700. FIG. 95 depicts a rear view of a Star Ergonomic Flexible Grip Container Opener 700. FIG. 96 illustrates a right-side view of a Star Ergonomic Flexible Grip Container Opener 700. FIG. 97 displays a left-side view of a Star Ergonomic Flexible Grip Container Opener 700. Because of the symmetry of the Star Ergonomic Flexible Grip Container Opener 700, the front view in FIG. 94, the rear view in FIG. 95, the right-side view in FIG. 96, and the left-side view in FIG. 97, appear substantially identical. FIG. 98 shows a top view of a Star Ergonomic Flexible Grip Container Opener 700. FIG. 99 depicts a bottom view of a Star Ergonomic Flexible Grip Container Opener 700. FIG. 100 illustrates a front cutaway view of a Star Ergonomic Flexible Grip Container Opener 700 with the cutaway slice indicated by a dotted line in FIG. 99.

Referring still to the preferred embodiment of the invention in FIG. 93, FIG. 94, FIG. 95, FIG. 96, FIG. 97, FIG. 98, FIG. 99, and FIG. 100, the Star Ergonomic Flexible Grip Container Opener 700 comprises a star padded body 710; and a star indentation 740, which is recessing into the star bottom 742 of the star padded body 710 and capable of receiving a lid of a container. The star padded body 710 comprises a size suitable to substantially fit in a hand comfortably without the hand needing to be substantially closed or tightly gripped; a soft, strong, flexible, pliable, resilient, and stretchable material, which is suitable for being comfortably gripped in a hand; and a star shape with a star top 705 and a star bottom 742 and with ergonomic star fingers 720 set into each side (front, rear, right, and left sides) of the star padded body 710. The star bottom 742 also comprises a star lip 750, which surrounds the opening of the star indentation 740 and extends into it slightly. The star indentation 740 comprises a square-shaped opening and two gripping surfaces within a recessed cavity: a star lower gripping surface 741 and a star upper gripping surface 745. The star lower gripping surface 741 conforms to the square shape of the star indentation 740 but is wider than the star indentation 740 and comprises a plurality of surfaces, preferably a large number of surfaces, to engage a lid of a container at a large volume of multiple contact sites. The star upper gripping surface 745 has a smaller diameter than the star lower gripping surface 741 and comprises a plurality of surfaces, preferably a large number of surfaces, to engage a lid of a container at a large volume of multiple contact sites, which are set at an offset angle from the surfaces of the star lower gripping surface 741.

In further detail, referring still to the preferred embodiment of the invention in FIG. 93, FIG. 94, FIG. 95, FIG. 96, FIG. 97, FIG. 98, FIG. 99, and FIG. 100; during use, the a soft, strong, flexible, pliable, resilient, and stretchable material, of the star padded body 710 of a Star Ergonomic Flexible Grip Container Opener 700 allows the apparatus to fit upon a wide variety sizes and shapes of container lids and is well-suited for being comfortably gripped by weak hands. To use a Star Ergonomic Flexible Grip Container Opener 700, first a lid fastened onto a container is inserted into the star indentation 740. Because of the flexibility and stretchiness of the star padded body 710 of a Star Ergonomic Flexible Grip Container Opener 700, the star padded body 710 and the star lip 750 may be stretched over a lid, which does not necessarily match the size of the star indentation 740. Once the Star Ergonomic Flexible Grip Container Opener 700 is set onto the lid, the star padded body 710 may be comfortably gripped, even by weak hands that have difficulty with tightly closing, and gently squeezed, and twisted. The soft, strong, flexible, pliable, resilient, and stretchable material, of the star padded body 710 of a Star Ergonomic Flexible Grip Container Opener 700 allows force from a gentle grip to be applied to the lid while limiting this force from causing discomfort in a user's hands. The gentle squeezing of the Star Ergonomic Flexible Grip Container Opener 700 allows the star lower gripping surface 741 and/or the star upper gripping surface 745 to come into contact with the lid of the container within the star indentation 740. If the lid is a screw-on lid, then, while continuing to squeeze the star padded body 710 of a Star Ergonomic Flexible Grip Container Opener 700, a user may twist the apparatus to cause the lid to twist off of the container. Once the lid is removed from the container it may either be removed from the star indentation 740 or remain in the star indentation 740 so that the Star Ergonomic Flexible Grip Container Opener 700 may be used to attach the lid to the container again. The Star Ergonomic Flexible Grip Container Opener 700 offers a comfortable solution, which allows a person with weak hands to open and close containers with lids.

The construction details of the invention as shown in FIG. 93, FIG. 94, FIG. 95, FIG. 96, FIG. 97, FIG. 98, FIG. 99, and FIG. 100, are as follows. The star padded body 710 comprises a soft, strong, flexible, pliable, resilient, and stretchable material, or the like, which is suitable for being comfortably gripped in a hand, such as silicone, plastic, rubber, foam, composite material, soft wood, colloids, polymers, gels, emulsions, tissues, felt, cloth, or the like. The star indentation 740 comprises a shaped cavity or space within the star padded body 710. The star fingers 720 comprise extensions in the exterior of the star padded body 710. The star lip 750 is a part of the star padded body 710 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The star lower gripping surface 741 is a part of the star padded body 710 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. The star upper gripping surface 745 is a part of the star padded body 710 and comprises a soft, strong, flexible, pliable, resilient, and stretchable material, or the like, such as silicone, plastic, rubber, foam, composite material, soft wood, colloids, polymers, gels, emulsions, tissues, felt, cloth, or the like. This version could also be used with an inner lining and/or drawstring, as shown above with the most preferred embodiment of the invention. The materials listed herein are examples only and not intended to limit the scope of the present invention.

The advantages of the present invention include, without limitation, that it allows persons afflicted with weak hands, such as from arthritis, nerve damage, carpal tunnel, tendinitis, hand/wrist/arm injuries, weak muscles, inflexibility, old age, or the like, or with people with small hands that are unable to properly grip some lid sizes, such as children, who are unable to grip and turn lids due to their affliction, to open or close various sizes of lids from various sizes of containers by providing a large, soft, flexible, padded body, which substantially fits within a hand and which is easy to grip, squeeze, and twist, by weak hands that have difficulty in closing or closing tightly; that its stretchable and flexible nature allow it to stretch and fit onto a variety of sizes and shapes of lids and that this same property allows it to tightly and firmly grip a lid when compressed; that it can assist weak hands to open both pop-off lids and twistable lids; and that it is designed to ergonomically fit weak hands that have difficulty closing.

In broad embodiment, the present invention relates generally to an apparatus for opening and closing containers with lids by hand, which comprises a large flexible padded body made of a soft material, which is suitable for being comfortably gripped, squeezed, and twisted by weak hands, and a region for receiving and gripping a hard material, such as a lid of a container.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

What is claimed is:

1. An apparatus for opening and closing containers with lids by hand, said apparatus comprising:
a padded body, said padded body comprising:
a size suitable to substantially fit in said hand,
a strong, soft, flexible, and stretchable material suitable for being gripped in said hand,
an outer shape that ergonomically fits said hand,
an indentation in said large padded body, said indentation capable of receiving said lid of said container and comprising:
an opening,
a cavity, and
one or more gripping surfaces, said one or more gripping surfaces lining said cavity; and
wherein said lid of said container is inserted through said opening into said cavity of said indentation, said padded body is gripped by said hand thereby gripping said lid with said gripping surfaces in said indentation, said hand turns said padded body, thereby turning said gripping surfaces in said indentation and said lid of said container until said lid is opened or closed.

2. An apparatus of claim 1, said apparatus further comprising:
an inner layer lining said cavity of said indentation and bonded to said padded body, said inner layer comprising:
a thin, flexible, and stretchable material suitable for gripping said lid of said container.

3. An apparatus of claim 1, said apparatus further comprising a drawstring.

4. An apparatus of claim 1, said apparatus further comprising gripping notches disposed on said padded body.

5. An apparatus of claim 1, said apparatus further comprising:
a lip, said lip surrounding said opening of said indentation and extending into said opening, said lip comprising:
a thin, hard, flexible, and stretchable material suitable for gripping said lid of said container.

6. An apparatus of claim 1, wherein said gripping surfaces further comprise one or more faces.

7. An apparatus of claim 1, said apparatus comprising a plurality of said gripping surfaces wherein said gripping surfaces are at offset angles from each other.

8. An apparatus of claim 1, wherein said apparatus is shaped as a rounded cuboid.

9. An apparatus of claim 1, wherein said apparatus is shaped as a rounded spheroid.

10. An apparatus of claim 1, wherein said apparatus is shaped as a handle.

11. An apparatus of claim 1, wherein said apparatus is shaped as a star.

12. An apparatus of claim 1, wherein said apparatus is shaped as a cross.

13. An apparatus of claim 1, wherein said padded body comprises silicone.

14. An apparatus for opening and closing containers with lids by hand, said apparatus comprising:
a padded body, said padded body comprising:
a size suitable to substantially fit in said hand,
a strong, soft, flexible, and stretchable material suitable for being gripped in said hand,
an outer shape that ergonomically fits said hand,
an indentation in said large padded body, said indentation capable of receiving said lid of said container and comprising:
an opening,
a cavity,
an inner layer disposed within said indentation, lining said cavity, and bonded to said padded body, said inner layer comprising:
a thin, hard, flexible, and stretchable material suitable for gripping said lid of said container, and
one or more gripping surfaces; and
wherein said lid of said container is inserted into said indentation, said padded body is gripped by said hand thereby gripping said lid with said one or more gripping surfaces of said inner layer, and said hand turns said padded body, thereby turning said one or more gripping surfaces of said inner layer and said lid of said container until said lid is opened or closed.

15. An apparatus of claim 14, said apparatus further comprising a drawstring.

16. An apparatus of claim 14, said apparatus further comprising gripping notches disposed on said padded body.

17. An apparatus of claim 14, said apparatus further comprising:
a lip, said lip surrounding said opening of said indentation and extending into said opening, said lip comprising:
a thin, hard, flexible, and stretchable material suitable for gripping said lid of said container.

18. An apparatus of claim 14, wherein said gripping surfaces further comprise one or more faces.

19. An apparatus of claim 14, said apparatus comprising a plurality of said gripping surfaces wherein said gripping surfaces are at offset angles from each other.

20. An apparatus of claim 14, wherein said apparatus is shaped as a rounded cuboid.

21. An apparatus of claim 14, wherein said apparatus is shaped as a rounded spheroid.

22. An apparatus of claim 14, wherein said apparatus is shaped as a handle.

23. An apparatus of claim 14, wherein said apparatus is shaped as a star.

24. An apparatus of claim 14, wherein said apparatus is shaped as a cross.

25. An apparatus of claim 14, wherein said padded body comprises silicone.

26. An apparatus of claim 14, wherein said inner layer comprises silicone.
